(19) United States
(12) Patent Application Publication
(10) Pub. No.: US 2025/0372098 A1
(43) Pub. Date: Dec. 4, 2025

(54) SPEECH PROFILE MANAGEMENT

(71) Applicant: QUALCOMM Incorporated, San Diego, CA (US)

(72) Inventors: Soo Jin PARK, San Diego, CA (US); Sunkuk MOON, San Diego, CA (US); Hyeon-Kyeong SHIN, Goyang-si (KR); Phuong Lam TON, San Diego, CA (US); Erik VISSER, San Diego, CA (US); Ye JIANG, San Diego, CA (US); Dinesh RAMAKRISHNAN, Irvine, CA (US); Shaun VAN DYKEN, San Diego, CA (US)

(21) Appl. No.: 19/081,430

(22) Filed: Mar. 17, 2025

Related U.S. Application Data
(60) Provisional application No. 63/655,730, filed on Jun. 4, 2024.

(51) Int. Cl. G10L 17/08; G10L 17/02; G10L 17/04; G10L 17/18

(52) U.S. Cl. CPC G10L 17/08; G10L 17/02; G10L 17/04; G10L 17/18

(57) ABSTRACT

A device includes a memory configured to store enrolled speech profiles. The device also includes one or more processors configured to obtain multiple audio embeddings representing speech that is identified as associated with a single talker in an audio stream. The one or more processors are also configured to determine a first speech profile based on the multiple audio embeddings. The one or more processors are further configured to determine a similarity metric based on a comparison of the first speech profile to a second speech profile of the enrolled speech profiles. The one or more processors are also configured to, based on the similarity metric, determine whether to combine the first speech profile and the second speech profile.

### I. CROSS-REFERENCE TO RELATED APPLICATIONS

The present application claims priority from the commonly owned U.S. Provisional Patent Application No. 63/655,730, filed Jun. 4, 2024, entitled “SPEECH PROFILE MANAGEMENT,” the content of which is incorporated herein by reference in its entirety.

### II. FIELD

The present disclosure is generally related to management of speech profiles.

### III. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to receive an audio signal from one or more microphones. For example, the audio signal may represent user speech captured by the microphones, external sounds captured by the microphones, or a combination thereof. Such devices may include applications that rely on speech profiles, e.g., for transcription. A speech profile can be trained by having a user speak a script of predetermined words or sentences. Such active user enrollment to generate a speech profile can be time-consuming and inconvenient. Automatic user enrollment would save time and improve user experience.

### IV. SUMMARY

According to one implementation of the present disclosure, a device includes a memory configured to store enrolled speech profiles. The device also includes one or more processors configured to obtain multiple audio embeddings representing speech that is identified as associated with a single talker in an audio stream. The one or more processors are also configured to determine a first speech profile based on the multiple audio embeddings. The one or more processors are further configured to determine a similarity metric based on a comparison of the first speech profile to a second speech profile of the enrolled speech profiles. The one or more processors are also configured to, based on the similarity metric, determine whether to combine the first speech profile and the second speech profile.

According to another implementation of the present disclosure, a method includes obtaining multiple audio embeddings representing speech that is identified as associated with a single talker in an audio stream. The method also includes determining a first speech profile based on the multiple audio embeddings. The method further includes determining a similarity metric based on a comparison of the first speech profile to a second speech profile of enrolled speech profiles. The method also includes, based on the similarity metric, determining whether to combine the first speech profile and the second speech profile.

According to another implementation of the present disclosure, a non-transitory computer-readable medium includes instructions that, when executed by one or more processors, cause the one or more processors to obtain multiple audio embeddings representing speech that is identified as associated with a single talker in an audio stream. The instructions, when executed by the one or more processors, also cause the one or more processors to determine a first speech profile based on the multiple audio embeddings. The instructions, when executed by the one or more processors, further cause the one or more processors to determine a similarity metric based on a comparison of the first speech profile to a second speech profile of enrolled speech profiles. The instructions, when executed by the one or more processors, also cause the one or more processors to, based on the similarity metric, determine whether to combine the first speech profile and the second speech profile.

According to another implementation of the present disclosure, an apparatus includes means for obtaining multiple audio embeddings representing speech that is identified as associated with a single talker in an audio stream. The apparatus also includes means for determining a first speech profile based on the multiple audio embeddings. The apparatus further includes means for determining a similarity metric based on a comparison of the first speech profile to a second speech profile of enrolled speech profiles. The apparatus also includes means for determining, based on the similarity metric, whether to combine the first speech profile and the second speech profile.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1A is a block diagram of a particular illustrative example of a system operable to perform speech profile management, in accordance with some examples of the present disclosure.

FIG. 1B is a block diagram of a particular illustrative example of a system operable to perform speech profile management, in accordance with some examples of the present disclosure.

FIG. 2A is a diagram of an illustrative aspect of operations associated with merging speech profiles that may be performed by the profile manager of the system of FIG. 1A or the system of FIG. 1B, in accordance with some examples of the present disclosure.

FIG. 2B is a diagram of an illustrative aspect of operations associated with splitting a speech profile that may be performed by the profile manager of the system of FIG. 1A or the system of FIG. 1B, in accordance with some examples of the present disclosure.

FIG. 3A is a diagram of a particular illustrative aspect of operations of components of a device that includes a speaker diarizer of the system of FIG. 1A or the system of FIG. 1B, in accordance with some examples of the present disclosure.

FIG. 3B is a diagram of a particular illustrative aspect of operations of components of a device that includes a speech segmentor of the system of FIG. 1B, in accordance with some examples of the present disclosure.

FIG. 4 is a diagram of an illustrative aspect of operations associated with speech profile management, in accordance with some examples of the present disclosure.

FIG. 5 is a diagram of an illustrative aspect of operations associated with speech profile management, in accordance with some examples of the present disclosure.

FIG. 6 is a diagram of an illustrative aspect of operations associated with speech profile management, in accordance with some examples of the present disclosure.

FIG. 7 is a diagram of an illustrative aspect of operations associated with speech profile management, in accordance with some examples of the present disclosure.

FIG. 8 is a diagram of an illustrative aspect of operations associated with speech profile management, in accordance with some examples of the present disclosure.

FIG. 9 is a diagram of an illustrative aspect of operations associated with speech profile management, in accordance with some examples of the present disclosure.

FIG. 10 is a diagram of an illustrative aspect of operations associated with speech profile management, in accordance with some examples of the present disclosure.

FIG. 11 is a diagram of an illustrative aspect of operations associated with speech profile management, in accordance with some examples of the present disclosure.

FIG. 12 is a diagram of an illustrative aspect of operations associated with speech profile management, in accordance with some examples of the present disclosure.

FIG. 13 is a diagram of an illustrative aspect of operations associated with speech profile management, in accordance with some examples of the present disclosure.

FIG. 14 is a diagram of a particular implementation of a method of speech profile management that may be performed by the system of FIG. 1A or the system of FIG. 1B, in accordance with some examples of the present disclosure.

FIG. 15 illustrates an example of an integrated circuit operable to perform speech profile management, in accordance with some examples of the present disclosure.

FIG. 16 is a diagram of a mobile device operable to perform speech profile management, in accordance with some examples of the present disclosure.

FIG. 17 is a diagram of a headset operable to perform speech profile management, in accordance with some examples of the present disclosure.

FIG. 18 is a diagram of a wearable electronic device operable to perform speech profile management, in accordance with some examples of the present disclosure.

FIG. 19 is a diagram of a voice-controlled speaker system operable to perform speech profile management, in accordance with some examples of the present disclosure.

FIG. 20 is a diagram of a camera operable to perform speech profile management, in accordance with some examples of the present disclosure.

FIG. 21 is a diagram of a headset, such as a virtual reality, mixed reality, or augmented reality headset, operable to perform speech profile management, in accordance with some examples of the present disclosure.

FIG. 22 is a diagram of a first example of a vehicle operable to perform speech profile management, in accordance with some examples of the present disclosure.

FIG. 23 is a diagram of a second example of a vehicle operable to perform speech profile management, in accordance with some examples of the present disclosure.

FIG. 24 is a block diagram of a particular illustrative example of a device that is operable to perform speech profile management, in accordance with some examples of the present disclosure.

### VI. DETAILED DESCRIPTION

Training a speech profile using active user enrollment where a user speaks a set of predetermined words or sentences guarantees correct association between users' identity and speech. However, active user enrollment can be time-consuming and inconvenient. For example, the user has to plan ahead and take time to train the speech profile. On the other hand, an automatically generated speech profile designated as associated with speech of a single talker can sometimes be incorrectly based on speech of multiple talkers. Alternatively, speech profiles generated based on speech of a single talker can sometimes be incorrectly designated as associated with multiple talkers.

Systems and methods of speech profile management disclosed herein enable restructuring the speech profiles. For example, speech profiles that are detected as likely associated with speech of the same talker can be merged. To illustrate, a profile manager merges a first speech profile with a second speech profile in response to determining that the first speech profile and the second speech profile satisfy a similarity metric. For example, the first speech profile is based on first audio embeddings that represent speech, and the second speech profile is based on second audio embeddings that represent speech. The profile manager, in response to determining that a first audio embedding of the first speech profile is within a threshold distance of a second audio embedding of the second speech profile in a feature space, merges the first speech profile with the second speech profile.

In another example, a speech profile that is detected as likely associated with speech of multiple talkers can be split into multiple speech profiles. To illustrate, a profile manager splits portions of a first speech profile that satisfy a difference metric into multiple speech profiles. For example, the profile manager performs clustering on first audio embeddings of the first speech profile to generate a plurality of clusters of audio embeddings. The profile manager, in response to determining that a distance between a first audio embedding of a first cluster and a nearest audio embedding of another cluster is greater than a threshold distance, removes the first cluster of audio embeddings from the first speech profile and either discards the first cluster of audio embeddings or creates a new speech profile including the first cluster of audio embeddings if the first cluster of audio embeddings satisfies quality criteria.

The automatic restructuring improves accuracy of the speech profiles and conserves resources by removing duplicate speech profiles of the same talker. In some examples, the profile manager can additionally also restructure the speech profiles based on user input. The speech profiles can be used by various applications. In an example, an audio portion (e.g., one or more audio frames) of an audio stream includes speech of multiple talkers. A speech segmentor uses a first speech profile to filter the audio portion to generate a first filtered audio portion (e.g., a first separated audio portion) that represents speech that matches the first speech profile. For example, other speech is removed from the audio portion to generate the first filtered audio portion. Similarly, the speech segmentor can use a second speech profile to filter the audio portion to generate a second filtered audio portion (e.g., a second separated audio portion) that represents speech that matches the second speech profile.

A speech recognizer processes the first filtered audio portion to generate first speech text and processes the second filtered audio portion to generate second speech text. A transcript generator generates a transcript that includes the first speech text labeled as associated with the first speech profile, and second speech text labeled as associated with the second speech profile. Performing speech recognition on the filtered audio portions improves accuracy in recognizing speech associated with distinct talkers.

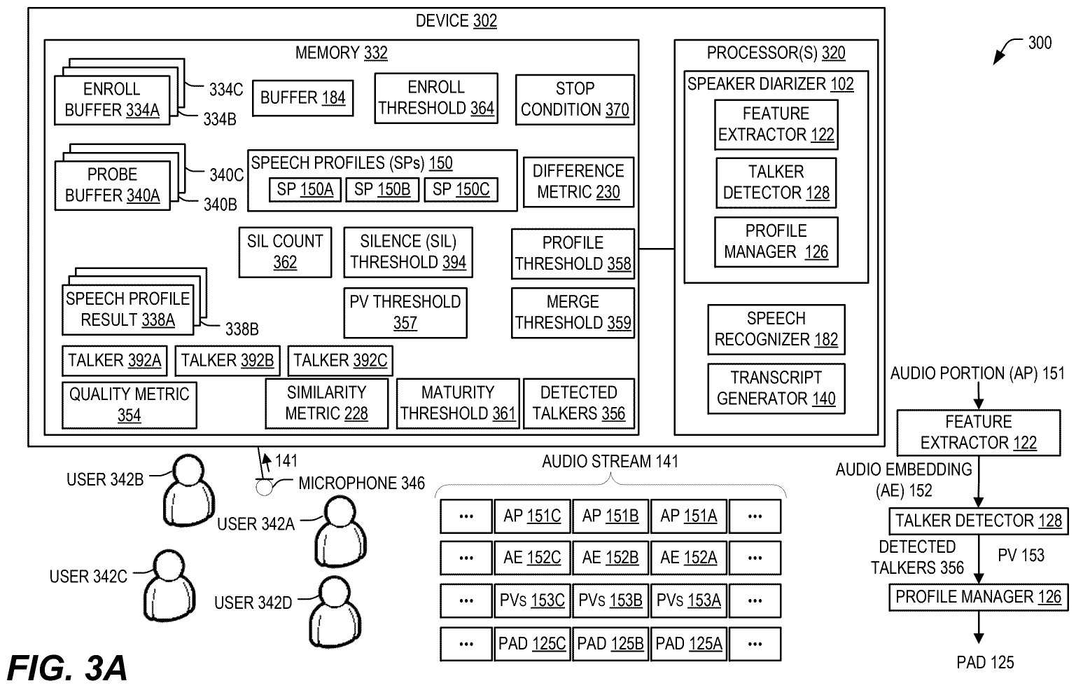

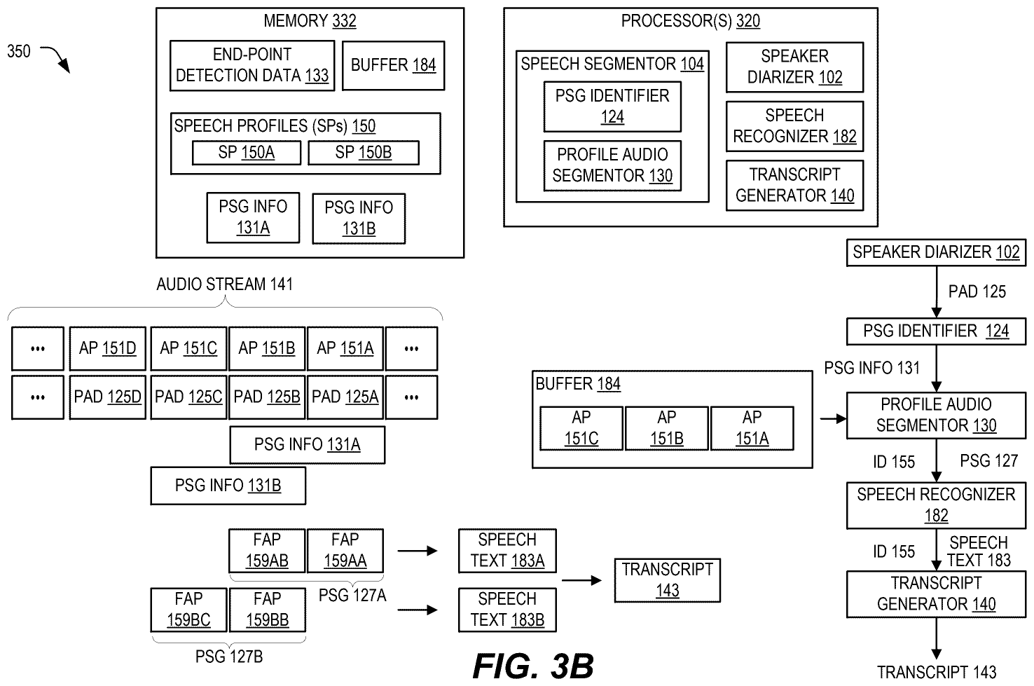

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 3A depicts a device 302 including one or more processors (“processor(s)” 320 of FIG. 3A), which indicates that in some implementations the device 302 includes a single processor 320 and in other implementations the device 302 includes multiple processors 320. For ease of reference herein, such features are generally introduced as “one or more” features and are subsequently referred to in the singular or optional plural (as indicated by “(s)”) unless aspects related to multiple of the features are being described.

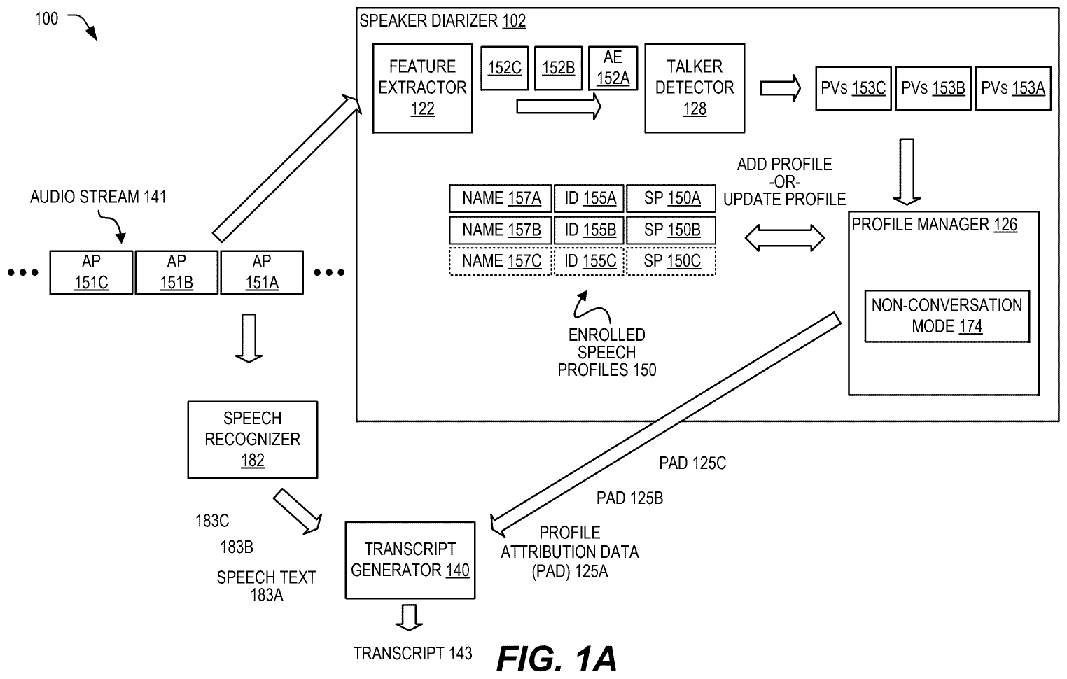

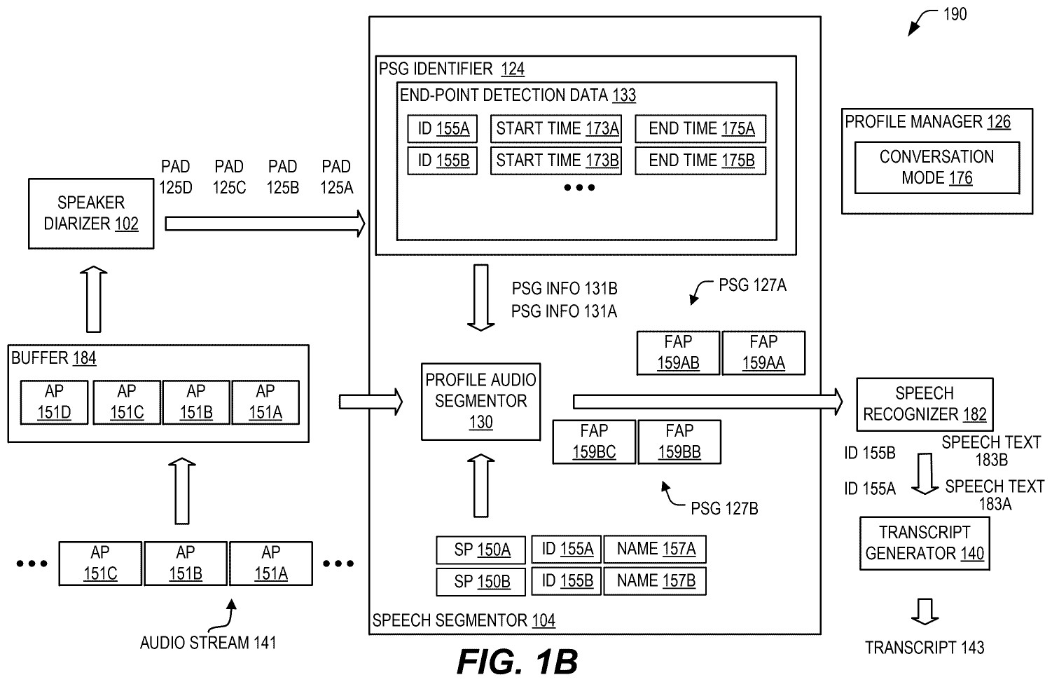

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1A, multiple audio portions are illustrated and associated with reference numbers 151A, 151B, and 151C. When referring to a particular one of these audio portions, such as an audio portion 151A, the distinguishing letter “A” is used. However, when referring to any arbitrary one of these audio portion or to these audio portions as a group, the reference number 151 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows-a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

Referring to FIG. 1A, a particular illustrative aspect of a system configured to perform speech profile management is disclosed and generally designated 100. The system 100 includes a speaker diarizer 102 and a speech recognizer 182 that are each coupled to a transcript generator 140.

The speaker diarizer 102 includes a feature extractor 122 coupled via a talker detector 128 to a profile manager 126. The feature extractor 122 is configured to process an audio portion (AP) 151 (e.g., one or more audio frames) to generate an audio embedding (AE) 152 that represents the audio portion 151. For example, the audio embedding 152 indicates a plurality of feature values corresponding to a plurality of audio features.

In some implementations, the feature extractor 122 includes a first machine learning model (e.g., a first neural network). In some implementations, the talker detector 128 includes a second machine learning model (e.g., a second neural network). In some implementations, the first machine learning model and the second machine learning model are trained together to enable the feature extractor 122 to generate audio embeddings 152 indicating feature values of those features that improve accuracy of the talker detector 128. A technical advantage of training the feature extractor 122 and the talker detector 128 together can include increased efficiency because the feature extractor 122 generates feature values of fewer audio features as compared to a feature extractor that is trained, independently of the talker detector 128, to generate feature values of a large set of audio features (e.g., all possible audio features).

The talker detector 128 is configured to process the audio embedding 152 to generate probability values (PVs) 153 indicating probabilities that speech of up to a predetermined count of talkers (e.g., 3) is detected in the audio portion 151. For example, the probability values 153 include a first probability value indicating an estimate of a first probability that speech of a first talker is detected, a second probability value indicating an estimate of a second probability that speech of a second talker (distinct from the first talker) is detected, a third probability value indicating an estimate of a third probability that speech of a third talker (distinct from the first talker and the second talker) is detected, one or more additional probability values, or a combination thereof. The probability values 153 thus indicate a count of talkers detected in the audio portion 151. For example, the count of detected talkers corresponds to a count of the probability values 153 that indicate a corresponding probability that is greater than a probability threshold. The talker detector 128 can thus detect talkers that do not have to be pre-enrolled and do not have to speak pre-determined words or sentences for speech profile generation. In some embodiments, the talker detector 128 does not have to store data long term about talkers. Rather, the talker detector 128 uses recurrent connections within a neural network to maintain some state data related to talkers that enables the talker detector 128 to predict whether speech of the same talker is detected in sequential audio portions.

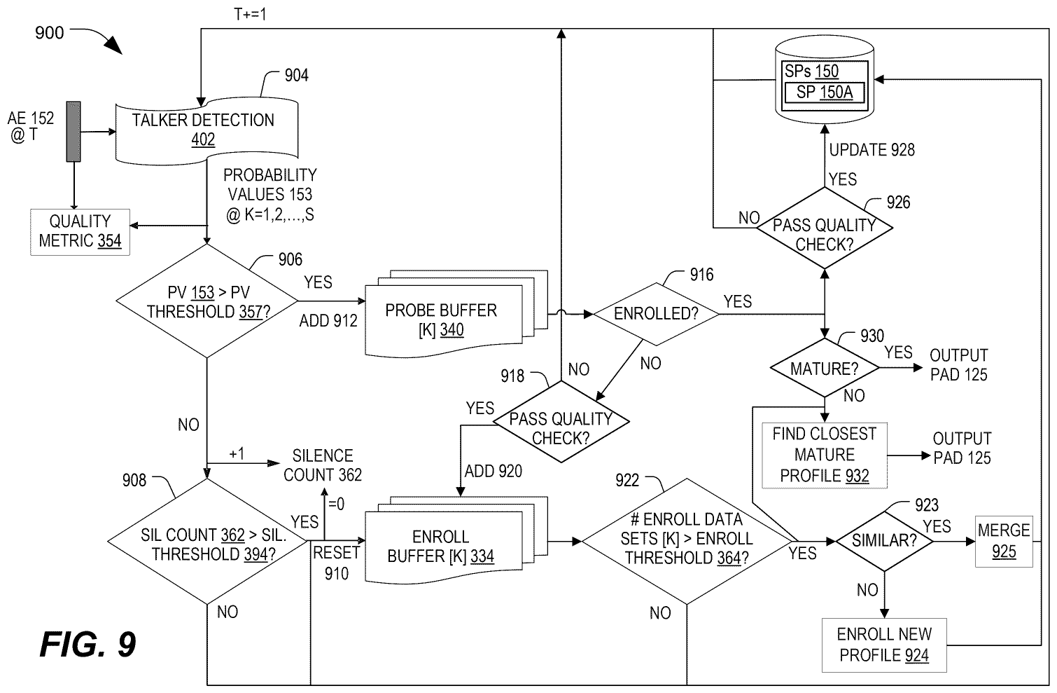

The profile manager 126 is configured to update enrolled speech profiles 150 based on the probability values 153 and the audio embedding 152, as further described with reference to FIG. 9. For example, the profile manager 126, in response to determining that the audio embedding 152 does not match any of the enrolled speech profiles 150, generates an enrolled speech profile (SP) 150 that includes the audio embedding 152. Alternatively, the profile manager 126, in response to determining that the audio embedding 152 matches an enrolled speech profile 150, adds the audio embedding 152 to the enrolled speech profile 150.

The profile manager 126 is configured to generate profile attribution data (PAD) 125 of the audio portion 151 based on an enrolled speech profile 150 (e.g., that matches the audio embedding 152) and the probability values 153. For example, the profile attribution data 125 indicates that the audio portion 151 represents speech that matches the speech profile 150. In the example shown in FIG. 1A, the speaker diarizer 102 is configured to provide the profile attribution data 125 to the transcript generator 140.

The speech recognizer 182 is configured to employ speech recognition techniques to process an audio portion 151 to generate speech text 183 that represents speech detected in the audio portion 151. The speech recognizer 182 is configured to provide the speech text 183 to the transcript generator 140.

The transcript generator 140 is configured to generate a transcript 143 based on the speech text 183 and the profile attribution data 125. For example, the transcript generator 140 is configured to generate the transcript 143 indicating the speech text 183 that is labeled as associated with the speech profile 150.

During operation, the speaker diarizer 102 receives an audio stream 141 including a sequence of audio portions 151, such as an audio portion 151A, an audio portion 151B, an audio portion 151C, and so on. In some examples, the speaker diarizer 102 receives the audio portion(s) 151 from a network device. In some examples, the speaker diarizer 102 retrieves the audio portion(s) 151 from a memory (e.g., a buffer) or a storage device. In some aspects, an audio portion 151 corresponds to one or more audio frames of the audio stream 141.

In some aspects, the speaker diarizer 102 initiates processing of the audio portion(s) 151 as the audio stream 141 is being received (e.g., real-time processing). For example, the speaker diarizer 102 processes the audio portion 151A prior to receiving one or more other audio portions 151 (e.g., the audio portion 151C or the audio portion 151C). In some examples, the speaker diarizer 102 initiates processing of the audio portion(s) 151 during an audio call or during a meeting. In some implementations, the audio portion(s) 151 are stored in a buffer for retrieval by the speaker diarizer 102 and the speech recognizer 182.

In some aspects, the speaker diarizer 102 initiates processing (e.g., post-processing) of the audio portion(s) 151 subsequent to receiving all of the audio portion(s) 151 of the audio stream 141 that are likely to be received. For example, the speaker diarizer 102 processes the audio portion 151A subsequent to detecting that an audio call or meeting associated with the audio stream 141 has ended.

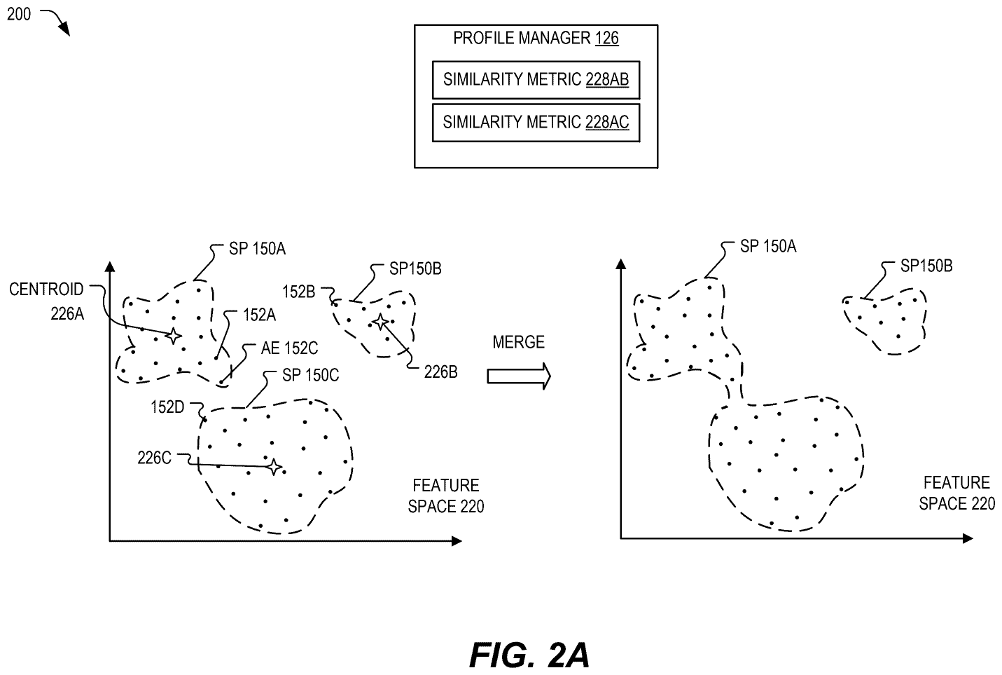

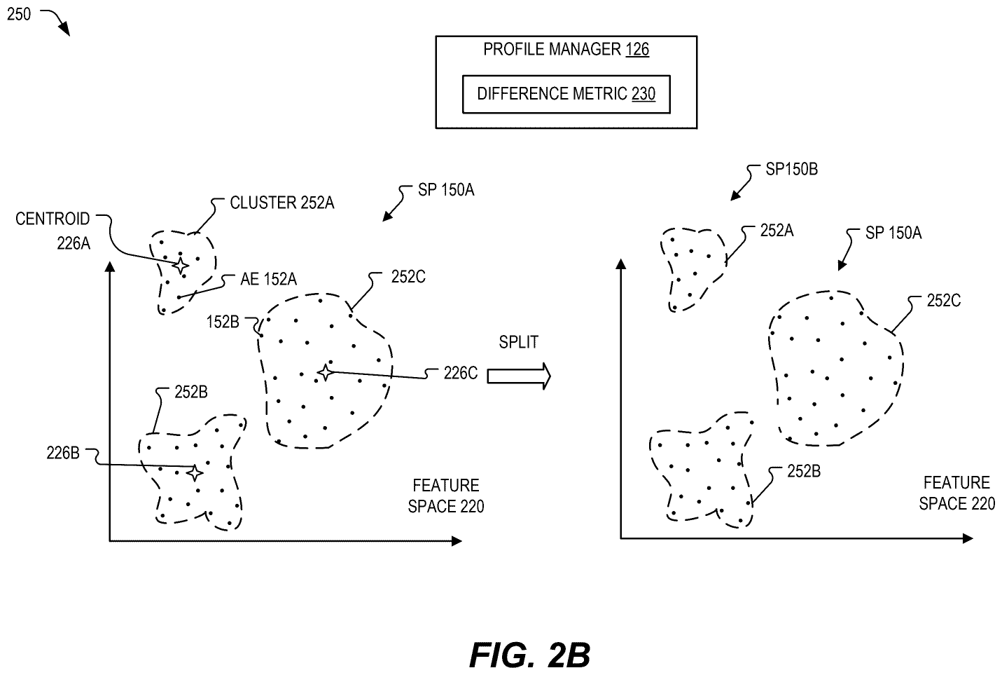

The feature extractor 122 processes the audio portion 151A to generate an audio embedding 152A that represents the audio portion 151A. For example, the audio embedding 152A indicates first feature values of a plurality of audio features. In some aspects, the audio embedding 152A corresponds to a first point in a feature space, as further described with reference to FIG. 2A. The feature extractor 122 provides the audio embedding 152A to the talker detector 128. Similarly, the feature extractor 122 processes the audio portion 151B to generate an audio embedding 152B and provides the audio embedding 152B, processes the audio portion 151C to generate an audio embedding 152C, and so on. In some implementations, the feature extractor 122 stores the audio embedding(s) 152 in a buffer for retrieval by the talker detector 128 and the profile manager 126.

The talker detector 128 processes the audio embedding 152A to generate probability values 153A that indicate probabilities that the audio portion 151A represents speech of up to a predetermined count of talkers. For example, the probability values 153A include a first probability value indicating a first probability that the audio portion 151A represents speech of a first talker, a second probability value indicating a second probability that the audio portion 151A represents speech of a second talker (distinct from the first talker), a third probability value indicating a third probability that the audio portion 151A represents speech of a third talker (distinct from the first talker and the second talker), and so on.

Similarly, the talker detector 128 processes the audio embedding 152B to generate probability values 153B that indicate probabilities that the audio portion 151B represents speech of up to the predetermined count of talkers. For example, the probability values 153B include a first probability value indicating a first probability that the audio portion 151B represents speech of a first talker, a second probability value indicating a second probability that the audio portion 151B represents speech of a second talker (distinct from the first talker), a third probability value indicating a third probability that the audio portion 151B represents speech of a third talker (distinct from the first talker and the second talker), and so on. The talker detector 128 processes the audio embedding 152C to generate probability values 153C that indicate probabilities that the audio portion 151C represents speech of up to the predetermined count of talkers.

In a particular example, the probability values 153A indicate that speech of the first talker is detected in the audio portion 151A, the probability values 153B indicate that speech of a first talker is not detected in the audio portion 151B, and the probability values 153C indicate that speech of a first talker is detected in the audio portion 151C. In this example, if a time period (during which a first talker is not detected) between detecting speech of a first talker in the audio portion 151A and speech of a first talker in the audio portion 151C is less than a silence threshold, then the first talker detected in the audio portion 151C is likely to be the same as the first talker detected in the audio portion 151A. Alternatively, if the time period is greater than the silence threshold, first talker detection could have been reset at the talker detector 128 and the first talker detected in the audio portion 151C can be different (e.g., a different person) from the first talker detected in the audio portion 151A.

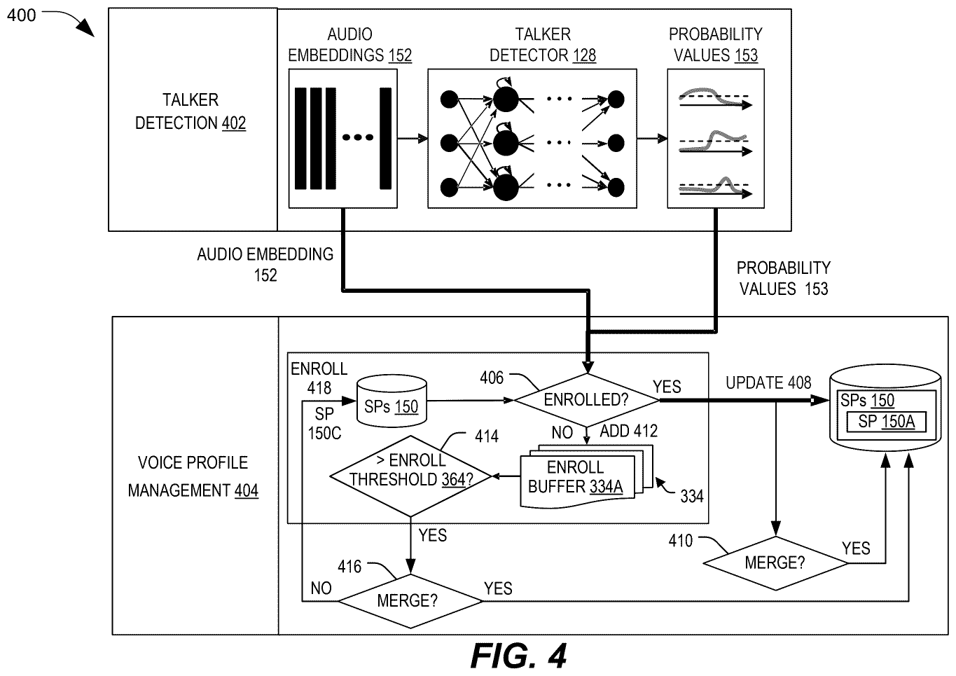

The profile manager 126, based on determining that the probability values 153A indicate that at least one talker is detected in the audio portion 151A, selectively updates the enrolled speech profiles 150 based on the audio embedding 152A, as further described with reference to FIGS. 4 and 9. For example, the profile manager 126, based on determining that the audio embedding 152A does not match any of the enrolled speech profiles 150 and satisfies an enrollment quality criterion, generates a speech profile 150A that includes the audio embedding 152A and adds the speech profile 150A to the enrolled speech profiles 150.

In a particular aspect, the profile manager 126 assigns a profile identifier (ID) 155A (e.g., 1242), a profile name 157A (e.g., “Talker 3”), or both, to the speech profile 150A. In a particular aspect, each of the enrolled speech profiles 150 has a unique profile identifier 155. For example, a speech profile 150B has a profile identifier 155B that is distinct from the profile identifier 155A, and a speech profile 150C has a profile identifier 155C that is distinct from each of the profile identifier 155A and the profile identifier 155B.

Optionally, in some aspects, each of the enrolled speech profiles 150 has a unique profile name 157. For example, the speech profile 150B has a profile name 157B, and the speech profile 150C has a profile name 157C. In some implementations, the profile name 157B is distinct from the profile name 157A, and the profile name 157C is distinct from each of the profile name 157A and the profile name 157B.

The profile manager 126, subsequent to generating the speech profile 150A, generates profile attribution data 125A indicating that the audio portion 151A represents speech that matches the speech profile 150A. In an example, the profile attribution data 125A includes the profile identifier 155A and an identifier (e.g., a sequence number or time information) of the audio portion 151A.

In an example, the profile manager 126, based on determining that the audio embedding 152B does not correspond to speech (e.g., includes silence, music, traffic, etc. without detectible speech), generates profile attribution data 125B indicating that the audio portion 151B corresponds to non-speech and is not associated with any speech profile 150. In an example, the profile attribution data 125B includes an identifier (e.g., a sequence number or time information) of the audio portion 151B.

In an example, the profile manager 126, based on determining that the audio embedding 152C matches the speech profile 150A and satisfies an update quality criterion, adds the audio embedding 152C to the speech profile 150A. The profile manager 126, responsive to determining that the audio embedding 152C matches the speech profile 150A, generates profile attribution data 125C indicating that the audio portion 151C represents speech that matches at least the speech profile 150A. In an example, the profile attribution data 125C includes the profile identifier 155A and an identifier (e.g., a sequence number or time information) of the audio portion 151C.

In some implementations, the profile manager 126 determines that an audio embedding 152 satisfies a quality criterion (e.g., the enrollment quality criterion, the update quality criterion, or both) based on a count of talkers, an audio quality, or both. For example, the profile manager 126 determines that the audio embedding 152A satisfies a quality criterion based on determining that the probability values 153A indicate that a single talker is detected in the audio portion 151A, determining that less than threshold noise is detected in the audio portion 151A, determining that a signal-to-noise ratio of the audio portion 151A is greater than a threshold, or a combination thereof.

In some aspects, the probability values 153 indicate that an audio portion 151 represents speech of multiple talkers and the profile manager 126 generates the profile attribution data 125 indicating multiple speech profiles 150. For example, the probability values 153 indicate that a first talker and a second talker are detected in the audio portion 151A. The profile manager 126, based on determining that the audio portion 151A matches a speech profile 150A and a speech profile 150B, generates the profile attribution data 125A indicating that the audio portion 151A represents speech that matches the speech profile 150A and the speech profile 150B. For example, the profile attribution data 125A indicates an identifier of the audio portion 151A, the profile identifier 155A, and the profile identifier 155B.

The speech recognizer 182 processes the audio portion(s) 151 of the audio stream 141 to generate speech text 183. For example, the speech recognizer 182 uses speech recognition techniques to process the audio portion 151A to generate speech text 183A representing speech detected in the audio portion 151A. In a particular aspect, the speech recognizer 182 determines a first audio time period based on a start timestamp of the audio portion 151A and an end timestamp of the audio portion 151A, and designates the speech text 183A as associated with the first audio time period.

As another example, the speech recognizer 182 uses speech recognition techniques to process the audio portion 151B to generate speech text 183B and designates the speech text 183B as associated with a second audio time period of the audio portion 151B. In a particular aspect, the speech text 183B indicates that no speech is detected in the audio portion 151B. Similarly, the speech recognizer 182 uses speech recognition techniques to process the audio portion 151C to generate speech text 183C representing speech detected in the audio portion 151C and designates the speech text 183C as associated with a third audio time period of the audio portion 151C. In some implementations, the speech recognizer 182 processes the audio portion(s) 151 concurrently with the speaker diarizer 102 processing the audio portion(s) 151.

The transcript generator 140 generates a transcript 143 based on the profile attribution data 125 and the speech text 183. In some aspects, the transcript generator 140 initiates generation of the transcript 143 as the audio stream 141 is being received (e.g., real-time processing). In other aspects, the transcript generator 140 generates the transcript 143 subsequent to receiving all of the audio portion(s) 151 of the audio stream 141 that are likely to be received (e.g., post-processing).

The transcript generator 140, based on determining that the profile attribution data 125A indicates that the audio portion 151A is associated with the speech profile 150A and the speech profile 150B, generates the transcript 143 including the speech text 183A with a label indicating that the speech text 183A is associated with the speech profile 150A and the speech profile 150B. For example, the label indicates the profile identifier 155A, the profile name 157A, or both, of the speech profile 150A, and the profile identifier 155B, the profile name 157B, or both, of the speech profile 150B. In some implementations, the transcript generator 140 generates the transcript 143 indicating the first audio time period associated with the speech text 183A (e.g., the audio portion 151A).

In a particular aspect, the transcript generator 140, based on determining that the profile attribution data 125B indicates that the audio portion 151B is associated with non-speech, refrains from updating the transcript 143 or updates the transcript 143 to indicate that the second audio time period associated with the speech text 183B (e.g., the audio portion 151B) is associated with non-speech.

The transcript generator 140, based on determining that the profile attribution data 125C indicates that the audio portion 151C is associated with the speech profile 150A, generates the transcript 143 including the speech text 183C with a label indicating that the speech text 183C is associated with the speech profile 150A. For example, the label indicates the profile identifier 155A, the profile name 157A, or both, of the speech profile 150A. In some implementations, the transcript generator 140 generates the transcript 143 indicating the third audio time period associated with the speech text 183C (e.g., the audio portion 151C).

A technical advantage of the system 100 includes enabling the audio portion(s) 151 to be concurrently processed by the speech recognizer 182 and the speaker diarizer 102 to generate the transcript 143. The transcript 143 includes speech text 183 with indications of corresponding speech profiles 150. The system 100 can have a greater count of enrolled speech profiles 150 (e.g., any number of speech profiles) than a pre-determined count of talkers (e.g., 3) that the talker detector 128 can detect. A technical advantage of having the talker detector 128 detect fewer talkers includes implementation of the talker detector 128 using a smaller and more efficient machine learning model.

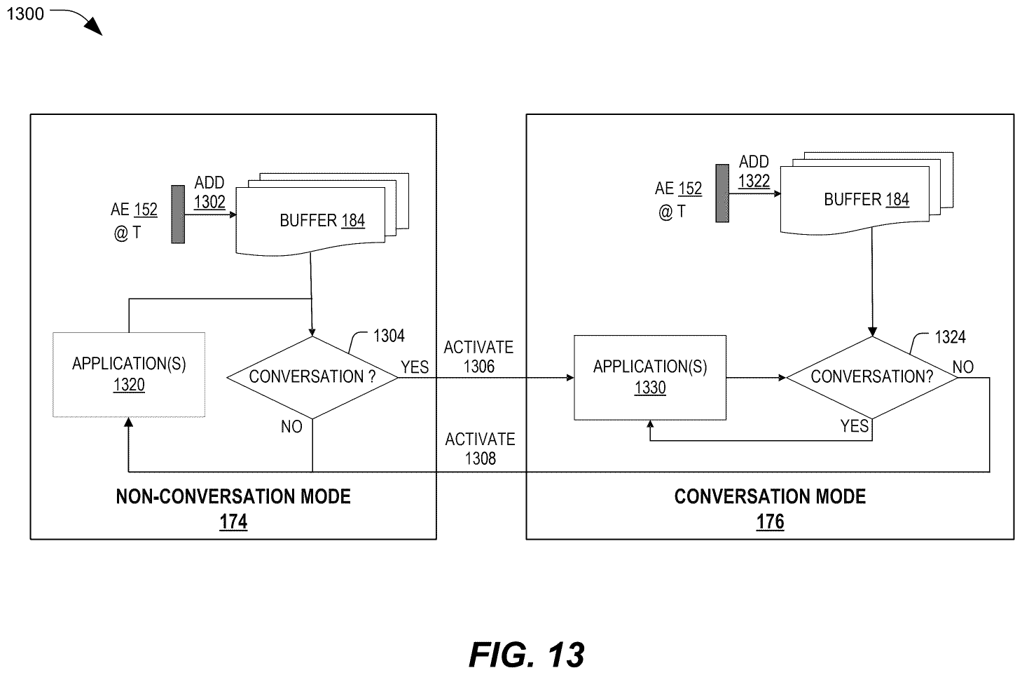

Although the speech recognizer 182 is described as processing the audio portion(s) 151 independently of the speaker diarizer 102, in some other implementations the speech recognizer 182 processes one or more filtered audio portions that are based on the profile attribution data 125 generated by the speaker diarizer 102, as further described with reference to FIG. 1B. In some implementations, the speech recognizer 182 can transition between processing the audio portion(s) 151 independently of the speaker diarizer 102 and processing the audio portion(s) 151 based on the profile attribution data 125 generated by the speaker diarizer 102. For example, during the a non-conversation mode 174 (e.g., when a conversation is not detected), the speech recognizer 182 processes an audio portion 151 independently of the profile attribution data 125. Alternatively, during a conversation mode (e.g., when a conversation is detected and the non-conversation mode 174 is inactivated), the speech recognizer 182 processes a filtered audio portion that is based on profile attribution data 125 generated by the speaker diarizer 102, as further described with reference to FIG. 1B. In a particular aspect, the profile manager 126 transitions between the non-conversation mode 174 and the conversation mode 176 based on whether a conversation is detected, as further described with reference to FIG. 13.

Referring to FIG. 1B, a particular illustrative aspect of a system configured to perform speech profile management is disclosed and generally designated 190. The system 190 includes the speaker diarizer 102 coupled via a speech segmentor 104 and the speech recognizer 182 to the transcript generator 140. The system 190 also includes a buffer 184 that is coupled to the speaker diarizer 102, the speech segmentor 104, or both. In a particular aspect, the system 100 of FIG. 1A includes one or more components of the system 190.

The speech segmentor 104 includes a profile audio segment (PSG) identifier 124 coupled to a profile audio segmentor 130. The profile audio segment identifier 124 is configured to maintain end-point detection data 133 based on profile attribution data 125 received from the speaker diarizer 102 and to generate profile audio segment information 131 based on the end-point detection data 133. The profile audio segment information 131 indicates a time period associated with a profile audio segment 127. The profile audio segment 127 includes one or more audio portions 151 that each include speech that matches a speech profile 150.

The profile audio segmentor 130 is configured to process an audio portion 151 that is included in a profile audio segment 127 based on the associated speech profile 150 to generate a filtered audio portion 159 (e.g., a separated audio portion). The filtered audio portion 159 includes speech that matches the speech profile 150. In an example, speech that does not match the speech profile 150 is removed from the audio portion 151 to generate the filtered audio portion 159. The speech recognizer 182 is configured to process the filtered audio portion 159 to generate speech text 183 that represents speech that matches the speech profile 150. The transcript generator 140 is configured to generate the transcript 143 including the speech text 183 with a label indicating that the speech text 183 is associated with the speech profile 150.

During operation, the audio portion(s) 151 are stored in the buffer 184 as the audio portion(s) 151 are received. The speaker diarizer 102 retrieves an audio portion 151A from the buffer 184 and processes the audio portion 151A to generate profile attribution data 125A, as described with reference to FIG. 1A. The profile audio segment identifier 124, in response to determining that the profile attribution data 125A indicates that the audio portion 151A represents speech that matches the speech profile 150A, determines whether the end-point detection data 133 indicates an audio segment of the speech profile 150A is in-progress.

In a particular implementation, the end-point detection data 133 maps the profile identifier 155 of each of the enrolled speech profiles 150 to an audio segment start time 173 and an audio segment end time 175. The profile manager 126 of FIG. 1A, concurrently with adding a speech profile 150 to the enrolled speech profiles 150, updates the end-point detection data 133 to add a profile identifier 155 that maps to an audio segment start time 173 having an invalid value (e.g., 0) and an audio segment end time 175 having an invalid value (e.g., 0). The profile audio segment identifier 124, in response to determining that the profile identifier 155A of the speech profile 150A maps to an audio segment start time 173A (e.g., 0) and an audio segment end time 175A (e.g., 0) that indicate invalid times, determines that no audio segment of the speech profile 150A is in-progress.

The profile audio segment identifier 124, in response to determining that the profile attribution data 125A indicates that the audio portion 151A represents speech that matches the speech profile 150A and that the end-point detection data 133 indicates that no audio segment of the speech profile 150A is in-progress, updates the end-point detection data 133 to indicate that a profile audio segment 127A of the speech profile 150A is in-progress. For example, the profile audio segment identifier 124 updates the audio segment start time 173A based on a timestamp associated with the audio portion 151A (e.g., an audio portion start time).

The speaker diarizer 102 retrieves an audio portion 151B from the buffer 184 and processes the audio portion 151B to generate profile attribution data 125B, as described with reference to FIG. 1A. The profile audio segment identifier 124, in response to determining that the profile attribution data 125B indicates that the audio portion 151B represents speech that matches the speech profile 150A, determines whether the end-point detection data 133 indicates an audio segment of the speech profile 150A is in-progress. The profile audio segment identifier 124, in response to determining that the end-point detection data 133 indicates that the audio segment start time 173A (e.g., timestamp of the audio portion 151A) is valid and the audio segment end time 175A (e.g., 0) is invalid, determines that the profile audio segment 127A of the speech profile 150A (e.g., the profile identifier 155A) is in-progress. The profile audio segment identifier 124, in response to determining that the profile attribution data 125B indicates that the audio portion 151B represents speech that matches the speech profile 150A and that the end-point detection data 133 indicates that an audio segment of the speech profile 150A is in-progress, determines that the profile audio segment 127A of the speech profile 150A has not ended.

In a particular aspect, an audio portion 151 represents speech that matches multiple speech profiles 150. In an example, the audio portion 151B represents speech that matches the speech profile 150B in addition to the speech profile 150A. The profile audio segment identifier 124, in response to determining that the profile attribution data 125B indicates that the audio portion 151B represents speech that matches the speech profile 150B, determines whether the end-point detection data 133 indicates an audio segment of the speech profile 150B is in-progress. The profile audio segment identifier 124, in response to determining that the profile attribution data 125B indicates that the audio portion 151B represents speech that matches the speech profile 150B and that the end-point detection data 133 indicates that no audio segment of the speech profile 150B is in-progress, updates the end-point detection data 133 to indicate that a profile audio segment 127B of the speech profile 150B is in-progress. For example, the profile audio segment identifier 124 updates the end-point detection data 133 to indicate that the profile identifier 155B maps to an audio segment start time 173B that is based on a timestamp associated with the audio portion 151B (e.g., an audio portion start time).

The speaker diarizer 102 retrieves an audio portion 151C from the buffer 184 and processes the audio portion 151C to generate profile attribution data 125C, as described with reference to FIG. 1A. The profile audio segment identifier 124, in response to determining that the profile attribution data 125C indicates that the audio portion 151C represents speech that matches the speech profile 150B, determines whether the end-point detection data 133 indicates an audio segment of the speech profile 150B is in-progress. The profile audio segment identifier 124, in response to determining that the profile attribution data 125C indicates that the audio portion 151C represents speech that matches the speech profile 150B and that the end-point detection data 133 indicates that an audio segment of the speech profile 150B is in-progress, determines that the profile audio segment 127B has not ended.

The profile audio segment identifier 124, in response to determining that the end-point detection data 133 indicates that the profile audio segment 127A of the speech profile 150A is in-progress and the profile attribution data 125C indicates that the audio portion 151C is designated as not representing speech that matches the speech profile 150A (e.g., corresponding to the profile identifier 155A), updates the end-point detection data 133 to indicate that the profile audio segment 127A of the speech profile 150A has ended. For example, the profile audio segment identifier 124 updates the audio segment end time 175A based on a time stamp associated with the audio portion 151C (e.g., an end time of the audio portion 151C). The profile audio segment identifier 124, in response to determining that the profile audio segment 127A has ended, generates profile audio segment information 131A indicating that a profile audio segment 127A of the profile identifier 155A has an audio segment time period from the audio segment start time 173A to the audio segment end time 175A.

In some implementations, the profile audio segment information 131A indicates one or more audio portions 151 that are included in the profile audio segment 127A. For example, the profile audio segment information 131A includes an identifier (e.g., an audio portion sequence number) of the audio portion 151A and an identifier of the audio portion 151B (e.g., an audio portion sequence number).

The profile audio segment identifier 124, subsequent to generating the profile audio segment information 131A, updates the end-point detection data 133 to reset the audio segment start time 173A to an invalid value (e.g., 0) and the audio segment end time 175A to an invalid value (e.g., 0) to indicate that no audio segment of the profile identifier 155A is in-progress. The profile audio segment identifier 124 provides the profile audio segment information 131A to the profile audio segmentor 130.

The speaker diarizer 102 retrieves an audio portion 151D from the buffer 184 and processes the audio portion 151D to generate profile attribution data 125D, as described with reference to FIG. 1A. In a particular aspect, the profile audio segment identifier 124, in response to determining that the end-point detection data 133 indicates that the profile audio segment 127B of the speech profile 150B is in-progress and the profile attribution data 125D indicates that the audio portion 151D is designated as not representing speech that matches the speech profile 150B (e.g., corresponding to the profile identifier 155B), updates the end-point detection data 133 to indicate that the profile audio segment 127B of the speech profile 150B has ended. For example, the profile audio segment identifier 124 updates the audio segment end time 175B based on a time stamp associated with the audio portion 151D (e.g., an end time of the audio portion 151D).

The profile audio segment identifier 124, in response to determining that the profile audio segment 127B has ended, generates profile audio segment information 131B indicating that a profile audio segment 127B of the profile identifier 155B has an audio segment time period from the audio segment start time 173B to the audio segment end time 175B. The profile audio segment identifier 124, subsequent to generating the profile audio segment information 131B, updates the end-point detection data 133 to reset the audio segment start time 173B to an invalid value (e.g., 0) and the audio segment end time 175B to an invalid value (e.g., 0) to indicate that no audio segment of the profile identifier 155B is in-progress. The profile audio segment identifier 124 provides the profile audio segment information 131B to the profile audio segmentor 130.

In some implementations, the profile audio segment information 131B indicates one or more audio portions 151 that are included in the profile audio segment 127B. For example, the profile audio segment information 131B includes an identifier (e.g., an audio portion sequence number) of the audio portion 151B and an identifier of the audio portion 151C (e.g., an audio portion sequence number).

The profile audio segmentor 130, in response to receiving profile audio segment information 131 of a profile audio segment 127, processes one or more audio portions of the profile audio segment 127 to generate one or more filtered audio portions. For example, the profile audio segmentor 130, in response to receiving the profile audio segment information 131A of a profile audio segment 127A of the profile identifier 155A, identifies one or more audio portions 151 that are included in the profile audio segment 127A. In a particular implementation, the profile audio segment information 131A indicates an audio segment time period (e.g., from the audio segment start time 173A to the audio segment end time 175A), and the profile audio segmentor 130 identifies one or more audio portions 151 that have time stamps during the audio segment time period. For example, the profile audio segmentor 130 identifies each of the audio portion 151A and the audio portion 151B having a time stamp (e.g., an audio portion start time) that is greater than or equal to the audio segment start time 173A and less than the audio segment end time 175A. In another implementation, the profile audio segment information 131A indicates identifiers of the audio portion 151A and the audio portion 151B that are included in the profile audio segment 127A.

The profile audio segmentor 130, in response to determining that the profile audio segment information 131A is associated with the profile identifier 155A of the speech profile 150A, filters the one or more audio portions included in the profile audio segment 127A based on the speech profile 150A to generate one or more filtered audio portions 159A. For example, the profile audio segmentor 130 filters the audio portion 151A based on the speech profile 150A to generate a filtered audio portion 159AA, and filters the audio portion 151B based on the speech profile 150A to generate a filtered audio portion 159AB. Each of the filtered audio portions 159A includes speech that matches the speech profile 150A. For example, other speech, if present, is removed from the audio portion 151A and the audio portion 151B to generate the filtered audio portion 159AA and the filtered audio portion 159AB, respectively.

The profile audio segmentor 130 provides the profile audio segment 127A including the filtered audio portion 159AA and the filtered audio portion 159AB to the speech recognizer 182. The profile audio segment 127A is designated as associated with the profile identifier 155A.

In an example, the profile audio segmentor 130, in response to receiving the profile audio segment information 131B of a profile audio segment 127B of the profile identifier 155B, identifies the audio portion 151B and the audio portion 151C that are included in the profile audio segment 127B. The profile audio segmentor 130, in response to determining that the profile audio segment information 131B is associated with the profile identifier 155B of the speech profile 150B, filters the audio portion 151B based on the speech profile 150B to generate a filtered audio portion 159BB, and filters the audio portion 151C based on the speech profile 150B to generate a filtered audio portion 159BC. Each of the filtered audio portions 159B includes speech that matches the speech profile 150B. For example, other speech, if present, is removed from the audio portion 151B and the audio portion 151C to generate the filtered audio portion 159BB and the filtered audio portion 159BC, respectively.

The profile audio segmentor 130 provides the profile audio segment 127B including the filtered audio portion 159BB and the filtered audio portion 159BC to the speech recognizer 182. The profile audio segment 127B is designated as associated with the profile identifier 155B.

The speech recognizer 182, in response to receiving the profile audio segment 127A, processes the filtered audio portions 159A (e.g., the filtered audio portion 159AA and the filtered audio portion 159AB) to generate speech text 183A. The speech recognizer 182 designates the speech text 183A as associated with the profile identifier 155A to indicate that the speech text 183A matches speech of the speech profile 150A. In a particular aspect, the speech recognizer 182 designates the speech text 183A as representing speech associated with the first audio segment time period (e.g., from the audio segment start time 173A to the audio segment end time 175A) of the profile audio segment 127A. The speech recognizer 182 provides the speech text 183A to the transcript generator 140.

As another example, the speech recognizer 182, in response to receiving the profile audio segment 127B, processes filtered audio portions 159B (e.g., the filtered audio portion 159BB and the filtered audio portion 159BC) to generate speech text 183B. The speech recognizer 182 designates the speech text 183B as associated with the profile identifier 155B, the second audio segment time period (e.g., from the audio segment start time 173B to the audio segment end time 175B), or both. The speech recognizer 182 provides the speech text 183B to the transcript generator 140.

The transcript generator 140, in response to receiving the speech text 183A, generates the transcript 143 indicating the speech text 183A with a label indicating the profile identifier 155A, the profile name 157A, or both, of the speech profile 150A. In a particular aspect, the transcript 143 indicates that the speech text 183A corresponds to speech associated with the first audio segment time period (e.g., from the audio segment start time 173A to the audio segment end time 175A).

The transcript generator 140, in response to receiving the speech text 183B, updates the transcript 143 to indicate the speech text 183B with a label indicating the profile identifier 155B, the profile name 157B, or both, of the speech profile 150B. In a particular aspect, the transcript 143 indicates that the speech text 183B corresponds to speech associated with the second audio segment time period (e.g., from the audio segment start time 173B to the audio segment end time 175B).

A technical advantage of the system 190 includes improved accuracy of the generated transcript 143 due to the speech recognizer 182 operating on filtered speech. For example, the speech recognizer 182 may generate more accurate text representing particular speech when an audio portion including the speech is filtered to represent a single talker (e.g., a single speech profile) as compared to text generated by the speech recognizer 182 based on an audio portion 151 that represents speech from multiple talkers.

In some implementations, the speech recognizer 182 can transition between processing the audio portion(s) 151 independently of the speaker diarizer 102, as described with reference to FIG. 1A, and processing the audio portion(s) 151 based on the profile attribution data 125 generated by the speaker diarizer 102, as described with reference to FIG. 1B. For example, during the the non-conversation mode 174, the speech recognizer 182 processes an audio portion 151 independently of the profile attribution data 125, as described with reference to FIG. 1A. During the non-conversation mode 174, an audio portion 151 is less likely to correspond to speech of multiple talkers and so the speech segmentor 104 can be bypassed without much impact on quality of the speech recognition. Alternatively, during the conversation mode 176, the speech recognizer 182 processes a filtered audio portion 159 that is based on profile attribution data 125 generated by the speaker diarizer 102, as described with reference to FIG. 1B. During the conversation mode 176, an audio portion 151 is more likely to correspond to speech of multiple talkers and so using the speech segmentor 104 is likely to improve quality of the speech recognition.

Referring to FIG. 2A, an example 200 is shown of an illustrative aspect of operations associated with merging speech profiles that may be performed by the profile manager 126 of the system 100 of FIG. 1A or the system 190 of FIG. 1B, in accordance with some examples of the present disclosure.

Each audio embedding 152 of an enrolled speech profile 150 corresponds to a point (or a vector) in a feature space 220. It should be understood that the feature space 220 is shown as a 2-dimensional feature space for ease of illustration. The feature space 220 can include any number of dimensions, with each dimension corresponding to a particular feature. Feature values represented by an audio embedding 152 indicate a location of the audio embedding 152 in the feature space 220.

The profile manager 126 determines whether a pair of speech profiles 150 is to be merged based on a similarity metric 228. In some aspects, the profile manager 126, concurrently with generating a new speech profile 150, compares the new speech profile 150 with the enrolled speech profiles 150 to determine whether the new speech profile 150 is to be merged with an existing speech profile 150 or is to be added to the enrolled speech profiles 150. In some aspects, the profile manager 126 (e.g., during post-processing) compares pairs of the enrolled speech profiles 150 to each other to determine whether a pair of the enrolled speech profiles 150 is to be merged.

In some aspects, the similarity metric 228 of a pair of speech profiles 150 is based on a distance (e.g., a cosine distance, Euclidean distance, or both) between centroid vectors of audio embeddings 152 of the pair of speech profiles. In the example 200, the speech profile 150A includes audio embeddings 152 corresponding to a centroid vector 226A. The speech profile 150B includes audio embeddings 152 corresponding to a centroid vector 226B. The speech profile 150C includes audio embeddings 152 corresponding to a centroid vector 226C. In some aspects, a similarity metric 228AB of the speech profile 150A and the speech profile 150B is based on a distance between the centroid vector 226A and the centroid vector 226B, and a similarity metric 228AC of the speech profile 150A and the speech profile 150C is based on a distance between the centroid vector 226A and the centroid vector 226C.

In some aspects, the similarity metric 228 of a pair of speech profiles 150 is based on a distance (e.g., a cosine distance, Euclidean distance, or both) between nearest audio embeddings 152 of the pair of speech profiles. In the example 200, the speech profile 150A includes an audio embedding 152A that is nearest to an audio embedding 152B of the speech profile 150B, and the speech profile 150A includes an audio embedding 152C that is nearest to an audio embedding 152D of the speech profile 150C. In some aspects, a similarity metric 228AB of the speech profile 150A and the speech profile 150B is based on a distance between the audio embedding 152A and the audio embedding 152B, and a similarity metric 228AC of the speech profile 150A and the speech profile 150C is based on a distance between the audio embedding 152C and the audio embedding 152D.

As an example, the profile manager 126, in response to determining that the similarity metric 228AB fails to satisfy a similarity threshold, determines that the speech profile 150A is not to be merged with the speech profile 150B. For example, the profile manager 126, in response to determining that the distance between the audio embedding 152A and the audio embedding 152B is greater than an audio embedding distance threshold and that the distance between the centroid vector 226A and the centroid vector 226B is greater than a centroid distance threshold, determines that the speech profile 150A is not to be merged with the speech profile 150B.

In another example, the profile manager 126, in response to determining that the similarity metric 228AC satisfies a similarity threshold, determines that the speech profile 150A is to be merged with the speech profile 150C. For example, the profile manager 126, in response to determining that the distance between the audio embedding 152C and the audio embedding 152D is less than or equal to the audio embedding distance threshold, that the distance between the centroid vector 226A and the centroid vector 226C is less than or equal to the centroid distance threshold, or both, determines that the speech profile 150A is to be merged with the speech profile 150C.

The profile manager 126, in response to determining that the speech profile 150A is to be merged with the speech profile 150C, adds audio embeddings 152 of the speech profile 150C to the speech profile 150A and resets the speech profile 150C. For example, resetting the speech profile 150C includes removing the audio embeddings 152 from the speech profile 150C, resetting the profile name 157C (e.g., to a default value, such as “Talker 3”), designating the speech profile 150C as available, resetting the profile identifier 155C (e.g., to a default value, such as 0), or a combination thereof.

In some implementations, the profile manager 126 updates other data (e.g., profile attribution data 125, speech text 183, transcript 143, or a combination thereof) that refers to the speech profile 150C (or the profile identifier 155C) to refer to the speech profile 150A (or the profile identifier 155A). In some implementations, the profile manager 126, in response to determining that the end-point detection data 133 of FIG. 1B indicates that an audio segment of the profile identifier 155A is in-progress, an audio segment of the profile identifier 155C is in-progress, or both, sets the audio segment start time 173A to indicate the earlier of the audio segment start time 173A or an audio segment start time 173 of the profile identifier 155C. In some implementations, the profile manager 126, in response to determining that the end-point detection data 133 of FIG. 1B indicates that an audio segment of the profile identifier 155A has ended and that an audio segment of the profile identifier 155C is in-progress, resets the audio segment end time 175A (e.g., to 0 to indicate an invalid time) to indicate that an audio segment of the profile identifier 155A is in-progress. The profile manager 126 updates the end-point detection data 133 to remove the profile identifier 155C and the corresponding audio segment start time and audio segment end time from the end-point detection data 133.

A technical advantage of merging the speech profile 150A and the speech profile 150C includes improved accuracy in identifying speech that corresponds to the same talker (e.g., the same person). Another technical advantage may include reduced memory usage to store fewer speech profiles.

Referring to FIG. 2B, an example 250 is shown of an illustrative aspect of operations associated with splitting a speech profile that may be performed by the profile manager 126 of the system 100 of FIG. 1A or the system 190 of FIG. 1B, in accordance with some examples of the present disclosure.

The profile manager 126 performs clustering on audio embeddings 152 of the speech profile 150A to generate a plurality of clusters, such as a cluster 252A, a cluster 252B, a cluster 252C, one or more additional clusters, or a combination thereof. The profile manager 126 determines, based on a difference metric 230, whether a cluster 252 is to be split off from the speech profile 150A to generate another speech profile. In some aspects, the profile manager 126 (e.g., during post-processing) performs clustering of each of the enrolled speech profiles 150 and compares pairs of clusters to determine whether a cluster is to be split off from an enrolled speech profile 150 to generate another speech profile 150.

In some aspects, the difference metric 230 of a cluster 252 is based on a distance (e.g., a cosine distance, Euclidean distance, or both) between centroid vectors of the cluster 252 and a nearest cluster. In the example 250, the cluster 252A has a centroid vector 226A, the cluster 252B has a centroid vector 226B, and the cluster 252C has a centroid vector 226C. In some aspects, the profile manager 126 identifies the cluster 252C as a nearest cluster to the cluster 252A based on determining that a first centroid distance between the centroid vector 226A and the centroid vector 226C is lower than a second centroid distance between the centroid vector 226A and the centroid vector 226B, and determines the difference metric 230 based on the first centroid distance.

In some aspects, the difference metric 230 of a cluster 252 is based on a distance (e.g., a cosine distance, Euclidean distance, or both) between an audio embedding 152 of the cluster 252 and a nearest audio embedding 152 of another cluster. In the example 200, the cluster 252A includes an audio embedding 152A that is nearest to an audio embedding 152B of the cluster 252C, and the profile manager 126 determines the difference metric 230 based on an audio embedding distance between the audio embedding 152A and the audio embedding 152B.

The profile manager 126, based on determining whether the difference metric 230 satisfies a difference threshold, determines whether the cluster 252A is to be split off from the speech profile 150A. For example, the profile manager 126, in response to determining that the audio embedding distance between the audio embedding 152A and the audio embedding 152B is greater than an audio embedding distance threshold and that the first centroid distance between the centroid vector 226A and the centroid vector 226C is greater than a centroid distance threshold, determines that the cluster 252A is to be split off from the speech profile 150A. In an alternative example, the profile manager 126, in response to determining the audio embedding distance is less than or equal to the audio embedding distance threshold or that the first centroid distance is less than or equal to the centroid distance threshold, determines that the cluster 252A is not to be split off from the speech profile 150A.

The profile manager 126, in response to determining that the cluster 252A is to be split off from the speech profile 150A, moves audio embeddings 152 of the cluster 252A from the speech profile 150A to a new speech profile 150B.

A technical advantage of splitting the cluster 252A from the speech profile 150A to generate the speech profile 150B includes improved accuracy in identifying speech that corresponds to different talkers (e.g., different people) that may have incorrectly been associated with the same speech profile.

Referring to FIG. 3A, a diagram 300 is shown of a particular illustrative aspect of operations of components of a device 302 that includes the speaker diarizer 102 of the system 100 of FIG. 1A or the system 190 of FIG. 1B, in accordance with some examples of the present disclosure. In a particular aspect, the device 302 includes one or more components of the system 100, the system 190, or both, one or more additional components, or a combination thereof, that are not shown in FIG. 3A for ease of illustration.

The device 302 includes one or more processors 320 that include the speaker diarizer 102. Optionally, in some implementations, the one or more processors 320 include the speech recognizer 182, the transcript generator 140, or both. The speaker diarizer 102 includes the feature extractor 122, the talker detector 128, and the profile manager 126, as described with reference to FIG. 1A.

In a particular aspect, the device 302 includes a memory 332 coupled to the one or more processors 320. In a particular aspect, the memory 332 includes one or more buffers, such as the buffer 184, enroll buffers 334, probe buffers 340, or a combination thereof. For example, the memory 332 includes an enrollment (enroll) buffer 334 and a probe buffer 340 designated for each of talkers 392 that the talker detector 128 is configured to detect. To illustrate, the memory 332 includes an enroll buffer 334A and a probe buffer 340A designated for a talker 392A, an enroll buffer 334B and a probe buffer 340B designated for a talker 392B, and an enroll buffer 334C and a probe buffer 340C designated for a talker 392C.

The memory 332 is configured to store one or more thresholds, such as a probability value threshold 357, an enroll threshold 364, a profile threshold 358, a silence threshold 394, a merge threshold 359, a maturity threshold 361, or a combination thereof. In a particular aspect, the one or more thresholds are based on user input, configuration settings, default data, or a combination thereof. The memory 332 is configured to store data indicating a stop condition 370, a speech profile result 338, a silence (SIL) count 362, or a combination thereof.

In a particular aspect, the memory 332 is configured to store data generated by the feature extractor 122, the talker detector 128, the profile manager 126, the speech recognizer 182, the transcript generator 140, or a combination thereof. For example, the memory 332 is configured to store enrolled speech profiles 150 that correspond to speech of a plurality of users 342, audio embeddings 152, probability values 153, profile attribution data 125, audio portion(s) 151, profile IDs 155, profile names 157, quality metric 354, a similarity metric 228, a difference metric 230, speech text 183, transcript 143, a detected talkers result 356, or a combination thereof. It should be understood that the memory 332 is configured to store any data described herein, some of which may not be shown in FIG. 3A for ease of illustration.

The device 302 is configured to receive an audio stream 141, via a modem, a network interface, an input interface, or from the microphone 346. In a particular aspect, the audio stream 141 includes one or more audio portions 151. For example, the audio stream 141 may be divided into a set of audio frames that correspond to the audio portions 151, with each audio frame representing a time-windowed portion of the audio stream 141. In other examples, the audio stream 141 may be divided in another manner to generate the audio portions 151. Each audio portion 151 of the audio stream 141 includes or represents silence, speech from one or more of the users 342, or other sounds. An audio portion refers to a portion of an audio frame, an audio frame, multiple audio frames, audio data corresponding to a particular speech or playback duration, or a combination thereof.

The feature extractor 122 is configured to extract (e.g., determine) audio features of the audio stream 141 to generate audio embeddings 152. For example, the feature extractor 122 is configured to extract audio feature values of an audio portion 151 of the audio stream 141 to generate an audio embedding 152. In a particular aspect, the audio embedding 152 corresponds to an audio feature vector in the feature space 220 of FIG. 2A. In a particular aspect, the audio embedding 152 indicates mel-frequency cepstral coefficients (MFCCs) of the audio portion 151.

In an illustrative example, the feature extractor 122 extracts the audio feature values of each audio portion 151 of the audio stream 141 to generate an audio embedding 152 and provides the audio embedding 152 of each audio portion 151 to the talker detector 128. In a particular aspect, the talker detector 128 is configured to generate a set of probability values for an audio embedding 152 of an audio portion 151A (e.g., 10 audio frames). For example, the feature extractor 122 extracts first audio feature values of a first audio frame, second audio feature values of a second audio frame, and so on including tenth audio feature values of a tenth audio frame, and the audio embedding 152A includes the first audio feature values, the second audio feature values, and so on including the tenth audio feature values. The talker detector 128 generates probability values 153A based on the audio embedding 152A (e.g., the first audio feature values, the second audio feature values, and so on, including the tenth audio feature values). Similarly, the feature extractor 122 extracts eleventh audio features of an eleventh audio frame, twelfth audio features of a twelfth audio frame, and so on including twentieth audio features of a twentieth audio frame, and the audio embedding 152B includes the eleventh audio features, the twelfth audio features, and so on, including the twentieth audio features. It should be understood that an audio portion 151 including ten audio frames is provided as an illustrative example. In other examples, an audio portion 151 can include fewer than ten or more than ten audio frames.

The talker detector 128 is configured to generate probability values 153 for each audio embedding 152. For example, in response to input of an audio embedding 152 to the talker detector 128, the talker detector 128 generates multiple probability values 153. The number of probability values 153 generated in response to an audio embedding 152 depends on the number of talkers that the talker detector 128 is trained to distinguish. The number of talkers that the talker detector 128 is trained to distinguish is independent of a count of enrolled speech profiles 150 generated by the profile manager 126. For example, the number of talkers that the talker detector 128 is trained to distinguish can be based on configuration and training of the talker detector 128, and does not change as more enrolled speech profiles 150 are added. The probability values 153 generated by the talker detector 128 are independent of comparisons to any speech profiles 150.

As one example, the talker detector 128 is configured to distinguish speech of K distinct talkers by generating a set of K probability values 153. In this example, each probability value 153 indicates a probability that the audio embedding 152 input to the talker detector 128 represents speech of a corresponding talker. To illustrate, K equals three (3) when the talker detector 128 is configured to distinguish speech of three (3) different talkers, such as a talker 392A, a talker 392B, and a talker 392C. In this illustrative example, the talker detector 128 is configured to output three (3) probability values 153, such as a first probability value 153, a second probability value 153, and a third probability value 153, for each audio embedding 152 input to the talker detector 128. In this illustrative example, the first probability value 153 indicates a probability that the audio embedding 152 represents speech of the talker 392A, the second probability value 153 indicates a probability that the audio embedding 152 represents speech of the talker 392B, and the third probability value 153 indicates a probability that the audio embedding 152 represents speech of the talker 392C. In other examples, the count of talkers that the talker detector 128 is configured to distinguish (K in the examples above), is greater than three or fewer than three.

The talkers 392 correspond to a set of talkers that have been detected most recently, e.g., during a segmentation window, by the talker detector 128. In a particular aspect, the talkers 392 do not have to be pre-enrolled in order to be distinguished by the talker detector 128. The talker detector 128 enables passive enrollment of multiple users by distinguishing between speech of multiple users that are not pre-enrolled. The segmentation window includes up to a particular count of audio portions (e.g., 20 audio frames), audio portions processed by the talker detector 128 during a particular time window (e.g., 20 milliseconds), or audio portions corresponding to a particular speech duration or playback duration.

The audio embeddings 152 representing features of the audio portions 151 of the audio stream 141 may be provided as input to the talker detector 128. In this example, the audio embeddings 152 represent speech of two or more of users 342, such as audio embeddings 152A representing speech of the user 342A, audio embeddings 152B representing silence, and audio embeddings 152C representing speech of the user 342B. In a particular implementation, the talker detector 128 has no prior information about the users 342. For example, the users 342 have not pre-enrolled with the device 302. In response to input of an audio embedding 152, the talker detector 128 outputs a first probability value 153, a second probability value 153, and a third probability value 153. Each probability value 153 indicates a probability that the audio embedding 152 represents speech of a respective talker 392, and each of the probability values 153 is compared to a probability value threshold 357. If one of the probability values 153 for the audio embedding 152 satisfies the probability value threshold 357, speech of the corresponding talker 392 is indicated as detected in the audio embedding 152. To illustrate, if the first probability value 153 for the audio embedding 152 satisfies the probability value threshold 357, speech of the talker 392A is indicated as detected in the audio embedding 152 (and the audio portion 151 represented by the audio embedding 152). A similar operation is performed for each of the audio embeddings 152A, the audio embeddings 152B, and the audio embeddings 152C.

The talker detector 128 uses a talker 392 as a placeholder for an unknown user (such as a user 342 who is unknown to the talker detector 128 as associated with speech represented by an audio embedding 152) during the segmentation window. For example, the audio embeddings 152A correspond to speech of a user 342A. The talker detector 128 generates the first probability value 153 for each of the audio embeddings 152A that satisfies the probability value threshold 357 to indicate that the audio embeddings 152A correspond to speech of the talker 392A (e.g., a placeholder for the user 342A). As another example, the audio embeddings 152C correspond to speech of a user 342B. The talker detector 128 generates the second probability value 153 for each of the audio embeddings 152C that satisfies the probability value threshold 357 to indicate that the audio embeddings 152C correspond to speech of the talker 392B (e.g., a placeholder for the user 342B).

In a particular implementation, the talker detector 128 may reuse the talker 392A (e.g., the first probability value 153) as a placeholder for another user (e.g., a user 342C) when speech of the talker 392A (e.g., the user 342A) has not been detected for a duration of the segmentation window, e.g., a threshold duration has expired since detecting previous speech associated with the talker 392A. The talker detector 128 can distinguish speech associated with more than the predetermined count of talkers (e.g., more than K talkers) in the audio stream 141 by reusing a talker placeholder for another user when a previous user associated with the talker placeholder has not spoken during a segmentation window. In a particular implementation, the talker detector 128, in response to determining that speech of each of the talker 392A (e.g., the user 342A), the talker 392B (e.g., the user 342B), and the talker 392C (e.g., the user 342C) is detected within the segmentation window and determining that speech associated with another user (e.g., a user 342D) is detected, re-uses a talker placeholder (e.g., the talker 392A) based on determining that speech of the talker 392A (e.g., the user 342A) was detected least recently.

In a particular aspect, the talker detector 128 includes or corresponds to a trained machine-learning model, such as a neural network. For example, analyzing the audio embeddings 152 includes applying a talker detection neural network (or another machine-learning-based system) to the audio embeddings 152. In a particular aspect, the talker detection neural network includes a recurrent neural network (RNN), a long short-term memory (LSTM) network, a gated recurrent unit (GRU) network, or a combination thereof.

In a particular aspect, the talker detector 128 generates a detected talkers result 356 based on the probability values 153. The detected talkers result 356 indicates the talkers 392 (if any) that are detected in an audio portion 151. For example, the detected talkers result 356 output by the talker detector 128 indicates that speech of a talker 392 is detected in response to determining that a probability value 153 for the talker 392 satisfies (e.g., is greater than) the probability value threshold 357. To illustrate, when the first probability value 153 of an audio embedding 152 satisfies the probability value threshold 357, the talker detector 128 generates the detected talkers result 356 (e.g., “1”) for the audio embedding 152 indicating that speech of the talker 392A is detected in the audio portion 151. In another example, when each of the first probability value 153 and the second probability value 153 of the audio embedding 152 satisfies the probability value threshold 357, the talker detector 128 generates the detected talkers result 356 (e.g., “1, 2”) for the audio embedding 152 to indicate that speech of the talker 392A and the talker 392B (e.g., multiple talkers) is detected in the audio portion 151. In a particular example, when each of the first probability value 153, the second probability value 153, and the third probability value 153 for the audio embedding 152 fails to satisfy the probability value threshold 357, the talker detector 128 generates the detected talkers result 356 (e.g., “0”) for the audio embedding 152 to indicate that silence (or non-speech audio) is detected in the audio portion 151. The talker detector 128 provides an output for the audio portion 151 (or the audio embedding 152) that includes the probability values 153, the detected talkers result 356, or both, to the profile manager 126.

The profile manager 126 is configured to, in response to determining that the audio embedding 152 represents speech of at least one talker 392 and does not match any of the enrolled speech profiles 150, generate a speech profile 150 based at least in part on the audio embedding 152. In a particular aspect, the profile manager 126 is configured to generate the speech profile 150 based on an audio portion 151 and an audio embedding 152 that pass an enroll quality check. For example, the profile manager 126 generates a quality metric 354 of the audio portion 151 and the audio embedding 152 based on the detected talkers result 356 (e.g., a count of talkers detected in the audio embedding 152), the probability values 153, an amount of noise detected in the audio portion 151, a signal-to-noise (SNR) value of the audio portion 151, or a combination thereof. The profile manager 126, in response to determining that the quality metric 354 satisfies an enroll quality criterion, determines that the audio portion 151 and the audio embedding 152 pass the enroll quality check. For example, the profile manager 126, in response to determining that the detected talkers result 356 indicates that the audio embedding 152 represents speech of a single talker, that the amount of noise is less than a noise threshold, that the SNR value is greater than a SNR threshold, or a combination thereof, determines that the audio portion 151 and the audio embedding 152 pass the enroll quality check.

In an example, the profile manager 126 is configured to generate a speech profile 150A for the talker 392A (e.g., placeholder for the user 342A) based on the audio embeddings 152A that pass the enroll quality check and to add the speech profile 150A to the enrolled speech profiles 150. The speech profile 150A represents (e.g., models) speech of the user 342A. Alternatively, the profile manager 126 is configured to, in response to determining that the audio embedding 152 matches an enrolled speech profile 150, update the enrolled speech profile 150 based on the audio embedding 152. For example, the profile manager 126 is configured to update the speech profile 150A that represents the speech of the user 342A based on subsequent audio portions that match the speech profile 150A independently of which talker 392 is used as a placeholder for the user 342A for the subsequent audio portions. In a particular aspect, the profile manager 126 outputs a profile ID 155, a profile name 157, or both, of the speech profile 150 responsive to generating or updating the speech profile 150. For example, the profile manager 126 outputs profile attribution data 125 indicating that the audio portion 151 is associated with the speech profile 150 having the profile ID 155, the profile name 157, or both.

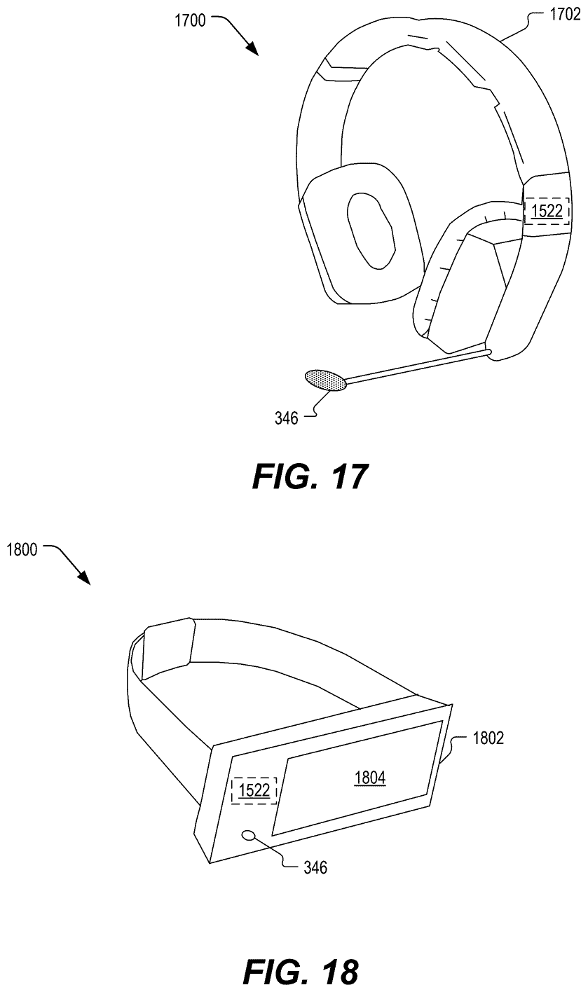

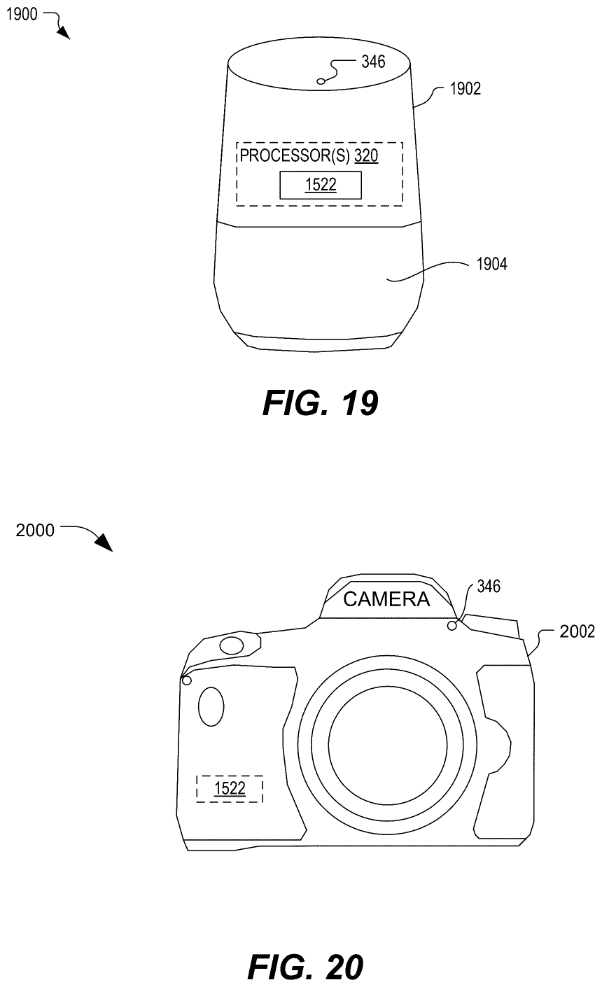

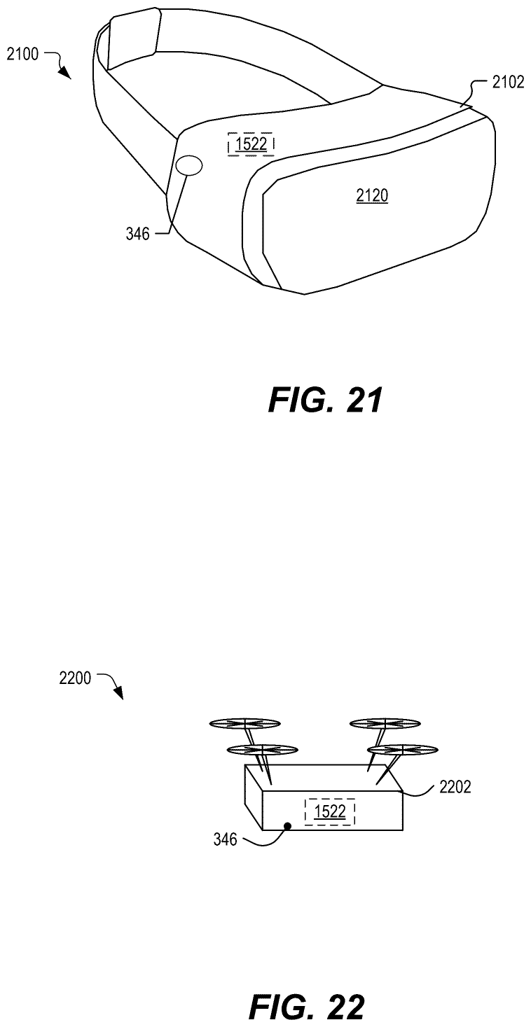

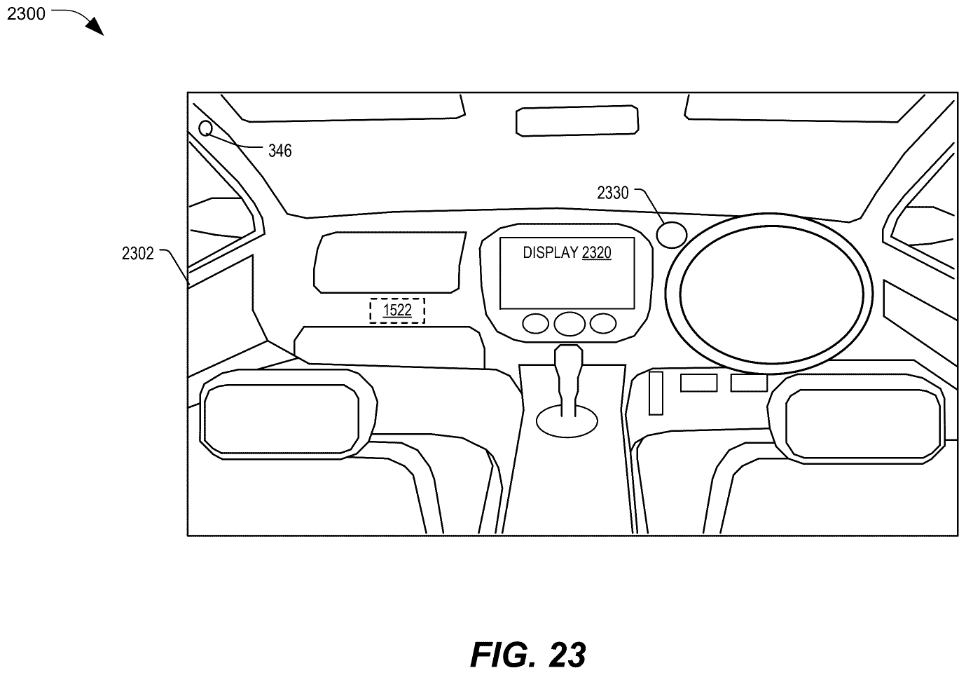

In some implementations, the device 302 corresponds to or is included in one of various types of devices. In an illustrative example, the one or more processors 320 are integrated in a headset device that includes the microphone 346, such as described further with reference to FIG. 17. In other examples, the one or more processors 320 are integrated in at least one of a mobile phone or a tablet computer device, as described with reference to FIG. 16, a wearable electronic device, as described with reference to FIG. 18, a voice-controlled speaker system, as described with reference to FIG. 19, a camera device, as described with reference to FIG. 20, or a virtual reality, mixed reality, or augmented reality headset, as described with reference to FIG. 21. In another illustrative example, the one or more processors 320 are integrated into a vehicle that also includes the microphone 346, such as described further with reference to FIG. 22 and FIG. 23.

During operation, the one or more processors 320 receive an audio stream 141 corresponding to speech of one or more users 342 (e.g., a user 342A, a user 342B, a user 342C, a user 342D, or a combination thereof). In a particular example, the one or more processors 320 receive the audio stream 141 from the microphone 346 that captures the speech of the one or more users 342. In another example, the audio stream 141 corresponds to an audio playback file stored in the memory 332, and the one or more processors 320 receive the audio stream 141 from the memory 332. In a particular aspect, the one or more processors 320 receive the audio stream 141 via an input interface or a network interface (e.g., a network interface of a modem) from another device.

During a feature extraction stage, the feature extractor 122 generates audio embeddings 152 of the audio stream 141. For example, the feature extractor 122 determines feature values of audio portions 151 of the audio stream 141 to generate the audio embeddings 152. In a particular example, the audio stream 141 includes audio portions 151A, audio portions 151B, audio portions 151C, or a combination thereof. The feature extractor 122 generates audio embeddings 152A representing feature values of the audio portions 151A, audio embeddings 152B representing feature values of the audio portions 151B, and audio embeddings 152C representing feature values of the audio portions 151C, or a combination thereof. For example, the feature extractor 122 extracts audio feature values of the audio portion 151 to generate an audio embedding 152 (e.g., a feature vector) for an audio portion 151 (e.g., an audio frame).

During a talker detection stage, the talker detector 128 analyzes the audio embeddings 152 to generate probability values 153. For example, the talker detector 128 analyzes the audio embedding 152 (e.g., a feature vector) of the audio portion 151 (e.g., an audio frame) to generate probability values 153 for the audio portion 151. In a particular example, the talker detector 128 analyzes audio embeddings 152A, the audio embeddings 152B, and the audio embeddings 152C to generate probability values 153A, probability values 153B, and probability values 153C, respectively.

The probability values 153 of an audio portion 151 include a first probability value 153 (e.g., 0.6) indicating a likelihood that the audio portion 151 corresponds to speech of a talker 392A. The probability values 153 also include a second probability value 153 (e.g., 0) and a third probability value 153C (e.g., 0) indicating a likelihood of the audio portion 151 corresponding to speech of a talker 392B and a talker 392C, respectively.

In a particular aspect, the talker detector 128, in response to determining that the first probability value 153 satisfies the probability value threshold 357 and each of the second probability value 153 and the third probability value 153 fails to satisfy the probability value threshold 357, generates a detected talkers result 356 (e.g., “1”) indicating that the audio portion 151 corresponds to speech of the talker 392A and does not correspond to speech of either the talker 392B or the talker 392C. The talker detector 128 generates an output indicating the probability values 153, the detected talkers result 356, or both, for the audio portion 151.

In some implementations, the talker detector 128, in response to determining that each of multiple probability values 153 (e.g., the first probability value 153 and the second probability value 153) satisfy the probability value threshold 357, generates a detected talkers result 356 (e.g., “1, 2”) indicating that the audio portion 151 corresponds to speech of multiple talkers (e.g., the talker 392A and the talker 392B).

The profile manager 126 is configured to, during a profile check stage, determine whether the audio embedding 152 matches an existing enrolled speech profile 150. In a particular aspect, the profile manager 126 uses the same audio features for the comparison with or update of the speech profiles 150 as the audio features used by the talker detector 128 to generate the detected talkers result 356. In another aspect, the profile manager 126 uses second audio features for the comparison with or update of the speech profiles 150 that are distinct from first audio features used by the talker detector 128 to generate the detected talkers result 356.

In a particular implementation, the profile manager 126 is configured to collect audio embeddings 152 corresponding to the same talker in a probe buffer 340 prior to comparing with the speech profiles 150 to improve accuracy of the comparison. If the audio embedding 152 matches an existing speech profile 150, the profile manager 126 is configured to, during an update stage, update the existing speech profile 150 based on the audio embedding 152 if the audio embedding 152 passes an update quality check. For example, the profile manager 126, in response to determining that a quality metric 354 of the audio embedding 152 satisfies an update quality criterion, determines that the audio embedding 152 passes the update quality check. If the audio embedding 152 does not match an existing speech profile, the profile manager 126 is configured to, during an enrollment stage, add the audio embedding 152 to an enroll buffer 334 if the audio embedding 152 passes the enrollment quality check. The profile manager 126 is configured to, in response to determining that the audio embeddings 152 stored in the enroll buffer 334 satisfy the enroll threshold 364, generate a speech profile 150 based on the audio embeddings 152 stored in the enroll buffer 334.

During the profile check stage, the profile manager 126, in response to determining that no enrolled speech profiles are available and that the detected talkers result 356 indicates that the audio portion 151 corresponds to speech of a talker (e.g., the talker 392A), adds the audio embedding 152 to the enroll buffer 334 (e.g., the enroll buffer 334A) that is designated for the talker 392 and proceeds to an enrollment stage.

In a particular aspect, the profile manager 126, in response to determining that at least one enrolled speech profile 150 is available, determines whether the audio embedding 152 matches any of the at least one enrolled speech profile 150. For example, the profile manager 126, in response to determining that at least one speech profile 150 is available and that the detected talkers result 356 indicates that the audio portion 151 corresponds to speech of a talker 392 (e.g., the talker 392A), adds the audio embedding 152 to the probe buffer 340 (e.g., the probe buffer 340A) that is designated for the talker 392. The profile manager 126 determines whether the audio embeddings (e.g., including the audio embedding 152) stored in the probe buffer 340 match any of the at least one speech profile 150. To illustrate, the profile manager 126 generates speech profile results 338 based on a comparison of the audio embeddings (e.g., including the audio embedding 152) of the probe buffer 340 (e.g., the probe buffer 340A) and each of the at least one speech profile 150. To illustrate, the profile manager 126 generates a speech profile result 338A based on a comparison of the audio embeddings (e.g., including the audio embedding 152) of the probe buffer 340 (e.g., the probe buffer 340A) and a speech profile 150A.

In a particular aspect, the profile manager 126, in response to determining that a single audio embedding (e.g., the audio embedding 152) is available in the probe buffer 340 (e.g., the probe buffer 340A), generates the speech profile result 338A based on a comparison of the single audio embedding and the speech profile 150A. Alternatively, the profile manager 126, in response to determining that multiple audio embeddings (e.g., including the audio embedding 152) are available in the probe buffer 340 (e.g., the probe buffer 340A), generates the speech profile result 338A based on comparisons of the multiple audio embeddings and speech profile 150A. For example, the profile manager 126 generates a first audio embedding result based on a comparison of the audio embedding 152 and the speech profile 150A, a second audio embedding result based on a comparison of a second audio embedding of the probe buffer 340 and the speech profile 150A, additional audio embedding results based on comparisons of additional audio embeddings of the probe buffer 340 and the speech profile 150A, or a combination thereof. The profile manager 126 generates the speech profile result 338A based on (e.g., a weighted average of) the first audio embedding result, the second audio embedding result, the additional audio embedding results, or a combination thereof. In a particular aspect, higher weights are assigned to audio embedding results of audio embeddings that are more recently added to the probe buffer 340.

The speech profile result 338A indicates a likelihood that the audio embeddings match the speech profile 150A. Similarly, the profile manager 126 generates a speech profile result 338B based on a comparison of the audio embeddings (e.g., including the audio embedding 152) of the probe buffer 340 (e.g., the probe buffer 340A) and a speech profile 150B.

In a particular aspect, the profile manager 126 selects a speech profile result 338 that indicates a highest likelihood that the audio embedding 152 matches the corresponding speech profile 150. For example, the profile manager 126 selects the speech profile result 338A in response to determining that the speech profile result 338A indicates higher likelihood of a match than (e.g., is greater than or equal to) the speech profile result 338B. The profile manager 126, in response to determining that the speech profile result 338A (e.g., the speech profile result 338A indicating a highest likelihood of a match) satisfies (e.g., is greater than or equal to) the profile threshold 358, determines that the audio embeddings stored in the probe buffer 340 (e.g., the probe buffer 340A) match the speech profile 150A and proceeds to the update stage. Alternatively, the profile manager 126, in response to determining that the speech profile result 338A (e.g., the speech profile result 338A indicating a highest likelihood of a match) fails to satisfy (e.g., is less than) the profile threshold 358, determines that the audio embeddings stored in the probe buffer 340 (e.g., the probe buffer 340A) do not match any of the speech profiles 150 and proceeds to the enrollment stage.

During the update stage, the profile manager 126, in response to determining that the audio embedding 152 matches a speech profile 150 (e.g., the speech profile 150A), updates the speech profile 150 and outputs profile attribution data 125 indicating that the audio embedding 152 (corresponding to the audio portion 151) represents speech that matches the speech profile 150. The profile manager 126 updates the speech profile 150 (that matched the audio embeddings stored in the probe buffer 340) based on the audio embeddings stored in the probe buffer 340. The speech profile 150A thus evolves over time to match changes in user speech.

During the enrollment stage, the profile manager 126, in response to determining that the detected talkers result 356 indicates that the audio embedding 152 represents speech of a talker 392 (e.g., the talker 392A), adds the audio embedding 152 to an enroll buffer 334 (e.g., the enroll buffer 334A) corresponding to the talker 392. The profile manager 126 determines whether the audio embeddings stored in the enroll buffer 334 satisfy the enroll threshold 364. In a particular aspect, the profile manager 126 determines that the audio embeddings stored in the enroll buffer 334 satisfy the enroll threshold 364 in response to determining that a count of the audio embeddings is greater than or equal to the enroll threshold 364 (e.g., 48 audio embeddings). In another aspect, the profile manager 126 determines that the audio embeddings stored in the enroll buffer 334 satisfy the enroll threshold 364 in response to determining that a speech duration (e.g., a playback duration) of the audio embeddings is greater than or equal to the enroll threshold 364 (e.g., 2 seconds).

The profile manager 126, in response to determining that the audio embeddings stored in the enroll buffer 334 fail to satisfy the enroll threshold 364, refrains from generating a speech profile 150 based on the audio embeddings stored in the enroll buffer 334 and continues to process subsequent audio portions of the audio stream 141. In a particular aspect, the profile manager 126 continues to add subsequent audio embeddings representing speech of the talker 392 (e.g., the talker 392A) to the enroll buffer 334 (e.g., the enroll buffer 334A) until the stop condition 370 is satisfied. For example, the profile manager 126 determines that the stop condition 370 is satisfied in response to determining that the count of audio embeddings (e.g., including the audio embedding 152) stored in the enroll buffer 334 satisfies the enroll threshold 364, that longer than threshold silence is detected in the audio stream 141, or both, as described herein. To illustrate, the stop condition 370 is satisfied when enough audio embeddings are in the enroll buffer 334 to generate a speech profile or when the talker 392 appears to have stopped talking.

In a particular example, the profile manager 126, in response to determining that the audio embeddings (e.g., including an audio embedding 152) stored in the enroll buffer 334A (e.g., corresponding to the talker 392A) satisfy the enroll threshold 364, generates a speech profile 150C based on the audio embeddings stored in the enroll buffer 334A, resets the enroll buffer 334A, adds the speech profile 150C to the enrolled speech profiles 150, outputs profile attribution data 125, and continues to process subsequent audio portions of the audio stream 141. The profile manager 126 thus generates the speech profile 150C based on audio embeddings of audio portions corresponding to the same talker 392 (e.g., the talker 392A) that are stored in the enroll buffer 334 (e.g., the enroll buffer 334A) designated for the talker 392 (e.g., the talker 392A). Using multiple audio embeddings to generate the speech profile 150C improves accuracy of the speech profile 150C in representing the speech of the talker 392A (e.g., the user 342B). The talker detector 128 and the profile manager 126 thus enable passive enrollment of multiple users by generating speech profiles for users that do not have to be pre-enrolled and do not have to speak pre-determined words or sentences for speech profile generation.

In a particular example, the profile manager 126 generates the profile attribution data 125A indicating one or more of the speech profiles 150 that are generated or updated based on the audio embedding 152A, the profile attribution data 125B indicating one or more of the speech profiles 150 that are generated or updated based on the audio embedding 152B, the profile attribution data 125C indicating one or more of the speech profiles 150 that are generated or updated based on the audio embedding 152C, or a combination thereof.

In a particular aspect, audio portions that fail to satisfy a quality criterion (e.g., corresponding to multiple talkers, noisy, low SNR, etc.) are skipped or disregarded for generating or updating speech profiles 150. For example, the profile manager 126, in response to determining that the quality metric 354 of the audio portion 151 and the audio embedding 152 fails to satisfy the update quality criterion and the enrollment quality criterion, disregards the audio embedding 152 of the audio portion 151 for updating or generating a speech profile, and continues to process subsequent audio portions of the audio stream 141. For example, disregarding the audio embedding 152 includes refraining from updating a speech profile 150 based on the audio embedding 152, refraining from generating a speech profile 150 based on the audio embedding 152, or both.

In some aspects, the profile manager 126, independently of whether an audio portion 151 satisfies a quality criterion, outputs the profile attribution data 125 in response to determining that the audio embedding 152 matches an enrolled speech profile 150. For example, the profile attribution data 125 indicates that the audio portion 151 represents speech that matches the speech profile 150. In another example, the profile manager 126, in response to determining that the audio embedding 152 matches a speech profile 150A and that the speech profile 150A is not mature (e.g., a count of audio embeddings of the speech profile 150A is less than the maturity threshold 361), identifies another enrolled speech profile that is mature and is closest to the speech profile 150A. To illustrate, the profile manager 126, in response to identifying one or more of the enrolled speech profiles 150 that are mature and determining that a distance (e.g., a centroid distance or a nearest audio embedding distance) between the speech profile 150A and a speech profile 150B is lowest among distances from the speech profile 150A to the mature speech profiles, generates the profile attribution data 125 indicating that the audio portion 151 represents speech that likely matches or is closest to the speech profile 150B.

During a merge check stage, the profile manager 126 determines whether a speech profile 150 is to be merged with another speech profile of the enrolled speech profiles 150, as described with reference to FIG. 2A. In a particular aspect, the profile manager 126, in response to generating a speech profile 150A and prior to adding the speech profile 150A to the enrolled speech profiles 150, determines whether the speech profile 150A is to be merged with an already enrolled speech profile 150. In a particular aspect, the profile manager 126, in response to determining that the audio embedding 152 matches an enrolled speech profile 150A that is not mature, determines whether the speech profile 150A is to be merged with another of the enrolled speech profiles 150. For example, the profile manager 126 determines a similarity metric 228 based on a distance (e.g., a centroid distance, a nearest audio embedding distance, or both) between the speech profile 150A and a speech profile 150B, as described with reference to FIG. 2A. The profile manager 126, in response to determining that the similarity metric 228 (e.g., the distance) satisfies (e.g., is less than) a similarity threshold, determines that the speech profile 150A is to be merged with the speech profile 150B. The profile manager 126 moves the audio embeddings of the speech profile 150A to the speech profile 150B and discards the speech profile 150A. For example, the profile manager 126 removes the speech profile 150A from the enrolled speech profiles 150 or refrains from adding the speech profile 150A to the enrolled speech profiles 150.

In a particular aspect, audio portions corresponding to shorter than threshold silence (e.g., indicative of natural short pauses in speech of the same user) are not used to generate or update a speech profile 150 but are tracked to detect a longer than threshold silence. For example, during the talker detection stage, the talker detector 128 generates a detected talkers result 356 for the audio embedding 152 indicating that the audio portion 151 corresponds to silence. The profile manager 126 increments (e.g., by 1) a silence count 362 in response to determining that the audio portion 151 corresponds to silence. In a particular aspect, the profile manager 126, in response to determining that the silence count 362 is greater than or equal to the silence threshold 394 (e.g., indicative of a longer pause after a user has finished speaking), resets (e.g., marks as empty) the enroll buffers 334 (e.g., the enroll buffer 334A, the enroll buffer 334B, and the enroll buffer 334C), resets (e.g., marks as empty) the probe buffers 340 (e.g., the probe buffer 340A, the probe buffer 340B, and the probe buffer 340C), resets (e.g., to 0) the silence count 362, or a combination thereof, and continues to process subsequent audio portions of the audio stream 141. In a particular aspect, the profile manager 126 determines that the stop condition 370 is satisfied in response to determining that the silence count 362 is greater than or equal to the silence threshold 394. The profile manager 126 resets the enroll buffers 334 (e.g., the enroll buffer 334A, the enroll buffer 334B, and the enroll buffer 334C) in response to determining that the stop condition 370 is satisfied.

In a particular aspect, the profile manager 126 provides a notification to a display device coupled to the device 302. The notification indicates that speech analysis is in progress. In a particular aspect, the profile manager 126 selectively processes the audio stream 141 based on a user input indicating whether speech analysis is to be performed.

In a particular aspect, the profile manager 126 provides the profile attribution data 125 to the transcript generator 140. The speech recognizer 182 processes the audio portion(s) 151 to generate speech text 183 and provides the speech text 183 to the transcript generator 140, as described with reference to FIG. 1A. The transcript generator 140 generates the transcript 143 based on the profile attribution data 125 and the speech text 183, as described with reference to FIG. 1A.

In a particular implementation, one or more audio portions 151, the audio embeddings 152, or a combination thereof, are stored in the buffer 184, and the one or more processors 320 access the one or more audio portions 151, the audio embeddings 152, or a combination thereof, from the buffer 184. For example, the one or more processors 320 store an audio portion 151 in the buffer 184. The feature extractor 122 retrieves the audio portion 151 from the buffer 184 and stores an audio embedding 152 in the buffer 184. The talker detector 128 retrieves the audio embedding 152 from the buffer 184 and stores the probability values 153, the detected talkers result 356, or a combination thereof, of the audio embedding 152 in the buffer 184. The profile manager 126 retrieves the audio embedding 152, the probability values 153, the detected talkers result 356, or a combination thereof, from the buffer 184. In a particular aspect, the profile manager 126 stores the profile attribution data 125 in the buffer 184. In a particular aspect, the speech recognizer 182 retrieves the audio portion 151 from the buffer 184 and stores speech text 183 in the buffer 184. In a particular aspect, the transcript generator 140 retrieves the profile attribution data 125, the speech text 183, or both, from the buffer 184.

The device 302 thus enables passive speech profile enrollment and update for multiple talkers. For example, the enrolled speech profiles 150 can be generated and updated in the background during regular operation of the device 302 without having the users 342 having to say predetermined words or sentences from a script.

Although the microphone 346 is illustrated as being coupled to the device 302, in other implementations the microphone 346 may be integrated in the device 302. Although a single microphone 346 is illustrated, in other implementations one or more additional microphones 346 configured to capture user speech may be included.

Although a single device 302 is described as included in the system 100 or the system 190, in other implementations operations described as being performed at the device 302 may be distributed among multiple devices. For example, operations described as being performed by one or more of the feature extractor 122, the talker detector 128, the profile manager 126, the speech recognizer 182, or the transcript generator 140 may be performed at the device 302, and operations described as being performed by others of the feature extractor 122, the talker detector 128, the profile manager 126, the speech recognizer 182, or the transcript generator 140 may be performed at a second device.

Referring to FIG. 3B, a diagram 350 is shown of a particular illustrative aspect of operations of components of the device 302 of FIG. 3A, in accordance with some examples of the present disclosure. For example, the one or more processors 320 include the speech segmentor 104. The speech segmentor 104 includes the profile audio segment identifier 124 and the profile audio segmentor 130, as described with reference to FIG. 1B.

The memory 332 is configured to store end-point detection data 133 maintained by the profile audio segment identifier 124 and profile audio segment information 131 generated by the profile audio segmentor 130. The end-point detection data 133 indicates an audio segment time period of an audio segment of a speech profile 150. A set of audio portions 151 that represents speech that matches a particular speech profile is referred to as an audio segment of the particular speech profile.

In a particular aspect, the speaker diarizer 102 generates the profile attribution data 125, as described with reference to FIG. 3A, and provides the profile attribution data 125 to the profile audio segment identifier 124. The profile audio segment identifier 124 maintains end-point detection data 133 based on the profile attribution data 125, as described with reference to FIG. 1B.

In an example, the speaker diarizer 102 generates profile attribution data 125A indicating that audio portions 151A represent speech that matches the speech profile 150A. The profile audio segment identifier 124, in response to determining that the end-point detection data 133 indicates that no audio segment of the speech profile 150A (e.g., the profile identifier 155A) is in-progress, updates an audio segment start time of the speech profile 150A in the end-point detection data 133 to indicate that an audio segment of the speech profile 150A is in-progress. The audio segment start time is based on a start time of the audio portions 151A.

In a particular aspect, the speaker diarizer 102 generates profile attribution data 125B indicating that audio portions 151B represent speech that matches the speech profile 150A and the speech profile 150B. The profile audio segment identifier 124, in response to determining that the end-point detection data 133 indicates that the audio segment of the speech profile 150A (e.g., the profile identifier 155A) is in-progress, refrains from updating the end-point detection data 133 for the speech profile 150A. The profile audio segment identifier 124, in response to determining that the end-point detection data 133 indicates that no audio segment of the speech profile 150B (e.g., the profile identifier 155B) is in-progress, updates an audio segment start time of the speech profile 150B in the end-point detection data 133 to indicate that an audio segment of the speech profile 150B is in-progress. The audio segment start time is based on a start time of the audio portions 151B.

In a particular aspect, the speaker diarizer 102 generates profile attribution data 125C indicating that audio portions 151C represent speech that matches the speech profile 150B. The profile audio segment identifier 124, in response to determining that the end-point detection data 133 indicates that the audio segment of the speech profile 150A (e.g., the profile identifier 155A) is in-progress and that the profile attribution data 125C indicates that audio portions 151C do not represent speech that matches the speech profile 150A, updates an audio segment end time of the speech profile 150A in the end-point detection data 133 to indicate that an audio segment of the speech profile 150A has ended. The audio segment end time is based on a start time of the audio portions 151C. The profile audio segment identifier 124, in response to determining that an audio segment of the speech profile 150A has ended, generates profile audio segment information 131A of the audio segment of the speech profile 150A. The profile audio segment information 131A indicates that an audio segment of the speech profile 150A includes the audio portions 151A and the audio portions 151B, that the audio segment of the speech profile 150A extends from the audio segment start time (e.g., a start time of the audio portions 151A) to the audio segment end time (e.g., a start time of the audio portions 151C) indicated in the end-point detection data 133, or both. The profile audio segment identifier 124 provides the profile audio segment information 131A to the profile audio segmentor 130.

The profile audio segment identifier 124, in response to determining that the profile attribution data 125C indicates that audio portions 151C represent speech that matches the speech profile 150B and that the end-point detection data 133 indicates that an audio segment of the speech profile 150B (e.g., the profile identifier 155B) is in-progress, refrains from updating the end-point detection data 133 for the speech profile 150B.

The profile audio segmentor 130, in response to receiving the profile audio segment information 131A associated with the speech profile 150A, identifies one or more audio portions associated with an audio segment of the speech profile 150A. In some implementations, the profile audio segmentor 130, in response to determining that the profile audio segment information 131A indicates that an audio segment of the speech profile 150A includes the audio portions 151A and the audio portions 151B, identifies the audio portions 151A and the audio portions 151B as the identified audio portions associated with the audio segment. In other implementations, the profile audio segmentor 130, in response to determining that the profile audio segment information 131A indicates that an audio segment of the speech profile 150A extends from an audio segment start time to an audio segment end time, identifies the one or more audio portions (e.g., the audio portions 151A and the audio portions 151B) that have an audio portion start time that is greater than or equal to the audio segment start time and less than the audio segment end time.

The profile audio segmentor 130 retrieves the one or more identified audio portions from the buffer 184 and processes the retrieved audio portions based on the speech profile 150A identified in the profile audio segment information 131A to generate one or more filtered audio portions. For example, the profile audio segmentor 130 retrieves the audio portions 151A from the buffer 184 and processes the audio portions 151A based on the speech profile 150A to generate filtered audio portions 159AA. The filtered audio portions 159AA represent speech that matches the speech profile 150A. In a particular aspect, the profile audio segmentor 130 removes speech that does not match the speech profile 150A from the audio portions 151A to generate the filtered audio portions 159AA. As another example, the profile audio segmentor 130 retrieves the audio portions 151B from the buffer 184 and processes the audio portions 151B based on the speech profile 150A to generate filtered audio portions 159AB. The filtered audio portions 159AB represent speech that matches the speech profile 150A. In a particular aspect, the profile audio segmentor 130 removes speech that does not match the speech profile 150A from the audio portions 151B to generate the filtered audio portions 159AB.

The profile audio segmentor 130 generates a profile audio segment 127 including the one or more filtered audio portions. For example, the profile audio segmentor 130 generates a profile audio segment 127A including the filtered audio portions 159AA and the filtered audio portion 159AB.

The profile audio segmentor 130 provides the profile audio segment 127 to one or more audio analysis applications. For example, the profile audio segmentor 130 provides the profile audio segment 127A associated with the speech profile 150A (e.g., the profile identifier 155A) to the speech recognizer 182. The speech recognizer 182 uses speech recognition techniques to process the profile audio segment 127A to generate speech text 183A associated with the speech profile 150A (e.g., the profile identifier 155A).

The speech recognizer 182 provides speech text 183 to one or more speech text analysis applications. For example, the speech recognizer 182 provides the speech text 183A associated with the speech profile 150A (e.g., the profile identifier 155A) to the transcript generator 140, and the transcript generator 140 generates a transcript 143 based on the speech text 183A and the speech profile 150A. For example, the transcript 143 includes the speech text 183A and a label indicating that the speech text 183A is associated with the profile name 157A of the speech profile 150A. In a particular aspect, the transcript 143 indicates that the speech text 183A is associated with the audio segment start time, the audio segment end time, or both, indicated by the profile audio segment information 131A.

In a particular aspect, the speaker diarizer 102 generates profile attribution data 125D indicating that audio portions 151D do not represent speech that matches the speech profile 150B. The profile audio segment identifier 124 updates the end-point detection data 133 to indicate that an audio segment of the speech profile 150B has ended and generates profile audio segment information 131B of the audio segment of the speech profile 150B. The profile audio segment identifier 124 provides the profile audio segment information 131B to the profile audio segmentor 130.

The profile audio segmentor 130, in response to receiving the profile audio segment information 131B associated with the speech profile 150B, retrieves one or more audio portions (e.g., the audio portions 151B and the audio portions 151C) associated with an audio segment of the speech profile 150B from the buffer 184 and processes the retrieved audio portions based on the speech profile 150B identified in the profile audio segment information 131B to generate one or more filtered audio portions. For example, the profile audio segmentor 130 processes the audio portions 151B based on the speech profile 150B to generate filtered audio portions 159BB. The filtered audio portions 159BB represent speech that matches the speech profile 150B. In a particular aspect, the profile audio segmentor 130 removes speech that does not match the speech profile 150B from the audio portions 151B to generate the filtered audio portions 159BB. As another example, the profile audio segmentor 130 processes the audio portions 151C based on the speech profile 150B to generate filtered audio portions 159BC. The profile audio segmentor 130 generates a profile audio segment 127B including the filtered audio portions 159BB and the filtered audio portion 159BC.

The speech recognizer 182 uses speech recognition techniques to process the profile audio segment 127B to generate speech text 183B associated with the speech profile 150B (e.g., the profile identifier 155B). The transcript generator 140 updates the transcript 143 based on the speech text 183B and the speech profile 150B. For example, the transcript 143 includes the speech text 183B and a label indicating that the speech text 183B is associated with the profile name 157B of the speech profile 150B. In a particular aspect, the transcript 143 indicates that the speech text 183B is associated with the audio segment start time, the audio segment end time, or both, indicated by the profile audio segment information 131B.

In some implementations, the one or more processors 320 are configured to operate in the non-conversation mode 174 (e.g., when a conversation is not detected) or a conversation mode 176 (e.g., when a conversation is detected). In a particular aspect, the non-conversation mode 174 is a lower power mode as compared to the conversation mode 176. For example, the one or more processors 320 conserve energy by operating in the non-conversation mode 174 (as compared to the conversation mode 176) and transition to the conversation mode 176 as needed to activate components (e.g., the speech segmentor 104) that do not operate in the non-conversation mode 174.

In a particular example, some of the functions of the device 302 are active in the conversation mode 176 but not in the non-conversation mode 174. For example, the speaker diarizer 102 can be activated in the non-conversation mode 174 and in the conversation mode 176. In this example, the speech segmentor 104 can be activated in the conversation mode 176 and not in the non-conversation mode 174. When the audio stream 141 does not correspond to a conversation, the speech segmentor 104 does not have to be used to distinguish between audio portions corresponding to different talkers. Staying in (or transitioning to) the non-conversation mode 174 when the speech segmentor 104 does not have to be used reduces overall resource consumption. The profile manager 126 is configured to determine, in the non-conversation mode 174, whether the audio stream 141 corresponds to a conversation, as further described with reference to FIG. 13. The profile manager 126 is configured to, in response to determining that the audio stream 141 corresponds to a conversation, transition the one or more processors 320 from the non-conversation mode 174 to the conversation mode 176 and activate the speech segmentor 104. For example, the speech segmentor 104 generates filtered audio portions in the conversation mode 176.

A technical advantage of using the speech segmentor 104 includes improved accuracy of the portion of the speech text 183A and the portion of the speech text 183B corresponding to the audio portion 151B (that represents speech that matches multiple speech profiles) because the speech text 183A and the speech text 183B are generated from filtered audio portions that each include speech corresponding to distinct speech profiles.

Referring to FIG. 4, an illustrative aspect of operations 400 associated with speech profile management is shown, in accordance with some examples of the present disclosure. In a particular aspect, one or more of the operations 400 are performed by the feature extractor 122, the talker detector 128, the profile manager 126, the speaker diarizer 102, the system 100 of FIG. 1A, the one or more processors 320, the device 302 of FIG. 3A, or a combination thereof.

During talker detection (det.) 402, the feature extractor 122 of FIG. 1A generates audio embeddings 152 based on the audio stream 141, as described with reference to FIGS. 1A and 3A. The talker detector 128 analyzes the audio embeddings 152 to generate the probability values 153, as described with reference to FIGS. 1A and 3A.

During voice profile management 404, the profile manager 126 of FIG. 1A determines whether an audio embedding 152 corresponds to an enrolled talker, at 406. For example, the profile manager 126 determines whether the audio embedding 152 matches any speech profile 150, as described with reference to FIGS. 1A and 3A. The profile manager 126, in response to determining, at 406, that the audio embedding 152 matches a speech profile 150A having a profile ID 155, updates the speech profile 150A based at least in part on the audio embedding 152, at 408, and determines whether the speech profile 150A is to be merged with another speech profile of the enrolled speech profiles 150, at 410. For example, the profile manager 126, in response to determining that a similarity metric between the speech profile 150A and another speech profile satisfies a similarity threshold, merges the speech profile 150A with the other speech profile. The profile manager 126, after merging, at 410, the speech profile 150A with the other speech profile or after determining, at 410, that the speech profile 150A is not to be merged with another speech profile, returns to 406 to process subsequent audio portions of the audio stream 141. Alternatively, the profile manager 126, in response to determining, at 406, that the audio embedding 152 does not match any of the enrolled speech profiles 150 and that the probability values 153 indicates that the audio embedding 152 represents speech of the talker 392A, adds the audio embedding 152 to the enroll buffer 334A designated for the talker 392A, at 412.

The profile manager 126, in response to determining, at 414, that a count of audio embeddings of the enroll buffer 334A (or a speech duration of the audio embeddings of the enroll buffer 334A) is less than or equal to the enroll threshold 364, returns to 406 to process subsequent audio portions of the audio stream 141. Alternatively, the profile manager 126, in response to determining, at 414, that the count of audio embeddings of the enroll buffer 334A (or a speech duration of the audio embeddings of the enroll buffer 334A) is greater than the enroll threshold 364, generates a speech profile 150C based on the audio embeddings of the enroll buffer 334A and determines whether the speech profile 150C is to be merged with an enrolled speech profile 150, at 416. For example, the profile manager 126, in response to determining that a similarity metric between the speech profile 150C and another speech profile satisfies a similarity threshold, merges the speech profile 150C with the other speech profile and returns to 406 to process subsequent audio portions of the audio stream 141. Alternatively, the profile manager 126, in response to determining, at 416, that the speech profile 150C is not to be merged with another enrolled speech profile 150, enrolls the talker, at 418. For example, the profile manager 126 adds the speech profile 150C to the enrolled speech profiles 150, as described with reference to FIGS. 1A and 3A. The profile manager 126 continues to process subsequent audio portions of the audio stream 141.

The probability values 153, generated during the talker detection 402, thus enable audio embeddings corresponding to speech of the same talker to be collected in the same enroll buffer for talker enrollment during voice profile management 404. Generating the speech profile 150C based on multiple audio embeddings improves accuracy of the speech profile 150C in representing the speech of the talker.

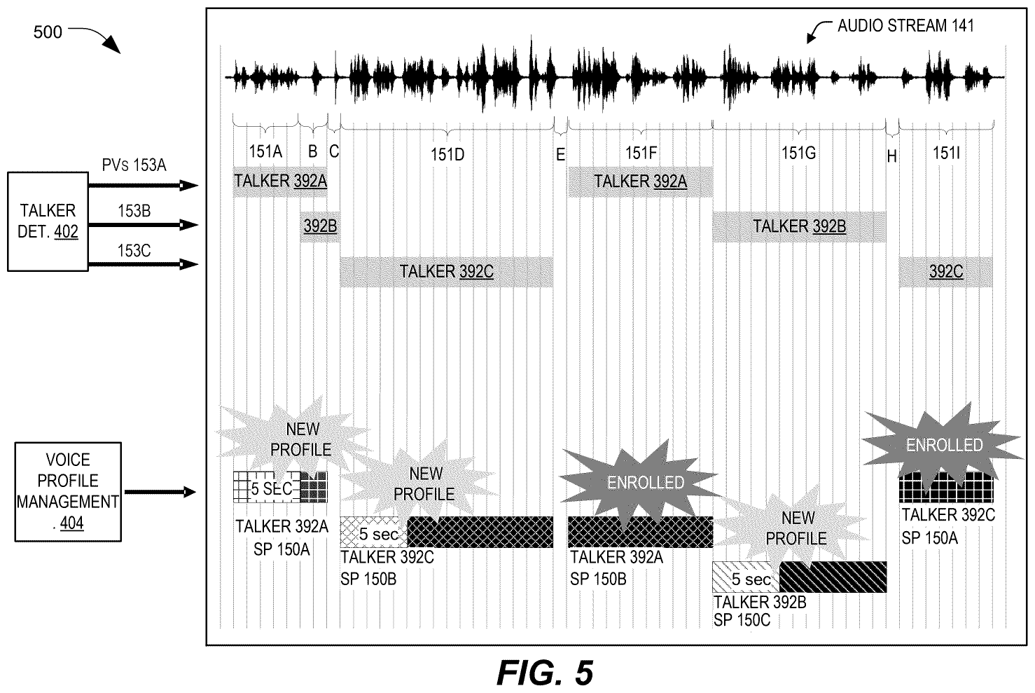

Referring to FIG. 5, an illustrative aspect of operations 500 associated with speech profile management are shown, in accordance with some examples of the present disclosure. In a particular aspect, one or more of the operations 500 are performed by the feature extractor 122, the talker detector 128, the profile manager 126, the speaker diarizer 102, the system 100 of FIG. 1, the one or more processors 320, the device 302 of FIG. 3A, or a combination thereof.

The audio stream 141 includes audio portions 151A-audio portions 151I. During the talker detection 402, the talker detector 128 of FIG. 1A generates first probability values 153A, second probability values 153B, and third probability values 153C for each of the audio portions 151A-I, as described with reference to FIGS. 1A and 3A.

The probability values 153 indicate that the audio portions 151A correspond to speech of the same single talker (e.g., designated as a talker 392A). For example, the first probability values 153A of each of the audio portions 151A satisfies the probability value threshold 357. The second probability values 153B and the third probability values 153C of each of the audio portions 151A do not satisfy the probability value threshold 357.

During the voice profile management 404, the profile manager 126 adds the audio portions 151A (e.g., the corresponding audio embeddings) in the enroll buffer 334A associated with the talker 392A. The profile manager 126 generates a speech profile 150A based on the audio portions 151A (e.g., the corresponding audio embeddings).

In a particular aspect, the probability values 153 indicate that audio portions 151B correspond to speech of multiple talkers, e.g., the talker 392A and another talker (e.g., designated as a talker 392B). In FIG. 5, the profile manager 126 updates the speech profile 150A based on the audio portions 151B (e.g., the corresponding audio embeddings). In a particular aspect, the profile manager 126 also adds the audio portions 151B to an enroll buffer 334B associated with the talker 392B. In an alternative aspect, the profile manager 126 disregards the audio portions 151B corresponding to multiple talkers for update or enrollment. For example, the profile manager 126 refrains from using the audio portions 151B to update or generate a speech profile 150.

The probability values 153 indicate that audio portions 151C correspond to speech of the talker 392B (e.g., a single talker). The profile manager 126 adds the audio portions 151C to the enroll buffer 334B. The profile manager 126, in response to determining that the audio portions (e.g., the corresponding audio embeddings) stored in the enroll buffer 334B fail to satisfy the enroll threshold 364, refrains from generating a speech profile 150 based on the audio portions (e.g., the corresponding audio embeddings) stored in the enroll buffer 334B. In a particular aspect, the audio portions (e.g., the corresponding audio embeddings) stored in the enroll buffer 334B include the audio portions 151B (e.g., the corresponding audio embeddings) and the audio portions 151C (e.g., the corresponding audio embeddings). In an alternative aspect, the audio portions (e.g., the corresponding audio embeddings) stored in the enroll buffer 334B include the audio portions 151C (e.g., the corresponding audio embeddings) and do not include the audio portions 151B (e.g., the corresponding audio embeddings).

The probability values 153 indicate that audio portions 151D correspond to speech of another single talker (e.g., designated as the talker 392C). The profile manager 126 adds a first subset of the audio portions 151D (e.g., corresponding audio embeddings) to the enroll buffer 334C. The profile manager 126, in response to determining that the first subset of the audio portions 151D (e.g., the corresponding audio embeddings) stored in the enroll buffer 334C satisfies the enroll threshold 364, generates a speech profile 150B based on the first subset of the audio portions 151D (e.g., the corresponding audio embeddings) stored in the enroll buffer 334C. The profile manager 126 updates the speech profile 150B based on a second subset of the audio portions 151D. The profile manager 126 determines whether the speech profile 150B is to be merged with the speech profile 150A, as described with reference to FIGS. 2A and 3A. For example, the profile manager 126, in response to determining that a similarity metric of the speech profile 150A and the speech profile 150B fails to satisfy a similarity threshold, determines that the speech profile 150A is not to be merged with the speech profile 150B.

In some implementations, the profile manager 126 resets enroll buffers 334A and 334B without resetting the enroll buffer 334C, in response to determining that speech from the talkers 392A and 392B has not been detected in the audio portions 151D and that a count of the audio portions 151D is greater than or equal to the silence threshold 394. For example, the audio portions 151D correspond to greater than threshold silence from the talkers 392A and 392B.

The probability values 153 indicate that audio portions 151E correspond to greater than threshold silence. For example, a count of the audio portions 151E is greater than or equal to the silence threshold 394. The profile manager 126 resets the enroll buffers 334 in response to determining that the audio portions 151E correspond to greater than threshold silence.

The probability values 153 indicate that audio portions 151F correspond to speech of a single talker (e.g., designated as the talker 392A). The profile manager 126, in response to determining that each of the audio portions 151F matches the speech profile 150B, updates the speech profile 150B based on the audio portions 151F. Because the talker designation (e.g., the talker 392A) is being reused, the audio portion 151D and the audio portion 151F are associated with different designated talkers, e.g., the talker 392C and the talker 392A, respectively, even though the audio portion 151D and the audio portion 151F correspond to speech of the same talker (e.g., the user 342C of FIG. 3A) and match the same speech profile (e.g., the speech profile 150B). In a particular aspect, the profile manager 126 determines whether the speech profile 150B is to be merged with the speech profile 150A, as described with reference to FIGS. 2A and 3A. The profile manager 126, in response to determining that a similarity metric between the speech profile 150A and the speech profile 150B fails to satisfy a similarity threshold, determines that the speech profile 150A is not to be merged with the speech profile 150B.

The probability values 153 indicate that audio portions 151G correspond to speech of a single talker (e.g., designated as the talker 392B). The profile manager 126, in response to determining that a first subset of the audio portions 151G do not match any of the speech profiles 150, adds the first subset of the audio portions 151G to the enroll buffer 334B associated with the talker 392B. The profile manager 126 generates a speech profile 150C based on the first subset of the audio portions 151G and updates the speech profile 150C based on a second subset of the audio portions 151G. Because the talker designation (e.g., the talker 392B) is being reused, the audio portion 151C and the audio portion 151G are associated with the same designated talker, e.g., the talker 392B, the audio portion 151C and the audio portion 151G can correspond to speech of the same user or different users. In a particular aspect, the profile manager 126 determines whether the speech profile 150C is to be merged with any of the enrolled speech profiles 150 (e.g., the speech profile 150A or the speech profile 150B), as described with reference to FIGS. 2A and 3A.

The probability values 153 indicate that audio portions 151H correspond to greater than threshold silence. The profile manager 126 resets the enroll buffers 334 in response to determining that the audio portions 151H correspond to greater than threshold silence.

The probability values 153 indicate that audio portions 151I correspond to speech of a single talker (e.g., designated as the talker 392C). The profile manager 126, in response to determining that each of the audio portions 151I matches the speech profile 150A, updates the speech profile 150A based on the audio portions 151I. Because the talker designation (e.g., the talker 392C) is being reused, the audio portion 151A and the audio portion 151I are associated with different designated talkers, e.g., the talker 392A and the talker 392C, respectively, even though the audio portion 151A and the audio portion 151I correspond to speech of the same user (e.g., the user 342A of FIG. 3A) and match the same speech profile (e.g., the speech profile 150A). In a particular implementation, the profile manager 126 determines whether the speech profile 150A is to be merged with any of the enrolled speech profiles 150 (e.g., the speech profile 150B or the speech profile 150C), as described with reference to FIGS. 2A and 3A. In an alternative aspect, the profile manager 126, in response to determining that the audio portions 151I do not match any of the plurality of speech profiles 150, adds a first subset of the audio portions 151I in the enroll buffer 334C associated with the talker 392C and generates a speech profile 150D based on the first subset of the audio portions 151I. By reusing the talker designation (e.g., the talker 392C), the profile manager 126 can generate (or update) a greater count of user profiles than the pre-determined count (e.g., K) of talkers 392 that can be distinguished by the talker detector 128. In a particular implementation, the profile manager 126 determines whether the speech profile 150D is to be merged with any of the enrolled speech profiles 150 (e.g., the speech profile 150A, 150B, or 150C), as described with reference to FIGS. 2A and 3A.

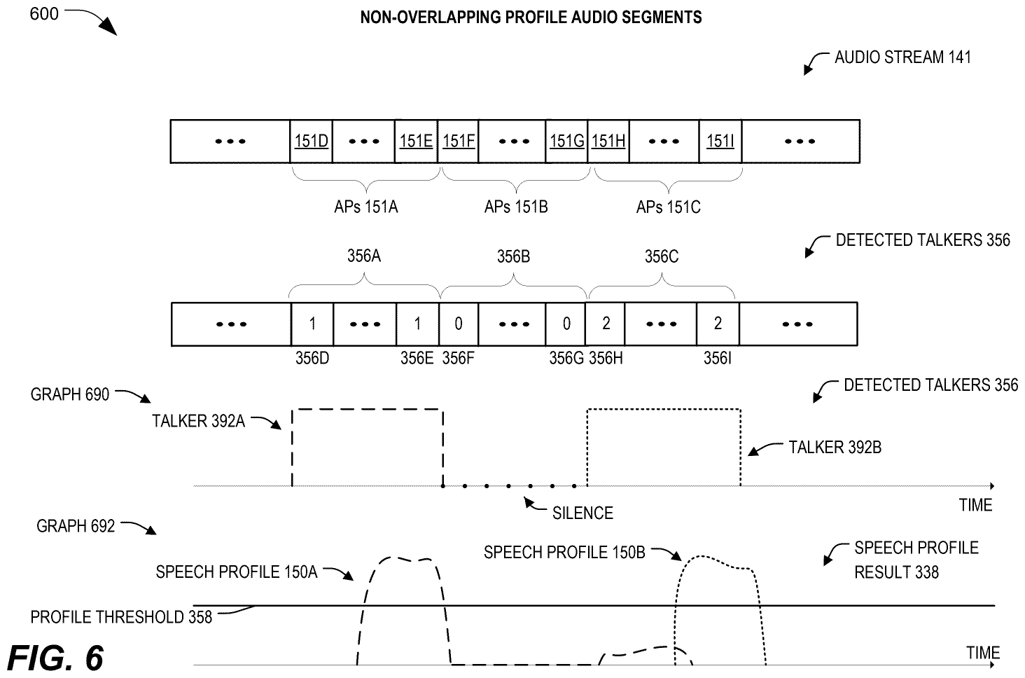

Referring to FIG. 6, an illustrative aspect of operations 600 associated with speech profile management are shown, in accordance with some examples of the present disclosure. In a particular aspect, one or more of the operations 600 are performed by the feature extractor 122, the talker detector 128, the profile manager 126, the speaker diarizer 102, the system 100 of FIG. 1A, the profile audio segment identifier 124, the profile audio segmentor 130, the speech segmentor 104, the system 190 of FIG. 1B, the one or more processors 320, the device 302 of FIG. 3A, or a combination thereof.

The audio stream 141 includes audio portions 151A, audio portions 151B, and audio portions 151C. For example, the audio portions 151A include an audio portion 151D (e.g., an audio frame), one or more additional audio portions, and an audio portion 151E. The audio portions 151B include an audio portion 151F, one or more additional audio portions, an audio portion 151G. The audio portions 151C include an audio portion 151H, one or more additional audio portions, and an audio portion 151I.

In a particular aspect, a detected talkers result 356A of each of the audio portions 151A indicates that the audio portion 151A corresponds to speech of a talker 392A. For example, a detected talkers result 356D (e.g., “1”) of the audio portion 151D indicates that the audio portion 151D represents speech of the talker 392A. As another example, a detected talkers result 356E (e.g., “1”) of the audio portion 151E indicates that the audio portion 151E represents speech of the talker 392A.

The detected talkers result 356B of each of the audio portions 151B indicates that the audio portion 151B corresponds to silence (or non-speech noise). For example, a detected talkers result 356F (e.g., “0”) of the audio portion 151F indicates that the audio portion 151F represents silence (or non-speech noise). As another example, a detected talkers result 356G (e.g., “0”) of the audio portion 151G indicates that the audio portion 151G represents silence (or non-speech noise).

The detected talkers result 356C of each of the audio portions 151C indicates that the audio portion 151C corresponds to speech of a talker 392B. For example, a detected talkers result 356H (e.g., “2”) of the audio portion 151H indicates that the audio portion 151H represents speech of the talker 392B. As another example, a detected talkers result 356I (e.g., “2”) of the audio portion 151I indicates that the audio portion 151I represents speech of the talker 392B.

A graph 690 is a visual depiction of an example of the detected talkers result 356. For example, the audio portions 151A represent speech of the talker 392A, the audio portions 151B represent silence, and the audio portions 151C represent speech of the talker 392B.

A graph 692 is a visual depiction of an example of the speech profile result 338. The profile manager 126 generates a speech profile 150A based on a first subset of the audio portions 151A. The profile manager 126, after generation of the speech profile 150A, determines a speech profile result 338A by comparing subsequent audio portions (e.g., subsequent audio embeddings) to the speech profile 150A. The speech profile result 338A of an audio portion 151 indicates a likelihood that the audio portion 151 matches the speech profile 150A. The profile manager 126 determines the speech profile result 338A of a first subset of the audio portions 151C by comparing the first subset of the audio portions 151C to the speech profile 150A. The profile manager 126, in response to determining that the speech profile result 338A of the first subset of the audio portions 151C is less than the profile threshold 358, determines that the first subset of the audio portions 151C do not match the speech profile 150A.

The profile manager 126, in response to determining that the first subset of the audio portions 151C do not match the speech profile 150A, generates a speech profile 150B based on the first subset of the audio portions 151C. The profile manager 126, after generation of the speech profile 150B, determines the speech profile result 338B by comparing subsequent audio portions to the speech profile 150B. The speech profile result 338B indicates a likelihood that audio portions match the speech profile 150B. For example, the speech profile result 338B of a second subset of the audio portions 151C indicates that the second subset of the audio portions 151C match the speech profile 150B. In a particular aspect, the profile manager 126 generates a graphical user interface (GUI) that includes the graph 690, the graph 692, or both, and provides the GUI to a display device.

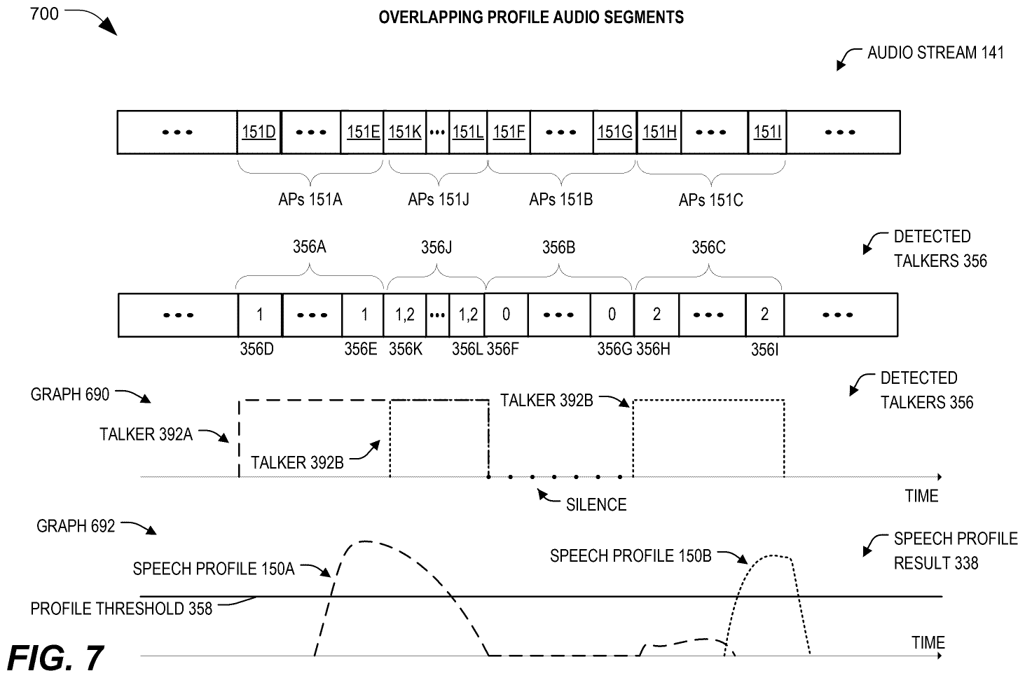

Referring to FIG. 7, an illustrative aspect of operations 700 associated with speech profile management are shown, in accordance with some examples of the present disclosure. In a particular aspect, one or more of the operations 700 are performed by the feature extractor 122, the talker detector 128, the profile manager 126, the speaker diarizer 102, the system 100 of FIG. 1A, the profile audio segment identifier 124, the profile audio segmentor 130, the speech segmentor 104, the system 190 of FIG. 1B, the one or more processors 320, the device 302 of FIG. 3A, or a combination thereof.

The audio stream 141 includes audio portions 151J corresponding to speech of multiple talkers. For example, the audio portions 151J include an audio portion 151K (e.g., an audio frame), one or more additional audio portions, and an audio portion 151L. In a particular aspect, the detected talkers result 356D of each of the audio portions 151J indicates that the audio portion 151J corresponds to speech of the talker 392A and a talker 392B. For example, a detected talkers result 356K (e.g., “1, 2”) of the audio portion 151K indicates that the audio portion 151K represents speech of the talker 392A and the talker 392B. As another example, a detected talkers result 356L (e.g., “1, 2”) of the audio portion 151L indicates that the audio portion 151L represents speech of the talker 392A and the talker 392B.

The profile manager 126, after generation of the speech profile 150A, determines the speech profile result 338A by comparing subsequent audio portions (e.g., subsequent audio embeddings) to the speech profile 150A. The profile manager 126 determines the speech profile result 338A of the audio portions 151J by comparing the audio portions 151J to the speech profile 150A. In a particular aspect, the speech profile result 338A for the audio portions 151J is lower than the speech profile result 338A for the audio portions 151A because the audio portions 151J include speech of the talker 392B in addition to the speech of the talker 392A.

In some aspects, the speech segmentor 104 filters at least a subset of the audio portions 151J that match the speech profile 150A based on the speech profile 150A to generate filtered audio portions. Because speech of the talker 392B is reduced (e.g., removed) from the filtered audio portions, the filtered audio portions more closely match the speech profile 150A.

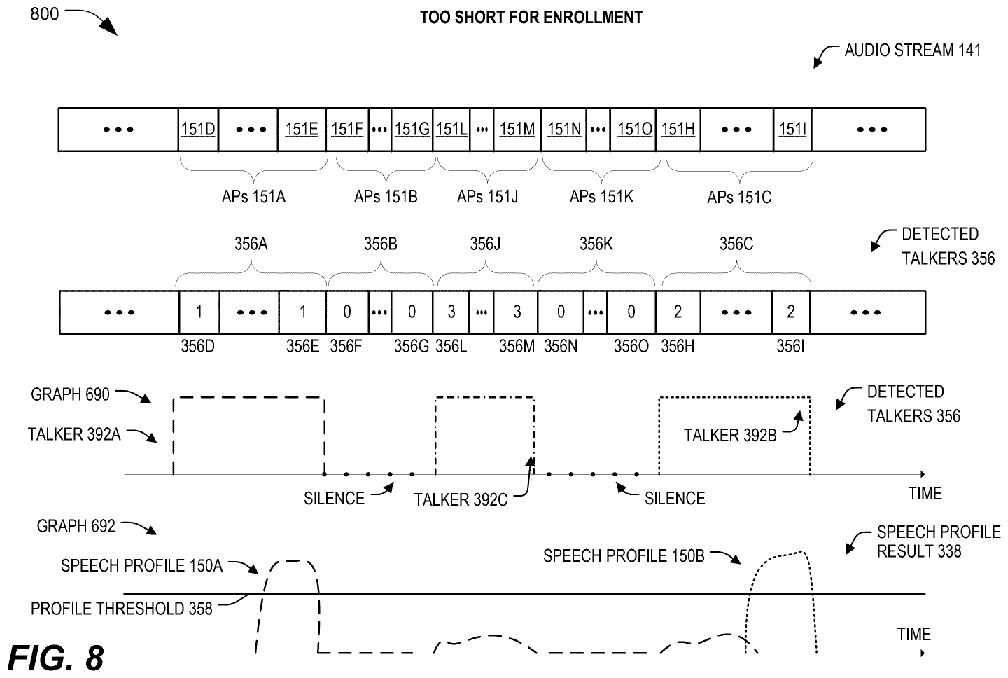

Referring to FIG. 8, an illustrative aspect of operations 800 associated with speech profile management are shown, in accordance with some examples of the present disclosure. In a particular aspect, one or more of the operations 800 are performed by the feature extractor 122, the talker detector 128, the profile manager 126, the speaker diarizer 102, the system 100 of FIG. 1A, the one or more processors 320, the device 302 of FIG. 3A, or a combination thereof.

The audio stream 141 includes audio portions 151J and the audio portions 151K. For example, the audio portions 151J include an audio portion 151L (e.g., an audio frame), one or more additional audio portions, and an audio portion 151M. The audio portions 151K include an audio portion 151N (e.g., an audio frame), one or more additional audio portions, and an audio portion 151O.

In a particular aspect, the detected talkers result 356J of each of the audio portions 151J indicates that the audio portion 151J represents speech of a talker 392C (e.g., a single talker). The detected talkers result 356K of each of the audio portions 151K indicates that the audio portion 151K represents silence (or non-speech noise).

The profile manager 126, after generation of the speech profile 150A, determines the speech profile result 338A of the audio portions 151J by comparing the audio portions 151J to the speech profile 150A. The profile manager 126, in response to determining that the speech profile result 338A is less than the profile threshold 358, determines that the audio portions 151J do not match the speech profile 150A.

The profile manager 126, in response to determining that the audio portions 151J do not match the speech profile 150A, stores the audio portions 151J in the enroll buffer 334C associated with the talker 392C. The profile manager 126, in response to determining that the audio portions 151J stored in the enroll buffer 334C fail to satisfy the enroll threshold 364, refrains from generating a speech profile 150 based on the audio portions 151J stored in the enroll buffer 334C. The profile manager 126 resets (e.g., marks as empty) the enroll buffers 334 in response to determining that the audio portions 151K indicate a greater than threshold silence. The audio portions 151J are thus removed from the enroll buffer 334C when the talker 392C appears to have stopped talking.

Referring to FIG. 9, an illustrative aspect of operations 900 associated with speech profile management are shown, in accordance with some examples of the present disclosure. In a particular aspect, one or more of the operations 900 are performed by the feature extractor 122, the talker detector 128, the profile manager 126, the speaker diarizer 102, the system 100 of FIG. 1A, the one or more processors 320, the device 302 of FIG. 3A, or a combination thereof.

The talker detector 128 of FIG. 1A performs the talker detection 402, at 904. For example, the talker detector 128 receives the audio embedding 152 from the feature extractor 122 at a time T and generates the probability values 153 for the audio embedding 152 of an audio portion 151, as described with reference to FIGS. 1A and 3A. The profile manager 126 of FIG. 1A determines the quality metric 354 of the audio embedding 152, as described with reference to FIG. 3A. For example, the quality metric 354 is based on a count of talkers that the probability values 153 indicate are detected in the audio embedding 152 (e.g., a count of the probability values 153 that are greater than the probability value threshold 357), a level of noise detected in the audio portion 151, a SNR value of the audio portion 151, or a combination thereof.

The profile manager 126 of FIG. 1A determines whether any of the probability values 153 satisfy the probability value threshold 357, at 906. For example, the profile manager 126, in response to determining that none of the probability values 153 satisfy the probability value threshold 357, determines that the audio embedding 152 represents silence (or non-speech noise) and increments (e.g., by 1) the silence count 362. The profile manager 126, subsequent to incrementing the silence count 362, determines whether the silence count 362 is greater than the silence threshold 394, at 908.

The profile manager 126, in response to determining that the silence count 362 is greater than the silence threshold 394, at 908, performs a reset, at 910. For example, the profile manager 126 performs the reset by resetting the enroll buffers 334 (e.g., marks as empty), the probe buffers 340 (e.g., marks as empty), the silence count 362 (e.g., resets to 0), or a combination thereof, and returns to 904 to process subsequent audio embeddings of the audio stream 141. Alternatively, the profile manager 126, in response to determining that the silence count 362 is less than or equal to the silence threshold 394, at 908, returns to 904 to process subsequent audio embeddings of the audio stream 141.

The profile manager 126, in response to determining that at least one of the probability values 153 satisfies the probability value threshold 357, at 906, adds the audio embedding 152 to at least one of the probe buffers 340, at 912. For example, the profile manager 126 in response to determining that a first probability value 153 associated with the talker 392A satisfies the probability value threshold 357, determines that the audio embedding 152 represents speech of the talker 392A and adds the audio embedding 152 to the probe buffer 340A associated with the talker 392A. In a particular implementation, the audio embedding 152 representing speech of multiple talkers 392 is added to multiple probe buffers 340 corresponding to the multiple talkers 392. For example, the profile manager 126, in response to determining that each of the first probability value 153 and the second probability value 153 satisfies the probability value threshold 357, adds the audio embedding 152 to the probe buffer 140A and the probe buffer 140B.

The profile manager 126 determines whether the corresponding talker (e.g., the talker 392A) is enrolled, at 916. For example, the profile manager 126 determines whether a talker 392 (e.g., the talker 392A) is enrolled by comparing audio embeddings (e.g., including the audio embedding 152) of the corresponding probe buffer 340 (e.g., the probe buffer 340A) to the enrolled speech profiles 150.

The profile manager 126, in response to determining that the talker 392 (e.g., the talker 392A) is not enrolled, at 916, determines whether the audio embedding 152 passes quality check, at 918. For example, the profile manager 126 determines whether the quality metric 354 satisfies an enroll quality criterion. To illustrate, the profile manager 126, in response to determining that the quality metric 354 indicates that the audio embedding 152 corresponds to multiple talkers 392, is associated with a noise level greater than a noise threshold, is associated with a SNR value less than an SNR threshold, or a combination thereof, determines that the audio embedding 152 fails the quality check. Alternatively, the profile manager 126, in response to determining that the quality metric 354 indicates the audio embedding 152 corresponds to a single talker, the noise level is less than or equal to the noise threshold, and the SNR value is less than or equal to the SNR threshold, determines that the audio embedding 152 passes the quality check.

The profile manager 126, in response to determining that the audio embedding 152 fails to pass the quality check, at 918, returns to 904 to process subsequent audio embeddings of the audio stream 141. Alternatively, the profile manager 126, in response to determining that the audio embedding 152 passes the quality check, at 918, adds the audio embedding 152 representing speech of a talker 392 (e.g., the talker 392A) to the enroll buffer 334 (e.g., the enroll buffer 334A) associated with the talker 392, at 920.

The profile manager 126 determines whether a count of audio embeddings stored in an enroll buffer 334 (e.g., the enroll buffer 334A) is greater than the enroll threshold 364, at 922. The profile manager 126, in response to determining that the count of audio embeddings stored in each of the enroll buffers 334 (e.g., the enroll buffer 334A) is less than or equal to the enroll threshold 364, at 922, returns to 904 to process subsequent audio embeddings of the audio stream 141. Alternatively, the profile manager 126, in response to determining that the count of audio embeddings of an enroll buffer 334 (e.g., the enroll buffer 334A) is greater than the enroll threshold 364, generates a speech profile 150A, and determines whether the speech profile 150A is similar to any of the enrolled speech profiles 150, at 923. For example, the profile manager 126 determines a similarity metric 228 based on a comparison of the speech profile 150A and another speech profile (e.g., a speech profile 150B), as described with reference to FIG. 2A. The profile manager 126, in response to determining that the similarity metric 228 satisfies a similarity threshold, determines that the speech profile 150A is similar to the other speech profile (e.g., the speech profile 150B) and merges the speech profile 150A with the other speech profile (e.g., the speech profile 150B), at 925. Alternatively, the profile manager 126, in response to determining that no enrolled speech profiles are available or that the speech profile 150A is not similar to any of the enrolled speech profiles 150, at 923, enrolls the speech profile 150A, at 924. For example, the profile manager 126 adds the speech profile 150A to the enrolled speech profiles 150, and returns to 904 to process subsequent audio embeddings of the audio stream 141.

The profile manager 126, in response to determining that the talker 392A is enrolled, at 916, determines whether the audio embedding 152 (or the audio embeddings of a probe buffer 340 associated with a talker 392 whose speech is represented by the audio embedding 152) passes a quality check, at 926. For example, the profile manager 126 determines whether the quality metric 354 satisfies an update quality criterion. To illustrate, the profile manager 126, in response to determining that the quality metric 354 indicates that the audio embedding 152 corresponds to multiple talkers 392, is associated with a noise level greater than a noise threshold, is associated with a SNR value less than an SNR threshold, or a combination thereof, determines that the audio embedding 152 fails the quality check. Alternatively, the profile manager 126, in response to determining that the quality metric 354 indicates the audio embedding 152 corresponds to a single talker, the noise level is less than or equal to the noise threshold, and the SNR value is less than or equal to the SNR threshold, determines that the audio embedding 152 passes the quality check. In some implementations, the thresholds to determine whether the update quality criterion is satisfied can be different from the thresholds to determine whether the enroll quality criterion is satisfied. For example, thresholds corresponding to higher audio quality (e.g., fewer talkers, lower noise, higher SNR value, or a combination thereof) may be used for the enroll quality criterion.

The profile manager 126, in response to determining that the audio embedding 152 (or the audio embeddings of the probe buffer 340) fail to pass the quality check, at 926, returns to 904 to process subsequent audio embeddings of the audio stream 141. The profile manager 126, in response to determining that the audio embedding 152 (or the audio embeddings of the probe buffer 340) passes the quality check, at 926, updates a speech profile 150A (that matches the audio embedding 152) based on the audio embedding 152 (or the audio embeddings of the probe buffer 340) and returns to 904 to process subsequent audio embeddings of the audio stream 141. In an alternative aspect, the quality check, at 926, is performed prior to adding the audio embedding 152 to a probe buffer 340. For example, the profile manager 126, in response to determining that the audio embedding 152 fails to pass the quality check (e.g., fails to satisfy the enroll quality criterion and the update quality criterion), refrains from adding the audio embedding 152 to the probe buffer 340 and returns to 904 to process subsequent audio embeddings of the audio stream 141.

Additionally, the profile manager 126, in response to determining that the talker 392A is enrolled, at 916, determines whether the speech profile 150A (that matches the audio embedding 152) is mature, at 930. For example, the profile manager 126, in response to determining that a count of audio embeddings 152 included in the speech profile 150A is greater than the maturity threshold 361, determines that the speech profile 150A is mature and outputs profile attribution data 125 indicating that the audio portion 151 represents speech that matches at least the speech profile 150A. For example, the profile attribution data 125A includes an identifier (e.g., a sequence number or a time period) of the audio portion 151 and the profile identifier 155A of the speech profile 150A. In some examples, the profile manager 126 determines that the audio embedding 152 represents speech of multiple talkers (e.g., the talker 392A and the talker 392B), at 906, that the multiple talkers are enrolled, at 916, and that multiple speech profiles (e.g., the speech profile 150A and the speech profile 150B) that match the audio embedding 152 are mature, at 930, outputs the profile attribution data 125 indicating that the audio portion 151 represents speech that matches the multiple speech profiles (e.g., the speech profile 150A and the speech profile 150B).

Alternatively, the profile manager 126, in response to determining that the speech profile 150A (that matches the audio embedding 152) is not mature, at 930, identifies a mature speech profile that is closest to the speech profile 150A, at 932. For example, the profile manager 126 identifies one or more mature speech profiles (if any) of the enrolled speech profiles 150, and identifies a mature speech profile (e.g., a speech profile 150B) among the one or more mature speech profiles that is closest (e.g., based on centroid distance, nearest audio embedding distance, or both) to the speech profile 150A. The profile manager 126, in response to identifying the mature speech profile (e.g., speech profile 150B), outputs profile attribution data 125 indicating that the audio portion 151 represents speech that likely matches or is closest to the mature speech profile.

Additionally, the profile manager 126, in response to determining that the speech profile 150A (that matches the audio embedding 152) is not mature, at 930, proceeds to 923 to determine whether the speech profile 150A is similar to another speech profile of the enrolled speech profiles 150. For example, the profile manager 126 merges the speech profile 150A with another speech profile that is similar to the speech profile 150A. The profile manager 126, subsequent to merging the speech profile 150A with the other speech profile or determining that the speech profile 150A is not similar to another enrolled speech profile, returns to 904 to process subsequent audio embeddings of the audio stream 141.

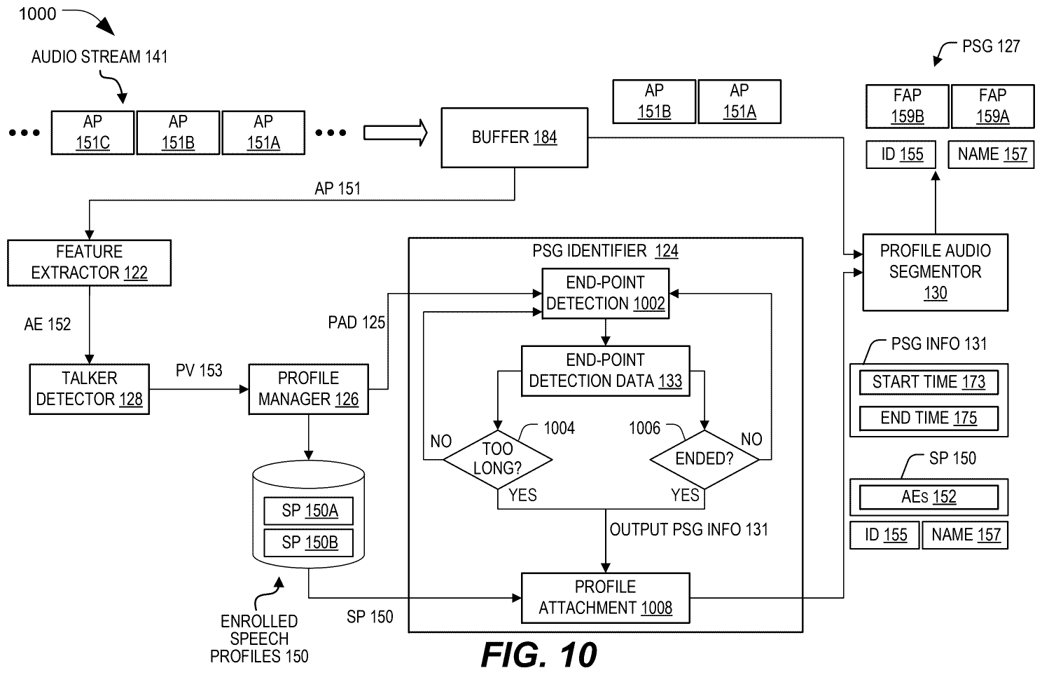

Referring to FIG. 10, an illustrative aspect of operations 1000 associated with speech profile management are shown, in accordance with some examples of the present disclosure. In a particular aspect, one or more of the operations 1000 are performed by the feature extractor 122, the talker detector 128, the profile manager 126, the speaker diarizer 102, the system 100 of FIG. 1A, the profile audio segment identifier 124, the profile audio segmentor 130, the speech segmentor 104, the system 190 of FIG. 1B, the one or more processors 320, the device 302 of FIG. 3A, or a combination thereof.

One or more audio portions 151 of the audio stream 141 are stored in the buffer 184. The feature extractor 122 retrieves an audio portion 151 from the buffer 184 and processes the audio portion 151 to generate an audio embedding 152, as described with reference to FIGS. 1A and 3A. The talker detector 128 processes the audio embedding 152 to generate probability values 153, as described with reference to FIGS. 1A and 3A. The profile manager 126 selectively updates the enrolled speech profiles 150 based on the audio embedding 152 and generates profile attribution data 125, as described with reference to FIGS. 1A, 3A, and 9. The profile attribution data 125 indicates that the audio portion 151 represents speech that matches one or more of the enrolled speech profiles 150. For example, in some implementations, the profile manager 126 does not generate profile attribution data 125 for an audio portion 151 in response to determining that the audio portion 151 corresponds to silence, non-speech audio, fails to pass quality checks, does not match an enrolled speech profile and a corresponding enroll buffer 334 includes insufficient audio embeddings for enrollment, is not mature, or a combination thereof, as described with reference to FIG. 9.

The profile audio segment identifier 124 performs end-point detection to selectively update the end-point detection data 133, at 1002. For example, the profile audio segment identifier 124 updates the end-point detection data 133 based on the profile attribution data 125, as described with reference to FIGS. 1B and 3B. The profile attribution data 125 indicates which of one or more speech profiles 150 match the audio portion 151. To illustrate, the profile audio segment identifier 124, in response to determining that the profile attribution data 125 indicates that the audio portion 151 represents speech that matches a speech profile 150A and that the end-point detection data 133 indicates that an audio segment of the speech profile 150A is not in-progress, updates an audio segment start time 173 of the speech profile 150A in the end-point detection data 133 to indicate that an audio segment of the speech profile 150A is in-progress, as described with reference to FIGS. 1B and 3B.

The profile audio segment identifier 124, in response to determining that the end-point detection data 133 indicates that an audio segment of a speech profile 150B is in-progress and that the profile attribution data 125 indicates that the audio portion 151 does not represent speech that matches the speech profile 150B, updates an audio segment end time 175 of the speech profile 150B in the end-point detection data 133 to indicate that an audio segment of the speech profile 150B has ended, as described with reference to FIGS. 1B and 3B.

The profile audio segment identifier 124 determines, at 1004, whether the end-point detection data 133 indicates that an audio segment of a speech profile 150 (that matches the audio embedding 152) has been in-progress for a duration that is greater than an audio segment duration threshold. For example, the profile audio segment identifier 124, in response to determining at a first time that an audio segment of a speech profile 150A (that matches the audio embedding 152) is in-progress and that a difference between the first time and an audio segment start time 173 of the speech profile 150A is greater than the audio segment duration threshold, updates the end-point detection data 133 to indicate that a first audio segment of the speech profile 150 has ended. To illustrate, the profile audio segment identifier 124 updates the audio segment end time 175A (e.g., based on the first time or an audio portion end time of the audio portion 151) in the end-point detection data 133 to indicate that the first audio segment of the speech profile 150A has ended. Alternatively, the profile audio segment identifier 124, in response to determining that the end-point detection data 133 indicates that an audio segment of the speech profile 150A (that matches the audio embedding 152) is in-progress and has been in-progress for a duration that is less than or equal to the audio segment duration threshold, returns to 1002 to perform end-point detection of subsequent profile attribution data 125.

The profile audio segment identifier 124 determines, at 1006, whether the end-point detection data 133 indicates that an audio segment of a speech profile 150 has ended. For example, the profile audio segment identifier 124, in response to determining that the end-point detection data 133 includes a valid audio segment start time 173 and a valid audio segment end time 175 for a speech profile 150B (e.g., the profile identifier 155B), determines that an audio segment of the speech profile 150B has ended. Alternatively, the profile audio segment identifier 124, in response to determining that the end-point detection data 133 indicates that an audio segment of the speech profile 150B has not ended (e.g., invalid audio segment start time 173 and invalid audio segment end time 175), returns to 1002 to perform end-point detection of subsequent profile attribution data 125.

The profile audio segment identifier 124, in response to ending, at 1004, an audio segment of a speech profile 150 that has been in-progress for a duration that is greater than the audio segment duration threshold or determining, at 1006, that the end-point detection data 133 indicates that an audio segment of a speech profile 150 has ended, generates profile audio segment information 131 of the audio segment of the speech profile 150. For example, the profile audio segment information 131 indicates an audio segment time period (e.g., an audio segment start time 173 and an audio segment end time 175) of the audio segment and a profile identifier 155 of the speech profile 150.

The profile audio segment identifier 124, subsequent to generating the profile audio segment information 131, performs profile attachment, at 1008. For example, the profile audio segment identifier 124, in response to determining that the profile audio segment information 131 indicates the profile identifier 155 of the speech profile 150, provides the profile audio segment information 131 and the speech profile 150 to the profile audio segmentor 130.

The profile audio segmentor 130, in response to receiving the profile audio segment information 131 and the speech profile 150, identifies one or more audio portions 151 that match the audio segment of the speech profile 150 corresponding to the profile audio segment information 131. For example, the profile audio segmentor 130 retrieves, from the buffer 184, one or more audio portions 151 (e.g., an audio portion 151A and an audio portion 151B) that each have an audio portion start time that is greater than or equal to the audio segment start time 173 and less than the audio segment end time 175 indicated in the profile audio segment information 131. It should be understood that an audio segment corresponding to two audio portions is provided as an illustrative example, in other examples an audio segment can correspond to fewer than two audio portions or more than two audio portions.

The profile audio segmentor 130 filters the one or more audio portions 151 (e.g., the audio portion 151A and the audio portion 151B) based on the speech profile 150 to generate one or more filtered audio portions 159, as described with reference to FIGS. 1B and 3B. For example, the profile audio segmentor 130 filters the audio portion 151A based on audio embeddings 152 of the speech profile 150 to generate a filtered audio portion 159A. As another example, the profile audio segmentor 130 filters the audio portion 151B based on the audio embeddings 152 of the speech profile 150 to generate a filtered audio portion 159B. The profile audio segmentor 130 outputs a profile audio segment 127 that includes the one or more filtered audio portions 159 (e.g., the filtered audio portion 159A and the filtered audio portion 159B) and designates the profile audio segment 127 as associated with the speech profile 150 (e.g., a profile identifier 155, a profile name 157, or both, of the speech profile 150).

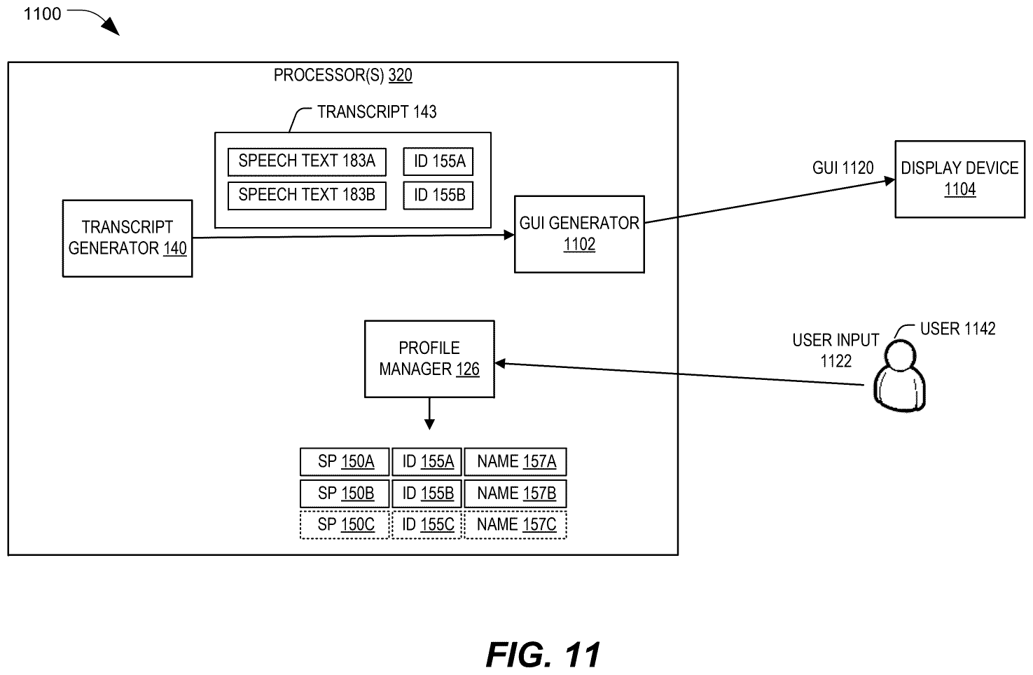

Referring to FIG. 11, a diagram 1100 is shown of an illustrative aspect of operations associated with speech profile management, in accordance with some examples of the present disclosure. The one or more processors 320 of the device 302 of FIG. 3A are coupled to a display device 1104. In a particular aspect, the display device 1104 is included in the system 100 of FIG. 1A, the system 190 of FIG. 1B, or both.

In some implementations, the display device 1104 is external to the device 302. In some implementations, the display device 1104 is integrated in the device 302. The one or more processors 320 include the transcript generator 140 coupled to a GUI generator 1102. The transcript generator 140 generates a transcript 143, as described with reference to FIGS. 1A, 1B, 3A, 3B. For example, the transcript 143 includes speech text 183 and indicates one or more speech profiles 150 associated with the speech text 183. To illustrate, the transcript 143 indicates speech text 183A is associated with the profile identifier 155A of the speech profile 150A, speech text 183B is associated with the profile identifier 155B of the speech profile 150B, or both. In some implementations (e.g., where the speech segmentor 104 is not activated), the transcript 143 can include speech text 183 that is associated with multiple speech profiles, as described with reference to FIGS. 1A and 3A. In some of these implementations, the transcript generator 140 generates the transcript 143 indicating that the speech text 183 is associated with an audio portion 151 that was used by the speech recognizer 182 to generate the speech text 183. In some of the implementations in which the speech recognizer 182 processes a profile audio segment 127 to generate the speech text 183, the transcript generator 140 generates the transcript 143 to indicate that the speech text 183 is associated with one or more filtered audio portions 159 of the profile audio segment 127. The transcript generator 140 provides the transcript 143 to the GUI generator 1102.

The GUI generator 1102 is configured to generate a GUI 1120 based on the transcript 143 and provide the GUI 1120 to the display device 1104. The profile manager 126 is configured to, based on receiving a user input 1122 from a user 1142, update one or more of the enrolled speech profiles 150.

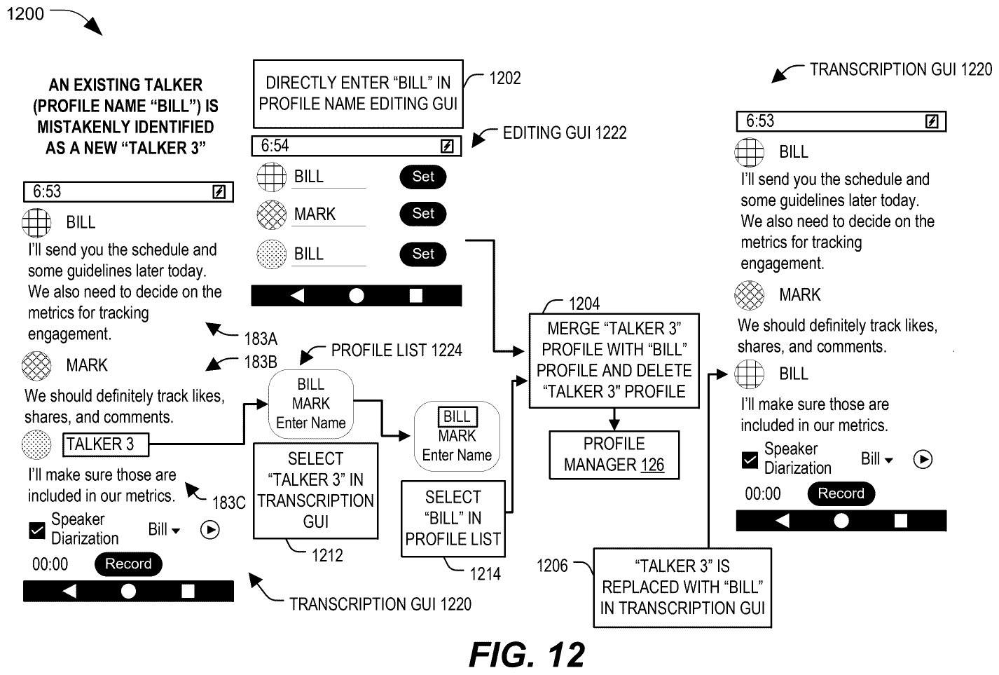

In a particular aspect, the GUI 1120 includes the speech text 183A and a first label associated with the speech text 183A indicating the profile name 157A of the speech profile 150A, and the speech text 183B and a second label associated with the speech text 183B indicating the profile name 157B of the speech profile 150B, as further described with reference to FIG. 12. In some implementations, the GUI 1120 includes a first option to access (e.g., playback or download) one or more audio portions (e.g., audio portion(s) 151 or filtered audio portion(s) 159) associated with speech text 183A, and a second option to access one or more audio portions (e.g., audio portion(s) 151 or filtered audio portion(s) 159) associated with speech text 183B.

The profile manager 126 receives a user input 1122 from a user 1142 responsive to the GUI generator 1102 providing the GUI 1120 to the display device 1104. In a first example, the user input 1122 indicates that the profile name 157A (e.g., “Talker 3”) is to be updated to an input profile name (e.g., “Bill”). The profile manager 126, in response to receiving the user input 1122, updates the profile name 157A of the speech profile 150A to the input profile name (e.g., “Bill”). In some implementations the profile names 157 are unique and the profile manager 126, in response to determining that the input profile name (e.g., “Bill”) matches a profile name 157C (e.g., “Bill”) of a speech profile 150C, merges the speech profile 150A and the speech profile 150C, as described with reference to FIGS. 2A and 3A. For example, the profile manager 126 moves audio embeddings of the speech profile 150A to the speech profile 150C and resets (e.g., removes) the speech profile 150A.

In a second example, the user input 1122 includes a selected profile identifier (e.g., the profile identifier 155C) and indicates that the speech profile 150A is to be merged with the speech profile 150C corresponding to the selected profile identifier. The profile manager 126, in response to receiving the user input 1122, updates the profile name 157A of the speech profile 150A to the input profile name (e.g., “Bill”). The profile manager 126, in response to receiving the user input 1122, merges the speech profile 150A and the speech profile 150C, as described with reference to FIGS. 2A and 3A. For example, the profile manager 126 moves audio embeddings of the speech profile 150A to the speech profile 150C and resets (e.g., removes) the speech profile 150A. The profile manager 126 thus enables the enrolled speech profiles 150 to be updated based on user input.

Referring to FIG. 12, a diagram is shown of an illustrative aspect of operations 1200 associated with speech profile management, in accordance with some examples of the present disclosure. In a particular aspect, one or more of the operations 1200 are performed by the transcript generator 140, the profile manager 126, the system 100 of FIG. 1A, the system 190 of FIG. 1B, the one or more processors 320, the device 302 of FIG. 3A, the GUI generator 1102, the display device 1104 of FIG. 11, or a combination thereof.

The GUI generator 1102 of FIG. 11 obtains the transcript 143 of FIGS. 1A and 1B. The transcript 143 indicates that speech text 183A, speech text 183B, and speech text 183C represent speech that matches a speech profile 150A, a speech profile 150B, and a speech profile 150C. The speech profile 150A has a profile identifier 155A and a profile name 157A (e.g., “BILL”). The speech profile 150B has a profile identifier 155B and a profile name 157B (e.g., “MARK”). The speech profile 150C has a profile identifier 155C and a profile name 157C (e.g., “TALKER 3”). In a particular aspect, each of the profile name 157A (e.g., “BILL”) and the profile name 157B (e.g., “MARK”) were previously assigned based on user input, and the profile name 157C (e.g., “TALKER 3”) was previously automatically generated by the profile manager 126.

The GUI generator 1102 generates a transcription GUI 1220 based on the transcript 143 of FIGS. 1A and 1B. In a particular aspect, the transcription GUI 1220 corresponds to the GUI 1120 of FIG. 11. The transcription GUI 1220 indicates the speech text 183A and a label associated with the speech text 183A that indicates the profile name 157A (e.g., “BILL”). The transcription GUI 1220 indicates the speech text 183B and a label associated with the speech text 183B that indicates the profile name 157B (e.g., “MARK”). The transcription GUI 1220 indicates the speech text 183C and a label associated with the speech text 183C that indicates the profile name 157C (e.g., “TALKER 3”).

The GUI generator 1102 sends the transcription GUI 1220 to the display device 1104. A user 1142 determines that the label of the speech text 183A correctly identifies the speech text 183A as speech of a user 342A (e.g., Bill), and that the label of the speech text 183B correctly identifies the speech text 183B as speech of a user 342B (e.g., Mark). The user 1142, in response to determining that the speech text 183C is also speech of the user 342A, provides user input 1122 to indicate the speech text 183C is to be associated with the same speech profile (e.g., the speech profile 150A) as the speech text 183A.

In a first example, the user 1142 selects an option to view an editing GUI 1222. In a particular implementation, the GUI generator 1102, in response to receiving the user selection, provides the editing GUI 1222 to the display device 1104. The editing GUI 1222 indicates the profile names 157 of the enrolled speech profiles 150. For example, the editing GUI 1222 includes an editable field indicating the profile name 157C (e.g., “TALKER 3”) of the speech profile 150C, and the user 1142 updates the editable field to an input profile name (e.g., “BILL”), at 1202. The user 1142 selects a save option to send a user input 1122 indicating that the profile name 157C (e.g., “TALKER 3”) of the speech profile 150C is to be updated to the input profile name (e.g., “BILL”).

In a particular implementation, the profile names 157 are unique. In this implementation, the profile manager 126, in response to determining receiving the user input 1122 and determining that the input profile name (e.g., “BILL”) matches the profile name 157A (e.g., “BILL”) of the speech profile 150A, merges, at 1204, the speech profile 150C with the speech profile 150A, as described with reference to FIG. 2A. For example, the profile manager 126 moves audio embeddings of the speech profile 150C to the speech profile 150A, removes (e.g., resets) the speech profile 150C, and updates data that refers to the speech profile 150C (e.g., the profile identifier 155C) to refer to the speech profile 150A (e.g., the speech profile 150A). For example, the profile manager 126 updates the transcript 143 from indicating that the speech text 183C is associated with the speech profile 150C (e.g., the profile identifier 155C) to indicating that the speech text 183C is associated with the speech profile 150A (e.g., the profile identifier 155A).

In an alternate implementation, the profile names 157 are not unique. In this implementation, the profile manager 126, in response to receiving the user input 1122, updates the profile name 157C (e.g., “TALKER 3”) of the speech profile 150C to input profile name (e.g., “BILL”), does not merge the speech profile 150C with the speech profile 150A, and updates the label of the speech text 183C in the transcript 143 to indicate the input profile name.

In a second example, the user 1142 selects an option to view a profile list 1224. In a particular implementation, the GUI generator 1102, in response to receiving the user selection, provides the profile list 1224 to the display device 1104. The profile list 1224 includes selectable options indicating the profile names 157 of the enrolled speech profiles 150 and a selectable option to enter a new profile name (e.g., “Enter Name”). The user 1142 selects, at 1214, an option indicating the profile name 157A (e.g., “BILL”) of the speech profile 150A to send a user input 1122 indicating that the speech profile 150C is to be merged with the speech profile 150A. The profile manager 126, in response to determining receiving the user input 1122, merges, at 1204, the speech profile 150C with the speech profile 150A. Alternatively, if the user 1142 selects the option to enter the new profile name, the profile manager 126 updates the profile name 157C to the new profile name, e.g., without merging the speech profile 150C with another speech profile, and updates the label of the speech text 183C in the transcript 143 to indicate the new profile name.

In both the first example and the second example, the GUI generator 1102 updates, at 1206, the transcription GUI 1220 to correspond to the updated transcript 143. For example, the label of the speech text 183C indicates the profile name 157A (e.g., “BILL”) of the speech profile 150A associated with the speech text 183C (after merging the speech profile 150C and the speech profile 150A). In another example, the label of the speech text 183C indicates the profile name 157C of the speech profile 150C that is updated based on the input profile name or the new profile name (e.g., when the speech profile 150C is not to be merged with the speech profile 150A).

Referring to FIG. 13, a diagram is shown of an illustrative aspect of operations 1300 associated with speech profile management, in accordance with some examples of the present disclosure. In a particular aspect, one or more of the operations 1300 are performed by the profile manager 126, the system 100 of FIG. 1A, the system 190 of FIG. 1B, the one or more processors 320, the device 302 of FIG. 3A, or a combination thereof.

In a non-conversation mode 174, the profile manager 126 adds audio embeddings 152 generated by the feature extractor 122 to the buffer 184, at 1302. The profile manager 126, based on audio embeddings 152 stored in the buffer 184, determines whether a conversation is detected, at 1304. For example, the profile manager 126 determines whether a portion of the audio stream 141 corresponds to speech associated with at least two speech profiles. To illustrate, the profile manager 126 determines, at a detection time, that the portion of the audio stream 141 corresponds to a sliding window with a window start time that is based on the detection time and a conversation duration threshold (e.g., window start time=detection time-conversation duration threshold). The profile manager 126, in response to determining that the speech profile result 338 indicates that speech associated with at least two speech profiles (e.g., the speech profile 150A and the speech profile 150B) is detected during the portion of the audio stream 141, determines that the conversation is detected and transitions to the conversation mode 176.

In some aspects, transitioning to the conversation mode 176 includes activation, at 1306, of any of one or more applications 1330 (e.g., the speech segmentor 104) that are to be operated in the conversation mode 176 and that are not to be operated in the non-conversation mode 174. In some aspects, transitioning to the conversation mode 176 includes deactivation of any of one or more applications 1320 that are to be operated in the non-conversation mode 174 and not to be operated in the conversation mode 176.

Alternatively, in response to the profile manager 126 determining, at 1304, that a conversation is not detected, the processor(s) 320 perform the application(s) 1320. For example, the profile manager 126 generates the profile attribution data 125 and provides the profile attribution data 125 to the transcript generator 140. As another example, the speech recognizer 182 processes the audio portions 151 to generate the speech text 183 and provides the speech text 183 to the transcript generator 140, as described with reference to FIG. 1A. The transcript generator 140 generates the transcript 143 based on the profile attribution data 125 and the speech text 183. In some aspects, the profile manager 126, during the non-conversation mode 174, determines whether to split a speech profile 150A into multiple speech profiles, as described with reference to FIG. 2B. Because a conversation is not detected, the audio portions 151 are less likely to correspond to speech that matches multiple speech profiles, so resources can be conserved by deactivating the speech segmentor 104 with reduced (e.g., no) impact on quality of speech recognition.

In the conversation mode 176, the profile manager 126 adds audio embeddings 152 generated by the feature extractor 122 to the buffer 184, at 1322. The profile manager 126, based on audio embeddings 152 stored in the buffer 184, determines whether a conversation is detected, at 1324. For example, the profile manager 126 determines whether a portion of the audio stream 141 corresponds to speech associated with fewer than two speech profiles. To illustrate, the profile manager 126 determines, at a detection time, that the portion of the audio stream 141 corresponds to a sliding window with a window start time that is based on the detection time and a conversation duration threshold (e.g., window start time=detection time-conversation duration threshold). The profile manager 126, in response to determining that the speech profile result 338 indicates that speech associated with fewer than two speech profiles (e.g., no speech, speech matching a single speech profile, or speech not matching any speech profiles) is detected during the portion of the audio stream 141, determines that conversation is not detected and transitions to the non-conversation mode 174.

In some aspects, transitioning to the non-conversation mode 174 includes activation, at 1308, of any of one or more applications 1320 that are to be operated in the non-conversation mode 174 and are not to be operated in the conversation mode 176. In some aspects, transitioning to the non-conversation mode 174 includes deactivation of any of one or more applications 1330 (e.g., the speech segmentor 104) that are to be operated in the conversation mode 176 and are not to be operated in the non-conversation mode 174.

Alternatively, in response to the profile manager 126 determining, at 1324, that a conversation is detected, the processor(s) 320 perform the application(s) 1330. For example, the profile manager 126 generates the profile attribution data 125 and provides the profile attribution data 125 to the speech segmentor 104, and the speech segmentor 104 generates profile audio segments 127 including filtered audio portions 159. As another example, the speech recognizer 182 processes the profile audio segments 127 to generate the speech text 183 and provides the speech text 183 to the transcript generator 140, as described with reference to FIG. 1B. The transcript generator 140 generates the transcript 143 based on the speech text 183. In some aspects, the profile manager 126, during the conversation mode 176, determines whether to combine a speech profile 150A with another speech profile of the enrolled speech profiles 150, as described with reference to FIG. 2A. Because conversation is detected, the audio portions 151 are more likely to correspond to speech that matches multiple speech profiles, so using the speech segmentor 104 can improve speech recognition accuracy thus improving accuracy of the transcript 143.

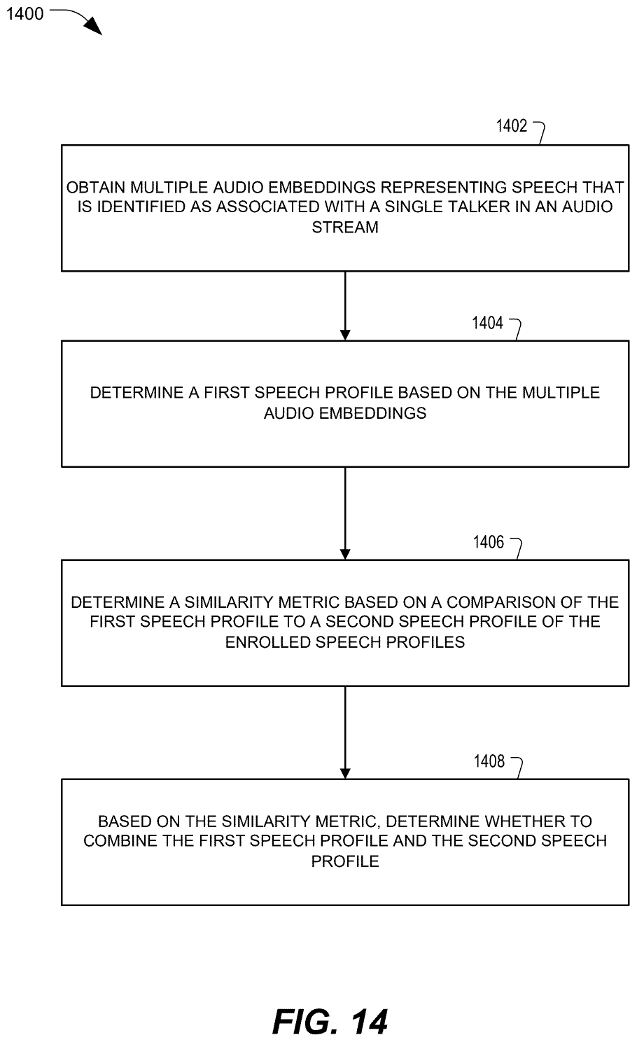

Referring to FIG. 14, a particular implementation of a method 1400 of performing speech profile management is shown. In a particular aspect, one or more operations of the method 1400 are performed by at least one of the feature extractor 122, the talker detector 128, the profile manager 126, the device 302, the system 100 of FIG. 1A, the one or more processors 320, the device 302 of FIG. 3A, or a combination thereof.

The method 1400 includes, at 1402, obtaining multiple audio embeddings representing speech that is identified as associated with a single talker in an audio stream. For example, the feature extractor 122 processes audio portions 151 to generate audio embeddings 152, as described with reference to FIGS. 1A, 3A, and 9. The talker detector 128 processes the audio embeddings 152 to generate the probability values 153, as described with reference to FIGS. 1A, 3A, and 9. The profile manager 126, based at least in part on determining that the probability values 153 indicate that an audio embedding 152 represents speech of a talker 392A, stores the audio embedding 152 in a probe buffer 340A, an enroll buffer 334A, or both, corresponding to the talker 392A, as described with reference to FIGS. 3A and 9. The probe buffer 340A, the enroll buffer 334A, or both, can thus store multiple audio embeddings 152 that represent speech of the talker 392A.

The method 1400 also includes, at 1404, determining a first speech profile based on the multiple audio embeddings. In an example, the profile manager 126 determines a speech profile 150A in response to determining that the audio embeddings 152 stored in the probe buffer 340A match the speech profile 150A of the enrolled speech profiles 150, as described with reference to FIGS. 3A and 9. In another example, the profile manager 126, based on determining that the audio embeddings 152 stored in the probe buffer 340A do not match any of the enrolled speech profiles 150, generates a speech profile 150A based on the audio embeddings 152 stored in the enroll buffer 334A, as described with reference to FIGS. 3A and 9.

The method 1400 further includes, at 1406, determining a similarity metric based on a comparison of the first speech profile to a second speech profile of the enrolled speech profiles. For example, the profile manager 126 determines a similarity metric 228AC based on a comparison of the speech profile 150A and a speech profile 150C, as described with reference to FIG. 2A. To illustrate, in a particular aspect, the profile manager 126 determines a centroid distance based on a distance between the centroid vector 226A of the speech profile 150A and the centroid vector 226C of the speech profile 150C, as described with reference to FIG. 2A. In a particular aspect, the profile manager 126 determines pairs of audio embeddings, with each pair including an audio embedding of the speech profile 150A and an audio embedding of the speech profile 150C. The profile manager 126 selects a particular pair with audio embeddings that are nearest each other from among the pairs of audio embeddings. The profile manager 126 determines a nearest audio embedding distance based on a distance between the audio embeddings (e.g., an audio embedding 152C of the speech profile 150A and an audio embedding 152D of the speech profile 150C) of the selected pair. The profile manager 126 generates the similarity metric 228AC based on the centroid distance, the nearest audio embedding distance, or both.

The method 1400 also includes, at 1408, based on the similarity metric, determining whether to combine the first speech profile and the second speech profile. For example, the profile manager 126, based on the similarity metric 228AB, determines whether to combine the speech profile 150A and the speech profile 150B, as described with reference to FIG. 2A. For example, the profile manager 126, in response to determining that the centroid distance indicated by the similarity metric 228AC is less than a centroid distance threshold and that the nearest audio embedding distance indicated by the similarity metric 228AC is less than an audio embedding distance threshold, determines that the speech profile 150A is to be combined (e.g., merged) with the speech profile 150C. To illustrate, the profile manager 126 moves the audio embeddings 152 of the speech profile 150A to the speech profile 150C, and removes the speech profile 150A.

The method 1400 thus enables updating the speech profile 150C as speech of a user evolves. Resource usage is also conserved by combining multiple speech profiles for the same user.

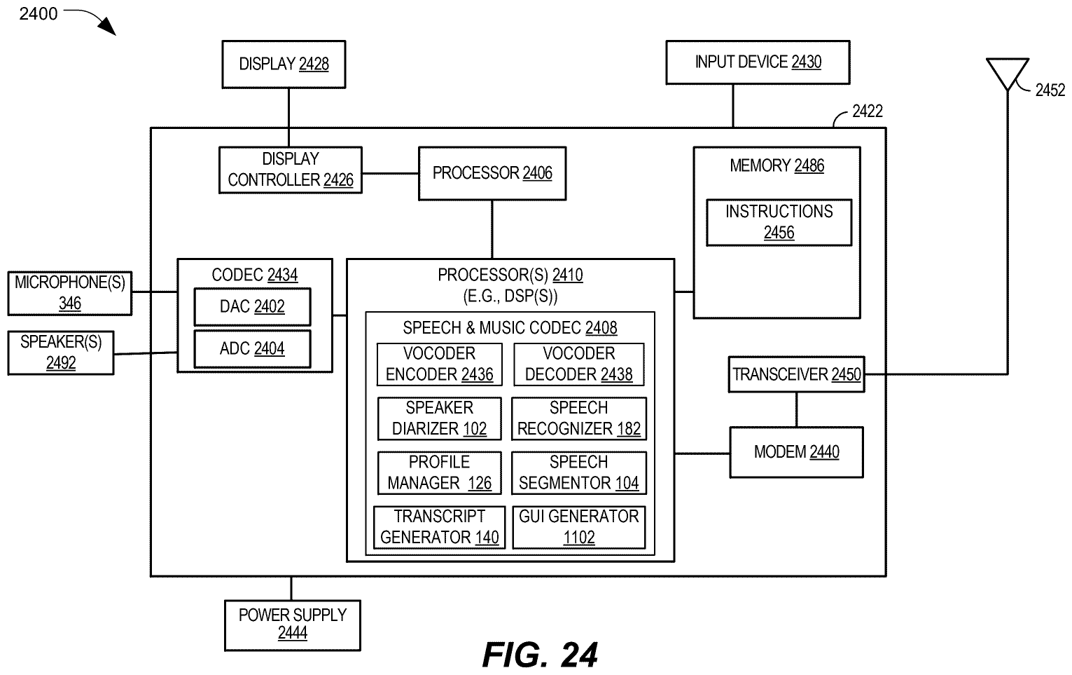

The method 1400 of FIG. 14 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 1400 of FIG. 14 may be performed by a processor that executes instructions, such as described with reference to FIG. 24.

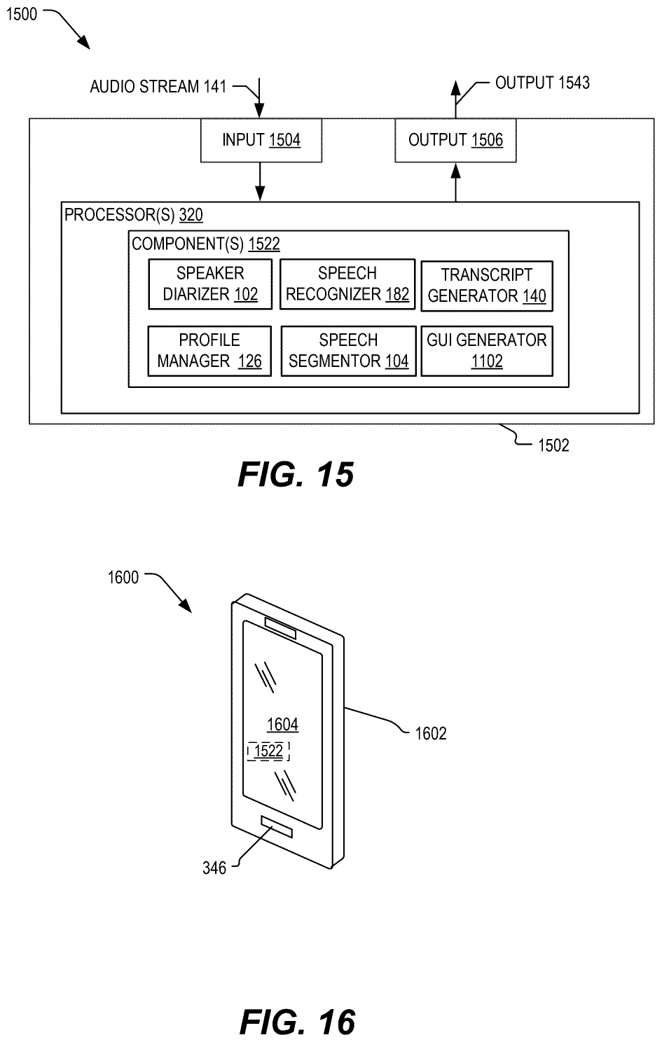

FIG. 15 depicts an implementation 1500 of the device 302 of FIG. 5A as an integrated circuit 1502 that includes the one or more processors 320. The one or more processors 320 include one or more components 1522 of the speaker diarizer 102, the speech segmentor 104, the profile manager 126, the speech recognizer 182, the transcript generator 140, the GUI generator 1102, or a combination thereof.

The integrated circuit 1502 also includes an audio input 1504, such as one or more bus interfaces, to enable the audio stream 141 to be received for processing. The integrated circuit 1502 also includes a signal output 1506, such as a bus interface, to enable sending of an output signal 1543, such as a speech profile 150, profile attribution data PAD 125, a transcript 143, a profile audio segment 127, speech text 183, or a combination thereof. The integrated circuit 1502 enables implementation of speech profile management as a component in a system that includes a microphone, such as a mobile phone or tablet as depicted in FIG. 16, a headset as depicted in FIG. 17, a wearable electronic device as depicted in FIG. 18, a voice-controlled speaker system as depicted in FIG. 19, a camera as depicted in FIG. 20, a virtual reality, mixed reality, or augmented reality headset as depicted in FIG. 21, or a vehicle as depicted in FIG. 22 or FIG. 23.

FIG. 16 depicts an implementation 1600 in which the device 302 includes a mobile device 1602, such as a phone or tablet, as illustrative, non-limiting examples. The mobile device 1602 includes the microphone 346 and a display screen 1604. In a particular aspect, the display screen 1604 corresponds to the display device 1104 of FIG. 11. Component(s) 1522 of the processor 320 are integrated in the mobile device 1602 and are illustrated using dashed lines to indicate internal components that are not generally visible to a user of the mobile device 1602. In a particular example, the speaker diarizer 102, the profile manager 126, the speech recognizer 182, and optionally the speech segmentor 104 operate to detect user voice activity, which is then processed to perform one or more operations at the mobile device 1602, such as to launch a graphical user interface or otherwise display other information associated with the user's speech at the display screen 1604 (e.g., via an integrated “smart assistant” application).

FIG. 17 depicts an implementation 1700 in which the device 302 includes a headset device 1702. The headset device 1702 includes the microphone 346. Component(s) 1522 of the processor 320 are integrated in the headset device 1702. In a particular example, the speaker diarizer 102, the profile manager 126, the speech recognizer 182, and optionally the speech segmentor 104 operate to detect user voice activity, which may cause the headset device 1702 to perform one or more operations at the headset device 1702, to transmit audio data corresponding to the user voice activity to a second device (not shown) for further processing, or a combination thereof.

FIG. 18 depicts an implementation 1800 in which the device 302 includes a wearable electronic device 1802, illustrated as a “smart watch.” The component(s) 1522 and the microphone 346 are integrated into the wearable electronic device 1802. In a particular example, the speaker diarizer 102, the profile manager 126, the speech recognizer 182, and optionally the speech segmentor 104 operate to detect user voice activity, which is then processed to perform one or more operations at the wearable electronic device 1802, such as to launch a graphical user interface or otherwise display other information associated with the user's speech at a display screen 1804 of the wearable electronic device 1802. To illustrate, the wearable electronic device 1802 may include a display screen that is configured to display a notification based on user speech detected by the wearable electronic device 1802. In a particular example, the wearable electronic device 1802 includes a haptic device that provides a haptic notification (e.g., vibrates) in response to detection of user voice activity. For example, the haptic notification can cause a user to look at the wearable electronic device 1802 to see a displayed notification indicating detection of a keyword spoken by the user. The wearable electronic device 1802 can thus alert a user with a hearing impairment or a user wearing a headset that the user's voice activity is detected.

FIG. 19 is an implementation 1900 in which the device 302 includes a wireless speaker and voice activated device 1902. The wireless speaker and voice activated device 1902 can have wireless network connectivity and is configured to execute an assistant operation. The processor(s) 320, including the component(s) 1522, and the microphone 346 are included in the wireless speaker and voice activated device 1902. The wireless speaker and voice activated device 1902 also includes a speaker 1904. During operation, in response to receiving a verbal command identified as user speech via operation of the speaker diarizer 102, the profile manager 126, the speech recognizer 182, and optionally the speech segmentor 104, the wireless speaker and voice activated device 1902 can execute assistant operations, such as via execution of a voice activation system (e.g., an integrated assistant application). The assistant operations can include adjusting a temperature, playing music, turning on lights, etc. For example, the assistant operations are performed responsive to receiving a command after a keyword or key phrase (e.g., “hello assistant”).

FIG. 20 depicts an implementation 2000 in which the device 302 includes a portable electronic device that corresponds to a camera device 2002. The component(s) 1522 and the microphone 346 are included in the camera device 2002. During operation, in response to receiving a verbal command identified as user speech via operation of the speaker diarizer 102, the profile manager 126, the speech recognizer 182, and optionally the speech segmentor 104, the camera device 2002 can execute operations responsive to spoken user commands, such as to adjust image or video capture settings, image or video playback settings, or image or video capture instructions, as illustrative examples.

FIG. 21 depicts an implementation 2100 in which the device 302 includes a portable electronic device that corresponds to a virtual reality, mixed reality, or augmented reality headset 2102. The component(s) 1522 and the microphone 346 are integrated into the headset 2102. User voice activity detection can be performed based on audio signals received from the microphone 346 of the headset 2102. A visual interface device 2120 is positioned in front of the user's eyes to enable display of augmented reality, mixed reality, or virtual reality images or scenes to the user while the headset 2102 is worn. In a particular example, the visual interface device is configured to display a notification indicating user speech detected in the audio signal.

FIG. 22 depicts an implementation 2200 in which the device 302 corresponds to, or is integrated within, a vehicle 2202, illustrated as a manned or unmanned aerial device (e.g., a package delivery drone). The component(s) 1522 and the microphone 346 are integrated into the vehicle 2202. User voice activity detection can be performed based on audio signals received from the microphone 346 of the vehicle 2202, such as for delivery instructions from an authorized user of the vehicle 2202.

FIG. 23 depicts another implementation 2300 in which the device 302 corresponds to, or is integrated within, a vehicle 2302, illustrated as a car. The vehicle 2302 includes the processor 320 including the component(s) 1522. The vehicle 2302 also includes the microphone 346. User voice activity detection can be performed based on audio signals received from the microphone 346 of the vehicle 2302. In some implementations, user voice activity detection can be performed based on an audio signal received from interior microphones (e.g., the microphone 346), such as for a voice command from an authorized passenger. For example, the user voice activity detection can be used to detect a voice command from an operator of the vehicle 2302 (e.g., from a parent to set a volume to 5 or to set a destination for a self-driving vehicle) and to disregard the voice of another passenger (e.g., a voice command from a child to set the volume to 10 or other passengers discussing another location). In some implementations, user voice activity detection can be performed based on an audio signal received from external microphones (e.g., the microphone 346), such as an authorized user of the vehicle. In a particular implementation, in response to receiving a verbal command identified as user speech via operation of the speaker diarizer 102, the profile manager 126, the speech recognizer 182, and optionally the speech segmentor 104, a voice activation system initiates one or more operations of the vehicle 2302 based on one or more keywords (e.g., “unlock,” “start engine,” “play music,” “display weather forecast,” or another voice command) detected in the user speech, such as by providing feedback or information via a display 2320 or one or more speakers (e.g., a speaker 2330).

Referring to FIG. 24, a block diagram of a particular illustrative implementation of a device is depicted and generally designated 2400. In various implementations, the device 2400 may have more or fewer components than illustrated in FIG. 24. In an illustrative implementation, the device 2400 may correspond to the device 302 of FIG. 3A. In an illustrative implementation, the device 2400 may perform one or more operations described with reference to FIGS. 1-23.

In a particular implementation, the device 2400 includes a processor 2406 (e.g., a CPU). The device 2400 may include one or more additional processors 2410 (e.g., one or more DSPs). In a particular aspect, the one or more processors 320 of FIG. 3A correspond to the processor 2406, the processors 2410, or a combination thereof. The processors 2410 may include a speech and music coder-decoder (CODEC) 2408 that includes a voice coder (“vocoder”) encoder 2436, a vocoder decoder 2438, the speaker diarizer 102, the speech segmentor 104, the profile manager 126, the speech recognizer 182, the transcript generator 140, the GUI generator 1102, or a combination thereof.

The device 2400 may include a memory 2486 and a CODEC 2434. The memory 2486 may include instructions 2456, that are executable by the one or more additional processors 2410 (or the processor 2406) to implement the functionality described with reference to one or more components of the speaker diarizer 102, the speech segmentor 104, the profile manager 126, the speech recognizer 182, the transcript generator 140, the GUI generator 1102, or a combination thereof. The device 2400 may include a modem 2440 coupled, via a transceiver 2450, to an antenna 2452.

The device 2400 may include a display 2428 coupled to a display controller 2426. A speaker 2492 and one or more microphones 346 may be coupled to the CODEC 2434. The CODEC 2434 may include a digital-to-analog converter (DAC) 2402, an analog-to-digital converter (ADC) 2404, or both. In a particular implementation, the CODEC 2434 may receive analog signals from the microphone 346, convert the analog signals to digital signals using the analog-to-digital converter 2404, and provide the digital signals to the speech and music codec 2408. The speech and music codec 2408 may process the digital signals, and the digital signals may further be processed by the speaker diarizer 102, the speech recognizer 182, the speech segmentor 104, the profile manager 126, the transcript generator 140, the GUI generator 1102, or a combination thereof. In a particular implementation, the speech and music codec 2408 may provide digital signals to the CODEC 2434. The CODEC 2434 may convert the digital signals to analog signals using the digital-to-analog converter 2402 and may provide the analog signals to the speaker 2492.

In a particular implementation, the device 2400 may be included in a system-in-package or system-on-chip device 2422. In a particular implementation, the memory 2486, the processor 2406, the processors 2410, the display controller 2426, the CODEC 2434, and the modem 2440 are included in the system-in-package or system-on-chip device 2422. In a particular implementation, an input device 2430 and a power supply 2444 are coupled to the system-in-package or the system-on-chip device 2422. Moreover, in a particular implementation, as illustrated in FIG. 24, the display 2428, the input device 2430, the speaker 2492, the microphone 346, the antenna 2452, and the power supply 2444 are external to the system-in-package or the system-on-chip device 2422. In a particular implementation, each of the display 2428, the input device 2430, the speaker 2492, the microphone 346, the antenna 2452, and the power supply 2444 may be coupled to a component of the system-in-package or the system-on-chip device 2422, such as an interface or a controller.

The device 2400 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for obtaining multiple audio embeddings representing speech that is identified as associated with a single talker in an audio stream. For example, the means for obtaining the multiple audio embeddings can correspond to the feature extractor 122, the talker detector 128, the profile manager 126, the system 100 of FIG. 1A, the system 190 of FIG. 1B, the probe buffer(s) 340, the enroll buffer(s) 334, the one or more processors 320, the device 302 of FIG. 3A, the processor 2406, the processor(s) 2410, the device 2400, one or more other circuits or components configured to obtain multiple audio embeddings representing speech that is identified as associated with a single talker in an audio stream, or any combination thereof.

The apparatus also includes means for determining a first speech profile based on the multiple audio embeddings. For example, the means for determining the first speech profile can correspond to the profile manager 126, the system 100 of FIG. 1A, the system 190 of FIG. 1B, the one or more processors 320, the device 302 of FIG. 3A, the processor 2406, the processor(s) 2410, the device 2400, one or more other circuits or components configured to determine a first speech profile based on the multiple audio embeddings, or any combination thereof.

The apparatus further includes means for determining a similarity metric based on a comparison of the first speech profile to a second speech profile of enrolled speech profiles. For example, the means for determining the similarity metric can correspond to the profile manager 126, the system 100 of FIG. 1A, the system 190 of FIG. 1B, the one or more processors 320, the device 302 of FIG. 3A, the processor 2406, the processor(s) 2410, the device 2400, one or more other circuits or components configured to determine a similarity metric based on a comparison of the first speech profile to a second speech profile of enrolled speech profiles, or any combination thereof.

The apparatus also includes means for determining, based on the similarity metric, whether to combine the first speech profile and the second speech profile. For example, the means for determining whether to combine the first speech profile and the second speech profile can correspond to the profile manager 126, the system 100 of FIG. 1A, the system 190 of FIG. 1B, the one or more processors 320, the device 302 of FIG. 3A, the processor 2406, the processor(s) 2410, the device 2400, one or more other circuits or components configured to determine, based on the similarity metric, whether to combine the first speech profile and the second speech profile, or any combination thereof.

In some implementations, a non-transitory computer-readable medium (e.g., a computer-readable storage device, such as the memory 2486) stores instructions (e.g., the instructions 2456) that, when executed by one or more processors (e.g., the one or more processors 2410 or the processor 2406), cause the one or more processors to obtain multiple audio embeddings (e.g., audio embeddings 152) representing speech that is identified as associated with a single talker (e.g., a talker 392A) in an audio stream (e.g., an audio stream 141). The instructions, when executed by the one or more processors, also cause the one or more processors to determine a first speech profile (e.g., a speech profile 150A) based on the multiple audio embeddings. The instructions, when executed by the one or more processors, further cause the one or more processors to determine a similarity metric (e.g., a similarity metric 228AC) based on a comparison of the first speech profile to a second speech profile (e.g., a speech profile 150C) of enrolled speech profiles. The instructions, when executed by the one or more processors, also cause the one or more processors to, based on the similarity metric, determine whether to combine the first speech profile and the second speech profile.

Particular aspects of the disclosure are described below in sets of interrelated Examples:

According to Example 1, a device includes a memory configured to store enrolled speech profiles; and one or more processors configured to: obtain multiple audio embeddings representing speech that is identified as associated with a single talker in an audio stream; determine a first speech profile based on the multiple audio embeddings; determine a similarity metric based on a comparison of the first speech profile to a second speech profile of the enrolled speech profiles; and, based on the similarity metric, determine whether to combine the first speech profile and the second speech profile.

Example 2 includes the device of Example 1, wherein the first speech profile includes a first set of audio embeddings including at least the multiple audio embeddings, wherein the second speech profile includes a second set of audio embeddings, and wherein the one or more processors are configured to determine a first cluster based on the first set of audio embeddings; determine a second cluster based on the second set of audio embeddings; and determine the similarity metric based on a distance between the first cluster and the second cluster.

Example 3 includes the device of Example 1 or Example 2, wherein the distance is between a first centroid vector of the first cluster and a second centroid vector of the second cluster.

Example 4 includes the device of any of Examples 1 to 3, wherein the one or more processors are configured to, based on determining that the first speech profile and the second speech profile are not to be combined and that the first speech profile is not one of the enrolled speech profiles, designate the first speech profile as associated with a first profile identifier and add the first speech profile to the enrolled speech profiles.

Example 5 includes the device of any of Examples 1 to 4, wherein the one or more processors are configured to, in response to determining that the first speech profile and the second speech profile are to be combined, add a first set of audio embeddings of the first speech profile to the second speech profile and discard the first speech profile.

Example 6 includes the device of any of Examples 1 to 5, wherein the one or more processors are configured to generate an audio embedding of an audio portion of the audio stream; process, using a talker detection neural network, the audio embedding to generate one or more probability values, each probability value indicating an estimate of a probability that the audio portion represents speech of a corresponding talker of a set of talkers; and based on determining that a first probability value of the one or more probability values is greater than or equal to a probability threshold, determine that the audio portion is identified as associated with a first talker.

Example 7 includes the device of Example 6, wherein the one or more processors are configured to, based on determining that each of the remaining probability values is less than the probability threshold, determine that the audio portion is identified as associated with the single talker, and that the single talker includes the first talker.

Example 8 includes the device of Example 6 or Example 7, wherein a count of the set of talkers is less than a count of the enrolled speech profiles.

Example 9 includes the device of any of Examples 1 to 8, wherein the memory is configured to store enrollment buffers associated with a set of talkers, and wherein the one or more processors are configured to generate an audio embedding of an audio portion of the audio stream; and based at least in part on determining that the audio portion is identified as associated with a first talker and that the audio embedding does not match any of the enrolled speech profiles, add the audio embedding to a first enrollment buffer associated with the first talker, wherein the multiple audio embeddings are obtained from the first enrollment buffer.

Example 10 includes the device of Example 9, wherein the audio embedding is added to the first enrollment buffer further based on determining that the audio portion is identified as not representing speech of multiple talkers.

Example 11 includes the device of Example 9 or Example 10, wherein the one or more processors are configured to, based at least in part on determining that the audio embedding matches the first speech profile that is included in the enrolled speech profiles and that a count of a first set of audio embeddings of the first speech profile is less than a maturity threshold, compare the first speech profile to the second speech profile to determine the similarity metric, wherein the multiple audio embeddings are obtained from the first speech profile.

Example 12 includes the device of any of Examples 9 to 11, wherein the one or more processors are configured to, based at least in part on determining that the audio portion is identified as associated with a first talker, and that the audio embedding matches the first speech profile that is included in the enrolled speech profiles, add the audio embedding to the first speech profile.

Example 13 includes the device of Example 12, wherein the audio embedding is added to the first speech profile further based on determining that the audio portion is identified as not representing speech of multiple talkers.

Example 14 includes the device of any of Examples 1 to 13, wherein the memory is configured to store end-point detection data indicating time periods of audio segments associated with the enrolled speech profiles, wherein each of the audio segments includes one or more audio portions of the audio stream, and wherein the one or more processors are configured to generate an audio embedding of an audio portion of the audio stream, the multiple audio embeddings including the audio embedding; based on determining that the audio embedding matches the first speech profile associated with a first profile identifier, designate the audio portion as representing speech corresponding to the first profile identifier; and based on determining that the audio portion represents speech corresponding to the first profile identifier and that the end-point detection data indicates that no audio segment of the first profile identifier is in-progress, update the end-point detection data to indicate that an audio segment of the first profile identifier is in-progress.

Example 15 includes the device of Example 14, wherein the one or more processors are configured to update the end-point detection data to indicate a start time of the audio segment of the first profile identifier, and wherein the start time is based on a time stamp associated with the audio portion.

Example 16 includes the device of Example 14 or Example 15, wherein the one or more processors are configured to, based on determining that the audio portion is designated as not representing speech corresponding to a second profile identifier of the second speech profile, and that the end-point detection data indicates that an audio segment of the second profile identifier is in-progress, update the end-point detection data to indicate that the audio segment of the second profile identifier has ended.

Example 17 includes the device of Example 16, wherein the one or more processors are configured to update the end-point detection data to indicate an end time of the audio segment of the second profile identifier, and wherein the end time is based on a time stamp associated with the audio portion.

Example 18 includes the device of Example 17, wherein the one or more processors are configured to generate a transcript including: text corresponding to the audio segment of the second profile identifier, and a label associated with the text, wherein the label is based on the end-point detection data and indicates a second profile name of the second speech profile, a start time of the audio segment of the second profile identifier, and the end time of the audio segment of the second profile identifier.

Example 19 includes the device of Example 18, wherein the one or more processors are configured to: provide the transcript to a display device; and in response to receiving a user input indicating that the label is to be updated to indicate an input profile name, update the second speech profile from being associated with the second profile name to being associated with the input profile name.

Example 20 includes the device of Example 18, wherein the one or more processors are configured to: provide the transcript to a display device; and in response to receiving a user input indicating that the label is to be updated to indicate an input profile name associated with a third speech profile of the enrolled speech profiles, combine the second speech profile and the third speech profile.

Example 21 includes the device of any of Examples 1 to 20, wherein the one or more processors are configured to perform clustering of a first set of embeddings of the first speech profile to generate a plurality of clusters; and based on distances between the plurality of clusters, determine whether to split the first speech profile into multiple profiles.

Example 22 includes the device of Example 21, wherein the one or more processors are configured to: identify a first cluster that is closest to a second cluster among the plurality of clusters; and based on determining that a distance between the first cluster and the second cluster is greater than a cluster distance threshold, generate a third speech profile including the second cluster and remove the second cluster from the first speech profile.

Example 23 includes the device of any of Examples 1 to 22, wherein the memory is configured to store end-point detection data indicating time periods of audio segments associated with the enrolled speech profiles, wherein each of the audio segments includes one or more audio portions of the audio stream, and wherein the one or more processors are configured to, based on determining that the end-point detection data indicates a start time and an end time of an audio segment of a first profile identifier of the first speech profile, determine an audio segment time period having the start time and the end time; identify an audio portion of the audio stream that is associated with the audio segment time period; filter the audio portion using a first set of embeddings of the first speech profile to generate a separated audio portion representing speech associated with a single profile identifier, wherein the single profile identifier includes the first profile identifier; and perform speech recognition on the separated audio portion to generate text.

Example 24 includes the device of Example 23, wherein the one or more processors are configured to, based on determining that the audio portion is identified as representing speech of multiple talkers, filter the audio portion to generate the separated audio portion.

Example 25 includes the device of any of Examples 1 to 24, wherein the one or more processors are configured to determine, in a non-conversation mode, whether a first portion of the audio stream corresponds to speech associated with at least two speech profiles; and based on determining that the first portion of the audio stream corresponds to speech associated with at least two speech profiles, transition to a conversation mode.

Example 26 includes the device of Example 25, wherein the one or more processors are configured to determine, in the conversation mode, whether a second portion of the audio stream corresponds to speech associated with fewer than two speech profiles; and based on determining that the second portion of the audio stream corresponds to speech associated with fewer than two speech profiles, transition to the non-conversation mode.

Example 27 includes the device of Example 25 or Example 26, wherein the one or more processors are configured to, during the conversation mode, determine whether to combine the first speech profile and the second speech profile.

Example 28 includes the device of any of Examples 25 to 27, wherein the one or more processors are configured to, during the non-conversation mode, determine whether to split the first speech profile into multiple speech profiles.

According to Example 29, a method includes obtaining multiple audio embeddings representing speech that is identified as associated with a single talker in an audio stream; determining a first speech profile based on the multiple audio embeddings; determining a similarity metric based on a comparison of the first speech profile to a second speech profile of enrolled speech profiles; and based on the similarity metric, determining whether to combine the first speech profile and the second speech profile.

According to Example 30, a non-transitory computer-readable medium stores instructions that, when executed by one or more processors, cause the one or more processors to obtain multiple audio embeddings representing speech that is identified as associated with a single talker in an audio stream; determine a first speech profile based on the multiple audio embeddings; determine a similarity metric based on a comparison of the first speech profile to a second speech profile of enrolled speech profiles; and based on the similarity metric, determine whether to combine the first speech profile and the second speech profile.

According to Example 31, an apparatus includes: means for obtaining multiple audio embeddings representing speech that is identified as associated with a single talker in an audio stream; means for determining a first speech profile based on the multiple audio embeddings; means for determining a similarity metric based on a comparison of the first speech profile to a second speech profile of enrolled speech profiles; and means for determining, based on the similarity metric, whether to combine the first speech profile and the second speech profile.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store enrolled speech profiles; and
one or more processors configured to:
obtain multiple audio embeddings representing speech that is identified as associated with a single talker in an audio stream;
determine a first speech profile based on the multiple audio embeddings;
determine a similarity metric based on a comparison of the first speech profile to a second speech profile of the enrolled speech profiles; and
based on the similarity metric, determine whether to combine the first speech profile and the second speech profile.

2. The device of claim 1, wherein the first speech profile includes a first set of audio embeddings including at least the multiple audio embeddings, wherein the second speech profile includes a second set of audio embeddings, and wherein the one or more processors are configured to:
determine a first cluster based on the first set of audio embeddings;
determine a second cluster based on the second set of audio embeddings; and
determine the similarity metric based on a distance between the first cluster and the second cluster.

3. The device of claim 1, wherein the one or more processors are configured to, based on determining that the first speech profile and the second speech profile are not to be combined and that the first speech profile is not one of the enrolled speech profiles, designate the first speech profile as associated with a first profile identifier and add the first speech profile to the enrolled speech profiles.

4. The device of claim 1, wherein the one or more processors are configured to, in response to determining that the first speech profile and the second speech profile are to be combined, add a first set of audio embeddings of the first speech profile to the second speech profile and discard the first speech profile.

5. The device of claim 1, wherein the one or more processors are configured to:
generate an audio embedding of an audio portion of the audio stream;
process, using a talker detection neural network, the audio embedding to generate one or more probability values, each probability value indicating an estimate of a probability that the audio portion represents speech of a corresponding talker of a set of talkers; and
based on determining that a first probability value of the one or more probability values is greater than or equal to a probability threshold, determine that the audio portion is identified as associated with a first talker.

6. The device of claim 5, wherein the one or more processors are configured to, based on determining that each of the remaining probability values is less than the probability threshold, determine that the audio portion is identified as associated with the single talker, and that the single talker includes the first talker.

7. The device of claim 1, wherein the memory is configured to store enrollment buffers associated with a set of talkers, and wherein the one or more processors are configured to:
generate an audio embedding of an audio portion of the audio stream; and
based at least in part on determining that the audio portion is identified as associated with a first talker and that the audio embedding does not match any of the enrolled speech profiles, add the audio embedding to a first enrollment buffer associated with the first talker, wherein the multiple audio embeddings are obtained from the first enrollment buffer.

8. The device of claim 7, wherein the one or more processors are configured to, based at least in part on determining that the audio embedding matches the first speech profile that is included in the enrolled speech profiles and that a count of a first set of audio embeddings of the first speech profile is less than a maturity threshold, compare the first speech profile to the second speech profile to determine the similarity metric, wherein the multiple audio embeddings are obtained from the first speech profile.

9. The device of claim 1, wherein the memory is configured to store end-point detection data indicating time periods of audio segments associated with the enrolled speech profiles, wherein each of the audio segments includes one or more audio portions of the audio stream, and wherein the one or more processors are configured to:
generate an audio embedding of an audio portion of the audio stream, the multiple audio embeddings including the audio embedding;
based on determining that the audio embedding matches the first speech profile associated with a first profile identifier, designate the audio portion as representing speech corresponding to the first profile identifier; and
based on determining that the audio portion represents speech corresponding to the first profile identifier and that the end-point detection data indicates that no audio segment of the first profile identifier is in-progress, update the end-point detection data to indicate that an audio segment of the first profile identifier is in-progress.

10. The device of claim 9, wherein the one or more processors are configured to update the end-point detection data to indicate a start time of the audio segment of the first profile identifier, and wherein the start time is based on a time stamp associated with the audio portion.

11. The device of claim 9, wherein the one or more processors are configured to, based on determining that the audio portion is designated as not representing speech corresponding to a second profile identifier of the second speech profile, and that the end-point detection data indicates that an audio segment of the second profile identifier is in-progress, update the end-point detection data to indicate that the audio segment of the second profile identifier has ended.

12. The device of claim 11, wherein the one or more processors are configured to update the end-point detection data to indicate an end time of the audio segment of the second profile identifier, and wherein the end time is based on a time stamp associated with the audio portion.

13. The device of claim 12, wherein the one or more processors are configured to generate a transcript including: text corresponding to the audio segment of the second profile identifier, and a label associated with the text, wherein the label is based on the end-point detection data and indicates a second profile name of the second speech profile, a start time of the audio segment of the second profile identifier, and the end time of the audio segment of the second profile identifier.

14. The device of claim 13, wherein the one or more processors are configured to:
provide the transcript to a display device; and
in response to receiving a user input indicating that the label is to be updated to indicate an input profile name associated with a third speech profile of the enrolled speech profiles, combine the second speech profile and the third speech profile.

15. The device of claim 1, wherein the one or more processors are configured to:
determine, in a non-conversation mode, whether a first portion of the audio stream corresponds to speech associated with at least two speech profiles; and
based on determining that the first portion of the audio stream corresponds to speech associated with at least two speech profiles, transition to a conversation mode.

16. The device of claim 15, wherein the one or more processors are configured to:
determine, in the conversation mode, whether a second portion of the audio stream corresponds to speech associated with fewer than two speech profiles; and
based on determining that the second portion of the audio stream corresponds to speech associated with fewer than two speech profiles, transition to the non-conversation mode.

17. The device of claim 15, wherein the one or more processors are configured to, during the conversation mode, determine whether to combine the first speech profile and the second speech profile.

18. The device of claim 15, wherein the one or more processors are configured to, during the non-conversation mode, determine whether to split the first speech profile into multiple speech profiles.

19. A method comprising:
obtaining multiple audio embeddings representing speech that is identified as associated with a single talker in an audio stream;
determining a first speech profile based on the multiple audio embeddings;
determining a similarity metric based on a comparison of the first speech profile to a second speech profile of enrolled speech profiles; and
based on the similarity metric, determining whether to combine the first speech profile and the second speech profile.

20. A non-transitory computer-readable medium storing instructions that, when executed by one or more processors, cause the one or more processors to:
obtain multiple audio embeddings representing speech that is identified as associated with a single talker in an audio stream;
determine a first speech profile based on the multiple audio embeddings;
determine a similarity metric based on a comparison of the first speech profile to a second speech profile of enrolled speech profiles; and
based on the similarity metric, determine whether to combine the first speech profile and the second speech profile.
